(19) United States
(12) Patent Application Publication
(10) Pub. No.: US 2026/0287710 A1
(43) Pub. Date: Sep. 24, 2026

(54) RADAR APPARATUS, METHOD FOR TRANSMITTING RADAR SIGNAL, METHOD FOR RECEIVING RADAR SIGNAL, AND RADAR SIGNAL GENERATION APPARATUS

(71) Applicant: Panasonic Automotive Systems Co., Ltd., Kanagawa (JP)

(72) Inventor: Takaaki KISHIGAMI, Tokyo (JP)

(21) Appl. No.: 19/034,348

(22) Filed: Jan. 22, 2025

Related U.S. Application Data
(63) Continuation of application No. PCT/JP2023/039876, filed on Nov. 6, 2023.

(30) Foreign Application Priority Data
Dec. 19, 2022 (JP) 2022-202052

(51) Int. Cl. G01S 7/03; G01S 7/285

(52) U.S. Cl. CPC G01S 7/03; G01S 7/285

(57) ABSTRACT

A radar apparatus includes: a plurality of transmission antennas including a first transmission antenna for emitting a first polarized wave and a second transmission antenna for emitting a second polarized wave different from the first polarized wave; and transmission circuitry, which, in operation, performs a multiplexing transmission on a transmission signal to which a phase rotation amount corresponding to a combination of a Doppler shift amount and a code sequence is applied, from the plurality of transmission antennas. The combination in which at least one of the Doppler shift amount or the code sequence is different is associated with each of the plurality of transmission antennas, and a first pattern of the Doppler shift amount and the code sequence assigned for the first transmission antenna and a second pattern of the Doppler shift amount and the code sequence assigned for the second transmission antenna are different from each other.

### TECHNICAL FIELD

The present disclosure relates to a radar apparatus, a method for transmitting a radar signal, a method for receiving a radar signal, and a radar signal generation apparatus.

### BACKGROUND ART

Recently, a study of radar apparatuses using a radar transmission signal of a short wavelength including a microwave or a millimeter wave that can achieve high resolution has been carried out. Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature 1).

### CITATION LIST

### Patent Literature

PTL 1
US Patent Application Publication No. 2019/0064337
PTL 2
US Patent Application Publication No. 2020/0363497
PTL 3
Japanese Unexamined Patent Application Publication No. 2008-304417
PTL 4
Japanese Unexamined Patent Application Publication (Translation of PCT Application) No. 2011-526371
PTL 5
Japanese Unexamined Patent Application Publication No. 2011-119344
PTL 6
Japanese Patent Application Laid-Open No. 2020-204603
PTL 7
Japanese Patent Application Laid-Open No. 2020-092247
PTL 8
Japanese Patent Application Laid-Open No. 2020-148754

### Non-Patent Literature

Non-Patent Literature 1
J. Li, and P. Stoica, “MIMO Radar with Colocated Antennas,” Signal Processing Magazine, IEEE Vol. 24, and Issue: 5, pp. 106-114, 2007
Non-Patent Literature 2
M. Kronauge, H. Rohling, “Fast two-dimensional CFAR procedure,” IEEE Trans. Aerosp. Electron. Syst., 2013, 49, (3), pp. 1817-1823
Non-Patent Literature 3
Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, methods for a radar apparatus (e.g., MIMO radar) to sense a target object (or a target) have not been comprehensively studied.

A non-limiting embodiment of the present disclosure contributes to providing a radar apparatus that improves the detection accuracy of a target object, a method for transmitting a radar signal, a method for receiving a radar signal, and a radar signal generation apparatus.

A radar apparatus according to an embodiment of the present disclosure includes: a plurality of transmission antennas including a first transmission antenna for emitting a first polarized wave and a second transmission antenna for emitting a second polarized wave different from the first polarized wave; and transmission circuitry, which, in operation, performs a multiplexing transmission on a transmission signal to which a phase rotation amount corresponding to a combination of a Doppler shift amount and a code sequence is applied, from the plurality of transmission antennas, in which the combination in which at least one of the Doppler shift amount or the code sequence is different is associated with each of the plurality of transmission antennas, and a first pattern of the Doppler shift amount and the code sequence assigned for the first transmission antenna and a second pattern of the Doppler shift amount and the code sequence assigned for the second transmission antenna are different from each other.

Note that these generic or specific exemplary embodiments may be achieved by a system, an apparatus, a method, an integrated circuit, a computer program, or a recording medium, and also by any combination of the system, the apparatus, the method, the integrated circuit, the computer program, and the recording medium.

According to an exemplary embodiment of the present disclosure, the target object-object sensing accuracy of a radar apparatus can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary coded Doppler multiplexing transmission;

FIG. 2 illustrates an example of a reception signal in coded Doppler multiplexing transmission;

FIG. 3 illustrates an exemplary coded Doppler multiplexing transmission;

FIG. 4 is a block diagram illustrating an exemplary configuration of a radar apparatus;

FIG. 5 illustrates an example of a transmission signal in a case where a chirp signal is used;

FIG. 6 illustrates a configuration example of a Doppler shift amount and a code sequence;

FIG. 7 illustrates a configuration example of the coded Doppler phase rotation amount;

FIG. 8 illustrates an example of a reception signal in coded Doppler multiplexing transmission;

FIG. 9 illustrates a configuration example of the coded Doppler phase rotation amount;

FIG. 10 illustrates an example of a reception signal in coded Doppler multiplexing transmission;

FIG. 11 illustrates a configuration example of the coded Doppler phase rotation amount;

FIG. 12 illustrates an example of a reception signal in coded Doppler multiplexing transmission;

FIG. 13 illustrates a configuration example of the coded Doppler phase rotation amount;

FIG. 14 is a flowchart illustrating an exemplary operation of demultiplexing of a coded Doppler multiplexed signal;

FIG. 15 is a block diagram illustrating an exemplary configuration of a radar receiver;

FIG. 16 illustrates a configuration example of the coded Doppler phase rotation amount; and

FIG. 17 illustrates an example of a reception signal in coded Doppler multiplexing transmission.

### DESCRIPTION OF EMBODIMENTS

### [Regarding Polarimetric Radar]

There are techniques for improving radar detection performance or identification performance by using, for example, an antenna that emits differently polarized radio waves or an antenna that receives differently polarized radio waves (see, for example, PTL 1 or 2). A radar apparatus using a plurality of polarized waves is also referred to as a “Polarimetric radar,” for example.

For example, PTL 1 or PTL 2 discloses a method for detecting and identifying an object by transmitting a transmission signal by an antenna using vertically polarized waves or horizontally polarized waves, and by using a signal received by an antenna using vertically polarized waves or horizontally polarized waves. PTL 1 discloses, for example, a method for detecting and identifying an object by transmitting a transmission signal by an antenna using left-handed circularly polarized waves or right-handed circularly polarized waves, and by using a signal received by an antenna using left-handed circularly polarized waves or right-handed circularly polarized waves. Note that an antenna using polarized waves such as linearly polarized waves including the vertically polarized waves or the horizontally polarized waves, or circularly polarized waves including left-handed circularly polarized waves or right-handed circularly polarized waves are also referred to as a “polarized antenna.”

Such polarimetric radars use a plurality of different types of polarized antennas (for example, polarized transmission antennas or polarized reception antennas).

Below, attention is given to the multiplexing transmission method in a MIMO radar using a plurality of different types of polarized antennas (referred to as, for example, “polarimetric MIMO radar”).

For example, as an example of a multiplexing transmission method for a MIMO radar using a plurality of transmission antennas, time division multiplexing (TDM) transmission (see, for example, PTLs 3 and 4) or Doppler division multiplexing (DDM) transmission (see, for example, PTL 5) is known.

The time-division multiplexing transmission or Doppler multiplexing transmission can separate the reflected waves corresponding to the transmission signals from a plurality of transmission antennas using the assigned transmission time or Doppler frequency domain. On the other hand, with time-division multiplexing transmission and Doppler multiplexing transmission, as the number of transmission antennas increases, the detection range of Doppler frequencies is likely to narrow. For example, in time-division multiplexing and Doppler multiplexing, the Doppler frequency range in which detection can be successful is −1/(2Nt×Tr)−fd<1/(2Nt×Tr), and the detection range of Doppler frequencies narrows inversely proportional to the number of transmission antennas. Here, Nt is the number of transmission antennas and Tr is a transmission period of a transmission signal.

### [Coded Doppler Multiplexing Transmission]

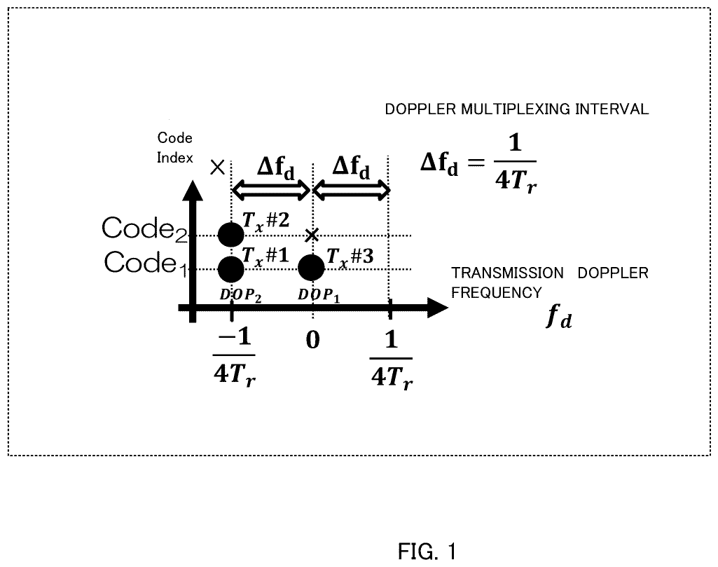

PTL 6 (for example, FIG. 1 of PTL 6) discloses a multiplexing transmission method that combines Doppler multiplexing and code multiplexing (hereinafter referred to as “coded Doppler multiplexing transmission” or “Coded DDM transmission (abbreviated to CDDM transmission).”

For example, FIG. 1 illustrates a case where a radar transmission wave (for example, a chirp signal) is transmitted in each transmission period Tr. FIG. 1 illustrates an example of the assignment of transmission Doppler frequencies and codes in a case where signals code-multiplexed with orthogonal codes (for example, code #1, code #2) of code length Loc=2 are transmitted via three transmission antennas (for example, Tx #1 to Tx #3) using two Doppler multiplexing (DDM) signals (for example, DOP₁, DOP₂). In the example of FIG. 1, number N_{CM} of code multiplexing=2 and number N_{DM} of Doppler multiplexing=2.

The phase rotation based on the codes is performed, for example, by cyclically repeating the operation of applying the phase rotation to a chirp signal in transmission periods Loc×Tr (in FIG. 1, two transmission periods (2Tr)), the number of times corresponding to the code length. At this time, the phase rotation based on the DDM signals is constant in the code length times of transmission periods Loc (in FIG. 1, two transmission periods (2Tr)) for application of codes with a code length of Loc. For example, the phase rotation based on the DDM signals may be varied and applied for each 2Tr transmission periods.

For example, in FIG. 1, the transmission Doppler shift amounts to be allocated are set to DOP₁=0 and DOP₂=−1/(4Tr) [Hz], respectively. For example, since DOP₁ is applied in each mth transmission period, phase rotation Φ₁(m)=ΔΦ₁×(floor (m/Loc)+1) is applied to the radar transmission wave (chirp signal). Further, since DOP₂ is applied in each mth transmission period, phase rotation Φ₂ (m)=ΔΦ₂×(floor (m/Loc)+1) is applied to the radar transmission wave. Here, ΔΦ₁=0 and ΔΦ₂=−π. The Doppler multiplexing interval is Δf_{d}=1/(4Tr). Further, orthogonal codes with a code length of 2, such as Code₁=[1, 1] and Code₂=[1, −1], may be used. In FIG. 1, for example, DopCode #1=(DOP₂, Code₁), DopCode #2=(DOP₂, Code₂), and DopCode #3=(DOP₁, Code₁) are assigned for Tx #1 to Tx #3, respectively, and are transmitted as coded Doppler-multiplexed signals (CDDM signals) in which Doppler-multiplexed signals and codes are combined. Note that floor[x] is a function that outputs the largest integer that does not exceed real number x.

Here, DopCode #n represents the assignment of a CDDM signal for nth Tx #n (assignment using Doppler shift amount DOP_{ndm} and code Code_{ncm}). The character, “n” is 1 to Nt, “ndm” is an integer value in the range of 1 to N_{DM}, and “ncm” is an integer value in the range of 1 to N_{CM}. For Nt transmission antennas, a CDDM signal with a different combination of DOP_{ndm} and Code_{ncm} is allocated.

These signals on which simultaneous multiplexing transmission is performed are received by a radar apparatus (for example, a reception signal processor). For example, in the radar apparatus, Doppler frequency analysis is performed on a radar reflected-wave reception signal at an individual Doppler analyzer (for example, V-FFT #1, #2, . . . , #Loc) on each reception signal for each element of the code to be transmitted, and the multiplexed transmission signal is demultiplexed and received by performing code demultiplexing and Doppler demultiplexing based on the output of the Doppler frequency analysis. For example, in a case where code length Loc=2, the number of elements of the code is 2, and the radar apparatus demultiplexes and receives the multiplexed transmission signal by performing code demultiplexing and Doppler demultiplexing on reception signals based on the output of the Doppler frequency analysis performed for each odd-numbered transmission signal and each even-numbered transmission signal in an individual Doppler analyzer (V-FFT #1, #2).

Here, since the radar apparatus (for example, the Doppler analyzer) uses reception signals with Loc (code length) times of transmission periods (in FIG. 1, 2 transmission periods (2Tr) since Loc=2), a Doppler frequency exceeding ±1/(2 Loc Tr) (±1/(4Tr) in FIG. 1) is detected as being aliased. Whether the radar reflected-wave reception signal includes a component in the frequency range of the aliasing can be detected by, for example, multiplexing transmission from a plurality of transmission antennas with uneven numbers of code multiplexing between the DDM signals, as disclosed in PTL 6. Thus, the radar apparatus can expand, to ±1/(2Tr), the Doppler frequency range (maximum Doppler) in which Doppler frequency detection is possible without aliasing, and can also determine the transmission antenna.

For example, in FIG. 1, the number of code multiplexing for Doppler shift amount DOP₁ is 1, the number of code multiplexing for DOP₂ is 2, and the numbers of code multiplexing between the DDM signals are unevenly configured. By using a CDDM signal (DopCode=(DOP₁, Code₂) in FIG. 1) for which to which no transmission antenna is assigned and that is a combination of an unused code and a Doppler signal, the radar apparatus detects, based on the demultiplexed reception signals for the multiplexed transmission signals, whether a radar reflected-wave reception signal includes a component in a frequency range of aliasing (hereinafter, the detection is also referred to as “aliasing determination”).

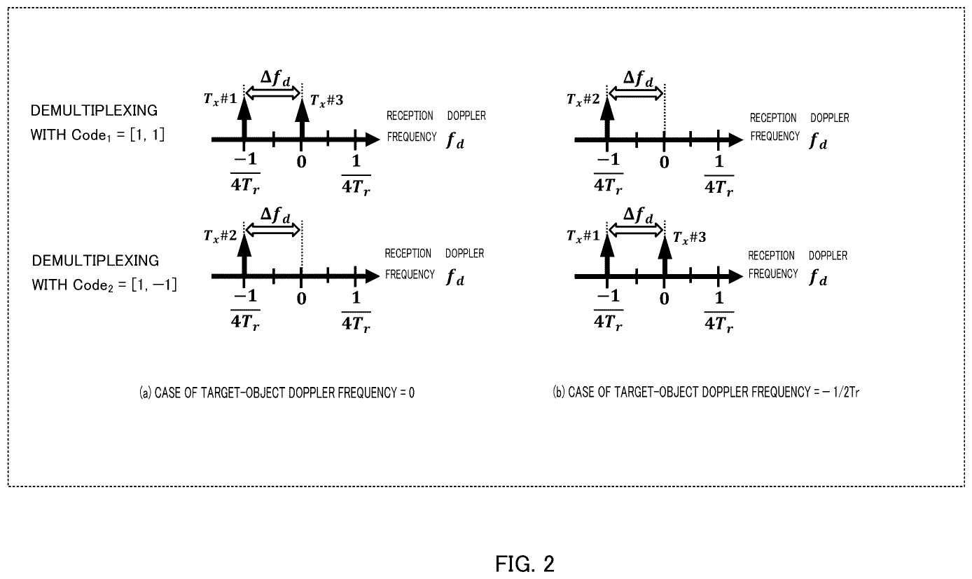

For example, (a) of FIG. 2 illustrates the reception Doppler signal in a case where target-object Doppler frequency f_{dtg} is 0 and the CDDM signal shown in FIG. 1 is demultiplexed with each of Code₁ and Code₂. In the reception DDM signal demultiplexed by Code₁, the reception levels at two Doppler frequencies of a Doppler frequency interval that matches Doppler multiplexing interval Δfd between DOP₁ and DOP₂ are detected to be high, and the radar apparatus can determine these components as the reception signals of Tx #1 and Tx #3. Further, in the reception Doppler signal demultiplexed by Code₂, one Doppler frequency with a high reception level at reception Doppler frequency f_{d}=−1/(4Tr) is detected. Note that the reception level of the Doppler frequency (reception Doppler frequency f_{d}=0) in the Doppler frequency interval that matches Doppler multiplexing interval Δf_{d} between DOP₁ and DOP₂ for the detected Doppler frequency is approximately the noise level.

For this reason, in (a) of FIG. 2, the radar apparatus can determine that the component of one Doppler frequency with a high reception level detected in the reception Doppler signal demultiplexed by Code₂ is the reception signal of Tx #2. Further, the radar apparatus can determine the Doppler frequency of the target object because the deviation amount from the Doppler shift amount at the time of transmission for each transmission antenna is the Doppler frequency of the target object.

Further, for example, in (b) of FIG. 2, the received Doppler signal in a case where the CDDM signal shown in FIG. 1 is demultiplexed with each of Code₁ and Code₂ in a case of Doppler frequency f_{dtg}=−1/(2Tr) of the target object is illustrated. In the reception Doppler signal demultiplexed by Code₂, the reception levels at two Doppler frequencies of a Doppler frequency interval that matches Doppler multiplexing interval Δf_{d} between DOP₁ and DOP₂, are detected to be high, and the radar apparatus can determine these components as the reception signals of Tx #1 and Tx #3. Further, one Doppler frequency with a high reception level is detected in the reception Doppler signal demultiplexed by Code₁. Note that the reception level of the Doppler frequency (reception Doppler frequency f_{d}=0) in the Doppler frequency interval that matches Doppler multiplexing interval Δf_{d} between DOP₁ and DOP₂ for the detected Doppler frequency is approximately the noise level.

For this reason, in (b) of FIG. 2, the radar apparatus can determine that the component of one Doppler frequency with a high reception level detected in the reception Doppler signal demultiplexed by Code₁ is the reception signal of Tx #2. Further, the radar apparatus can determine the Doppler frequency of the target object because a deviation amount from the Doppler shift amount at the time of transmission for each transmission antenna is the Doppler frequency of the target object.

Note that, in a case where the Doppler frequency of the target object is −1/(2Tr)≤f_{dtg}<−1/(4Tr) or 1/(4Tr)≤f_{dtg}<1/(2Tr), the Doppler analyzers (for example, V-FFT #1 and V-FFT #2) observe an aliased Doppler frequency. The actual Doppler frequency is obtained by adding a π phase rotation to the Doppler frequency detected in the Doppler analyzers (V-FFT #1 and V-FFT #2) in the case of detection time difference Tr between V-FFT #1 and V-FFT #2 because of a 2π phase difference between the transmission periods of 2Tr. Accordingly, in the case of code length Loc=2, the radar apparatus can determine that there is a Doppler frequency aliasing if a reception signal corresponding to Code₂ is determined in the demultiplexing of Code₁ as illustrated in (b) of FIG. 2.

By the demultiplexing reception processing of the CDDM signal as described above, the radar apparatus can estimate the Doppler frequency of the radar reflected wave in the Doppler frequency range of ±1/(2Tr). As described above, by performing CDDM transmission, the Doppler frequency range in which detection can be successful is expanded to ±½Tr. For example, the Doppler frequency range in which detection can be successful is expanded by Nt times compared to PTL 5.

### [Application of Coded Doppler Division Multiplexing (CDDM) Transmission to Polarimetric MIMO Radar]

As described above, in a MIMO radar using coded Doppler multiplexing, for example, the demultiplexing processing of a CDDM signal (hereinafter, referred to as “coded Doppler demultiplexing” or “CDDM demultiplexing”) is performed to estimate the Doppler frequency of a target object based on the reception power at the reception Doppler frequency after code demultiplexing of the reflected wave from the target object.

For this reason, the following can be assumed when CDDM is applied to a polarimetric MIMO radar.

In the polarimetric MIMO radar, for example, the reception level of reflected waves can vary significantly depending on the polarization of the transmission and reception antennas. In the polarimetric MIMO radar, when using transmission antennas of different polarizations, the reception level of reflected waves from a transmission antenna of one polarization may significantly attenuate compared to that from a transmission antenna of another polarization. For this reason, in a polarimetric MIMO radar, when multiplexing transmission is performed using CDDM, the difference (or ratio) in the reflected wave reception levels between transmission antennas of different polarizations may become large, making CDDM demultiplexing difficult. When CDDM demultiplexing becomes difficult, the target-object detection performance in a MIMO radar may deteriorate, or CDDM demultiplexing may be erroneous, leading to Doppler misestimation or deterioration in angle measurement performance.

Hereinafter, an example in which CDDM demultiplexing is difficult in a polarimetric MIMO radar that applies CDDM will be described.

Here, as an example, the case of configuring a MIMO radar with two transmission antennas of each of both left-handed circular polarization (hereafter, also referred to as “LC”) and right-handed circular polarization (hereafter, also referred to as “RC”) (denoted as LC-2Tx and RC-2Tx, respectively) (for example, with a total of Nt=4 transmission antennas) is described. For example, the polarization antenna corresponding to left-handed circular polarization is called “LC polarization antenna” (for example, LC polarized transmission antenna, or LC polarized reception antenna), and the polarization antenna corresponding to right-handed circular polarization is called “RC polarization antenna” (for example, RC polarized transmission antenna, or RC polarized reception antenna).

For example, the case where the MIMO radar receives a once-reflected wave (a reflected wave, which is reflected once on an object) using an LC polarized reception antenna is described. The reflected wave signal corresponding to the transmission signal from the RC polarized transmission antenna (for example, also called “reception signal corresponding to the RC polarized transmission antenna”) is a reception signal as an RC polarized wave, and when the reception signal corresponding to the RC polarized transmission antenna is received by the LC polarized reception antenna, the reception is a cross-polarized reception. Therefore, the reception levels of the reception signals corresponding to the RC polarized transmission antennas at the LC polarized reception antenna are lower (for example, by 10 dB or more depending on the cross-polarization discrimination degree of the antenna) compared to the reception levels of the reflected wave signals corresponding to the transmission signals from the LC polarized transmission antennas (for example, also called “reception signal corresponding to the LC polarized transmission antenna”). For example, the reception levels of the reception signals corresponding to the RC polarized transmission antennas may become at or below the noise level depending on the reception quality (for example, Signal to Noise Ratio (SNR)), making it difficult to detect Doppler frequency peaks in the MIMO radar.

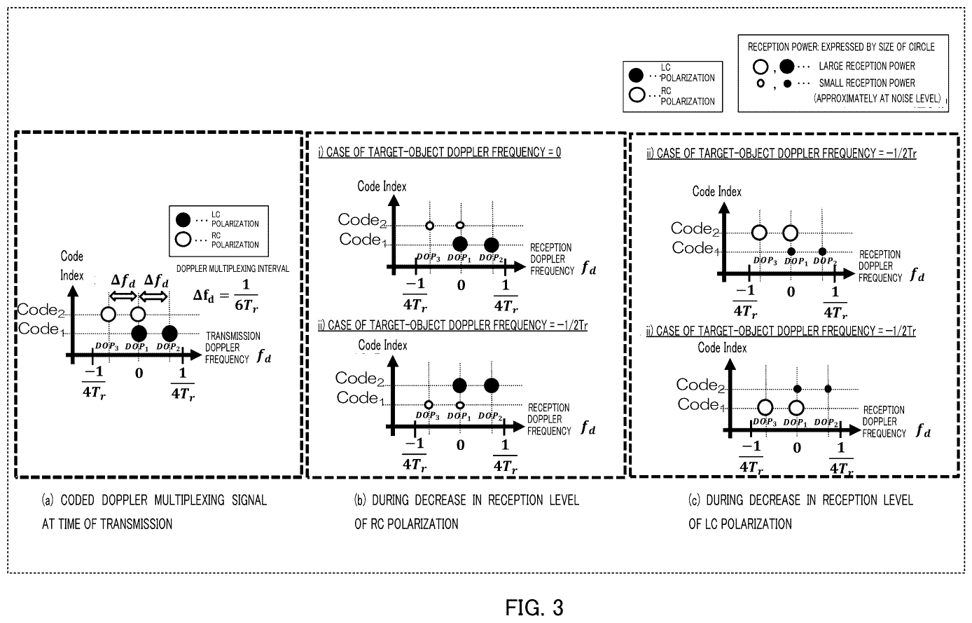

FIG. 3 illustrates an example of a signal subjected to CDDM transmission in a polarimetric MIMO radar. In FIG. 3, two transmission antennas of LC polarization and two transmission antennas of RC polarization are used as differently-polarized transmission antennas, and a MIMO radar is configured using a total of four Tx #1 to #4. Here, Tx #1 and Tx #2 are LC polarized transmission antennas, and Tx #3 and Tx #4 are RC polarized transmission antennas. Further, in the example of FIG. 3, the reception antenna performs reception using an LC polarized reception antenna.

For example, CDDM signals in which number N_{DM} of Doppler multiplexing=3 and number N_{CM} of code multiplexing=2 are assigned for four Tx #1 to Tx #4, as illustrated in (a) of FIG. 3. In CDDM, a combination of a DDM signal (one of DOP₁, DOP₂, and DOP₃) and a code (one of Code₁ and Code₂) different from one another is assigned for each transmission antenna.

Further, in FIG. 3, black circles (●) indicate the assignment of CDDM signals to LC polarized transmission antennas (Tx #1 and Tx #2), and the pairs of DopCode #1=(DOP₁, Code₁) and DopCode #2=(DOP₂, Code₁) are assigned for Tx #1 and Tx #2, respectively. Further, in FIG. 3, the white circles (◯) indicate the assignment of CDDM signals to RC-polarization transmission antennas (Tx #3 and Tx #4), and the combinations of DopCode #3=(DOP₃, Code₂) and DopCode #4=(DOP₁, Code₂) are assigned for Tx #3 and Tx #4, respectively.

For example, in a case where the CDDM signals are allocated as illustrated in (a) of FIG. 3 and the LC polarized reception antenna receives once-reflected waves, the reception levels of the reception signals (R) corresponding to the RC polarized transmission antennas may be smaller than the reception levels of the reception signals (L) corresponding to the LC polarized transmission antennas as illustrated in (b) of FIG. 3.

Here, in FIG. 3, the sizes of the black circles (●) and white circles (◯) represent the reception power. The smaller the size of the black circle (●) and the white circle (◯), the smaller the reception power (for example, the reception power is as small as the noise level).

Further, for example, an explanation is given for the case where the MIMO radar receives a twice-reflected wave (a reflected wave that is reflected twice by an object) using an LC polarized reception antenna. The reception signals corresponding to the LC polarized transmission antennas, which are received by the LC polarized reception antenna, become reception signals as RC polarized waves due to being reflected twice, and the reception by the LC polarized reception antenna becomes cross-polarized reception. Therefore, the reception signals corresponding to the LC polarized transmission antennas may have a lower reception level compared to the reception signals corresponding to the RC polarized transmission antennas (for example, lower by 10 dB or more depending on the cross-polarization discrimination degree of the antenna reception level). For example, the reception levels of the reception signals corresponding to the LC polarized transmission antennas may become below the noise level depending on the reception quality (SNR), making it difficult to detect Doppler frequency peaks in the MIMO radar.

For example, in a case where the CDDM signals are assigned as illustrated in (a) of FIG. 3 and the LC polarized reception antenna receives twice-reflected waves, the reception levels of the reception signals (L) corresponding to the LC polarized transmission antennas may be smaller than the reception levels of the reception signals (R) corresponding to the RC polarized transmission antennas as illustrated in (c) of FIG. 3.

Here, in a case where the Doppler frequency of the reflected wave from the target object and the number of times of reflection are unknown in advance, it is difficult for the MIMO radar to mine based on the reception levels shown at part (b) or (c) in FIG. 3 whether the reception levels of the reception signals corresponding to the RC polarized transmission antennas have decreased or the reception levels of the reception signals corresponding to the LC polarized transmission antennas have decreased. Further, for example, it is difficult for the MIMO radar to determine which transmission antenna the detected Doppler frequency peak in the signal corresponds to, based on the reception levels shown at part (b) or (c) in FIG. 3, when using CDDM transmission. For this reason, it is difficult for the MIMO radar to demultiplex the CDDM signal, and it is difficult to determine Doppler frequency f_{dtg} of the reflection wave (for example, referred to as “target-object reflected wave”) from the target object in a range of −1/(2Tr)≤f_{dtg}<1/(2Tr).

For example, in a case where the target-object reflected wave is a once-reflected wave and Doppler frequency f_{dtg}=0 (case i in the upper part of (b) of FIG. 3 in which the reception levels of the reception signals corresponding to the RC polarized transmission antennas decrease to a noise level) and in a case where the target-object reflected wave is a twice-reflected wave and Doppler frequency f_{dtg}=−1/(2Tr)+Δfd (case in which the reception levels of the reception signals corresponding to the LC polarized transmission antennas decrease to a noise level), the peak frequencies are observed in the same manner at DOP₁ and DOP₂ at the reception Doppler frequency after the code demultiplexing with Code₁. For this reason, the results of CDDM demultiplexing in these cases are not a unique response, and it is difficult for the radar apparatus to distinguish these cases.

As described above, in the coded Doppler multiplexing MIMO radar, the demultiplexing processing of the multiplexed transmission signal is performed on the assumption that the reception levels of CDDM signals allocated respectively to transmission antennas are similar to one another and that the reception level of the coded Doppler signal which is not assigned for any transmission antenna is sufficiently low and approximately at the noise level. In a polarimetric MIMO radar using CDDM, the assumption in the demultiplexing processing of CDDM may be broken as shown in (b) and (c) of FIG. 3, and there is a possibility that the CDDM demultiplexing processing is erroneous.

In a non-limiting exemplary embodiment of the present disclosure, a method for improving the detection performance of a polarimetric MIMO radar using coded Doppler division multiplexing (CDDM) transmission will be described.

It should be noted that, although the example described here involves configuring the MIMO radar using two transmission antennas of each of both left-handed circular polarization (LC) and right-handed circular polarization (RC) (for example, number Nt of transmission antennas=4), the polarizations used in the polarimetric MIMO radar are not limited to these.

For example, in the polarimetric MIMO radar, different linear polarizations that are orthogonal to each other may be applied. For example, linear polarizations that are orthogonal to each other, such as applying vertical polarization instead of left-handed circular polarization (LC) and horizontal polarization instead of right-handed circular polarization (RC), may be applied. When radar transmission waves are transmitted using such vertically and horizontally polarized transmission antennas, the closer the angle of incidence when the radar transmission waves are reflected by the target object is to the Brewster angle, the reflected wave of one of the vertical polarization and the horizontal polarization may have a weaker reception level of reflected waves compared to the other polarization. In the MIMO radar, for example, when such reflected waves are received using a polarization reception antenna corresponding to either the vertical polarization or the horizontal polarization, the reception signal corresponding to the transmission antenna of one of the vertical polarization and the horizontal polarization becomes a cross-polarized reception, and may have a lower reflected-wave reception level (for example, lower by 10 dB or more depending on the cross-polarization discrimination degree of the antenna) compared to the reception signal corresponding to the other polarized transmission antenna. The reception signal with reduced reception level may fall below the noise level depending on the reception quality (SNR), making it difficult to detect Doppler frequency peaks in the MIMO radar.

For example, in a case where vertical polarization is applied instead of left-handed circular polarization (LC), horizontal polarization is applied instead of right-handed circular polarization (RC), and the CDDM signals are assigned as in (a) of FIG. 3, the reception signals may be as in (b) of FIG. 3 or (c) of FIG. 3.

Even when using vertical and horizontal polarized transmission antennas, it is difficult for the MIMO radar to determine whether the reception level of the transmission signal from the horizontal polarized transmission antenna has decreased or the reception level of the transmission signal from the vertical polarized transmission antenna has decreased, based on the reception levels shown at part (b), (c), (e), or (f) in FIG. 3, for example. For this reason, for example, in a MIMO radar, it is difficult to demultiplex CDDM signals, and it is difficult to determine Doppler frequency fd of the target-object reflected wave in a range of −1/(2Tr)≤f_{d}<1/(2Tr).

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmitting branch in which multiplexed different transmission signals are simultaneously sent from a plurality of transmission antennas, and a receiving branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to transmit a pulse train after performing phase modulation or amplitude modulation on the pulse train.

Further, the radar apparatus performs Doppler multiplexing transmission, for example. Further, in the Doppler multiplexing transmission, the radar apparatus multiplexes and transmits signals by encoding (for example, performing code division multiplexing (CDM) on) the signals to which different phase rotations (for example, phase shifts), the number of which corresponds to the number of Doppler multiplexing, are applied, (hereinafter, such signals are referred to as “Doppler multiplexed (DDM) transmission signals” or “Doppler multiplexed (DDM) signals”) (hereinafter, such multiplexing is referred to as “Coded Doppler Division Multiplexing (CDDM)”).

### [Configuration of Radar Apparatus]

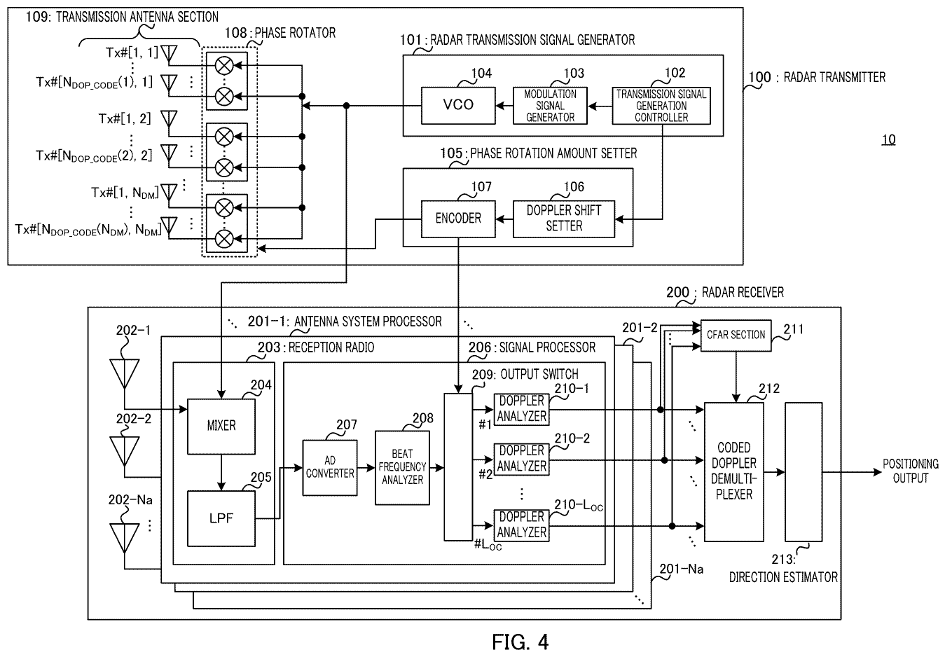

Radar apparatus 10 shown in FIG. 4 includes radar transmitter (transmission branch) 100 and radar receiver (reception branch) 200.

Radar transmitter 100 generates radar signals (radar transmission signals) and transmits the radar transmission signals in a defined transmission period (hereinafter, referred to as “radar transmission period”) using transmission antenna section 109 (e.g., a transmission array antenna) composed of a plurality of transmission antennas (for example, Nt transmission antennas).

Radar receiver 200 receives a reflected wave signal, which is a radar transmission signal reflected by a target object (target (not illustrated)) using reception antenna section 202 (for example, a reception array antenna) including a plurality of reception antennas 202-1 to 202-Na. Radar receiver 200 performs signal processing on the reflected wave signal received by each reception antenna, and outputs information (for example, positioning information) related to the estimation result by, for example, detecting the presence or absence of a target object or estimating the arrival distance, the Doppler frequency (for example, relative velocity), and the arrival direction of the reflected wave signal.

Note that, radar apparatus 10 may be mounted, for example, on a mobile body such as a vehicle, and a positioning output of radar receiver 200 (information on the estimation result) may, for example, be connected to an Electronic Control Unit (ECU) (not illustrated) such as an Advanced Driver Assistance System (ADAS) or an autonomous driving system for enhancing the collision safety and utilized for a vehicle drive control or alarm call control.

Radar apparatus 10 may also be mounted on a relatively high-altitude structure (not illustrated), such as, for example, a roadside utility pole or traffic lights. Radar apparatus 10 may also be utilized, for example, as a sensor of a support system for enhancing the safety of passing vehicles or pedestrians, or as a sensor of a suspicious intrusion prevention system (not illustrated). The positioning output of radar receiver 200 may also be connected, for example, to a control device (not illustrated) in the support system or the suspicious intrusion prevention system for enhancing safety and may be utilized for an alarm call control or an abnormality detection control. The use of radar apparatus 10 is not limited to the above, and may also be used for other uses.

In addition, the target object is an object to be detected by radar apparatus 10. Examples of the target object include vehicles (including four-wheel and two-wheel vehicles), a person, and a block or a curb.

### [Configuration of Radar Transmitter 100]

Radar transmitter 100 includes radar transmission signal generator 101, phase rotation amount setter 105, phase rotators 108, and transmission antenna section 109.

Radar transmission signal generator 101 generates a radar transmission signal. Radar transmission signal generator 101 includes, for example, transmission signal generation controller 102, modulation signal generator 103, and Voltage Controlled Oscillator (VCO) 104. Hereinafter, the components of radar transmission signal generator 101 will be described.

Transmission signal generation controller 102 configures, for example, a transmission signal generation timing for each radar transmission period, and outputs information on the configured transmission signal generation timing to modulation signal generator 103 and phase rotation amount setter 105 (e.g., Doppler shift setter 106). The radar transmission period is herein represented by Tr.

Modulation signal generator 103 periodically generates, for example, saw-toothed modulation signals based on the information on the transmission signal generation timing for each radar transmission period Tr inputted from transmission signal generation controller 102.

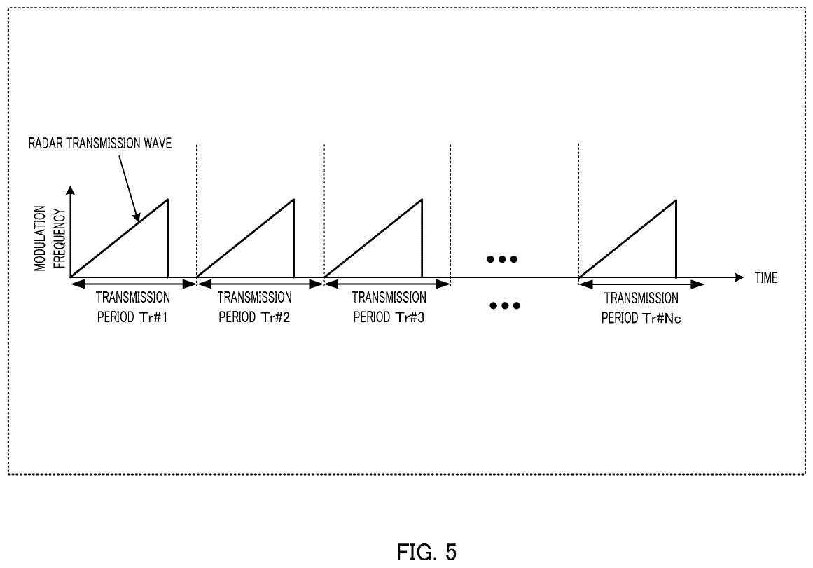

VCO 104 outputs, based on the modulation signals inputted from modulation signal generator 103, frequency-modulated signals (hereinafter referred to as, for example, frequency chirp signals or chirp signals) to phase rotators 108 and radar receiver 200 (mixer 204 described below) as the radar transmission signals (radar transmission waves) illustrated in FIG. 5.

Phase rotation amount setter 105 configures phase rotation amounts given (applied) to radar signals for each radar transmission period Tr at phase rotators 108 (e.g., phase rotation amounts corresponding to the CDDM transmission) based on the information on the transmission signal generation timing for each radar transmission period Tr inputted from transmission signal generation controller 102. Phase rotation amount setter 105 includes, for example, Doppler shift setter 106 and encoder 107.

Doppler shift setter 106 configures phase rotation amounts that are applied to the radar transmission signals (e.g., chirp signals) and that correspond to Doppler shift amounts, for example, based on the information on the transmission signal generation timing for each radar transmission period Tr.

Encoder 107 configures a phase rotation amount corresponding to coding, for example, based on the information on the transmission signal generation timing for each radar transmission period Tr. Encoder 107 calculates phase rotation amounts for phase rotators 108 based on, for example, the phase rotation amounts outputted from Doppler shift setter 106 and the phase rotation amount corresponding to coding, and outputs the phase rotation amounts to phase rotators 108. Further, encoder 107 outputs, for example, information on code sequences used for coding (for example, elements of orthogonal code sequences) to radar receiver 200 (for example, output switch 209).

Phase rotators 108 apply the phase rotation amounts inputted from encoder 107 to the chirp signals inputted from VCO 104 and outputs the signals subjected to phase rotation to transmission antenna section 109. For example, each of phase rotators 108 includes a phase shifter, a phase modulator, and the like (not illustrated). The output signals of phase rotators 108 are amplified to a defined transmission power and are radiated respectively from transmission antennas to space. For example, radar transmission signals are multiplexed by application of the phase rotation amounts corresponding to combinations of the Doppler shift amounts and the code sequences and are transmitted from a plurality of transmission antennas 109.

Next, an exemplary configuration method for phase rotation amount setter 105 to configure the phase rotation amounts will be described.

Doppler shift setter 106 configures phase rotation amount φ_{ndm} for applying Doppler shift amount DOP_{ndm}, and outputs the phase rotation amount to encoder 107. Here, ndm=1 to N_{DM}. N_{DM} is the configured number of different Doppler shift amounts, and is referred to as the “number of Doppler multiplexing” hereinafter.

In radar apparatus 10, since encoding by encoder 107 is used in combination, number N_{DM} of Doppler multiplexing may be set to be smaller than number Nt of transmission antennas used for multiplexing transmission. Note that number N_{DM} of Doppler multiplexing is greater than or equal to 2.

Doppler shift amounts at equal intervals, or Doppler shift amounts at unequal intervals may, for example, be configured as DOP₁, DOP₂, . . . , DOP_{N_DM} (where “N_DM” is also represented as “N_{DM}”). Each DOP₁, DOP₂, . . . , DOP_{N_DM} may be configured to satisfy, for example, 0≤DOP₁, DOP₂, . . . , DOP_{N_DM}<1/(TrL_{oc}) in order to be used in combination with the encoding by encoder 107 described later. Alternatively, DOP₁, DOP₂, . . . , DOP_{N_DM} may be configured to satisfy, for example, Expression 1:

$$\begin{matrix}[ 1 ] & \\ \frac{- 1}{2 {T}_{r} {L}_{oc}} \leq {DOP}_{1} , {DOP}_{2} , … , {DOP}_{N \_ DM} < \frac{1}{2 {T}_{r} {L}_{oc}} . & ( Expression 1 )\end{matrix}$$

Further, for example, minimum Doppler shift interval Δf_{MinInterval} between DOP₁, DOP₂, . . . , and DOP_{N_DM} may satisfy following Expression 2. Note that the Doppler shift interval (or, also described as the Doppler multiplexing interval or the Doppler interval) may be defined as the absolute value of the difference between any two Doppler shift amounts among DOP₁, DOP₂, . . . , and DOP_{N_DM}. Here, Loc represents the number of code elements. For example, Loc represents the code length of a code used in encoder 107.

$$\begin{matrix}[ 2 ] & \\ 0 < Δ {f}_{MinInterval} \leq \frac{1}{{T}_{r} {N}_{DM} {L}_{oc}} & ( Expression 2 )\end{matrix}$$

Further, phase rotation amount φ_{ndm} for applying each DOP₁, DOP₂, . . . , DOP_{N_DM} may be allocated, for example, as in following Expression 3:

$$\begin{matrix}[ 3 ] & \\ {ϕ}_{ndm} = 2 π {DOP}_{ndm} / ( \frac{1}{{T}_{r} {L}_{oc}} ) . & ( Expression 3 )\end{matrix}$$

In a case where a Doppler shift amounts with an interval of Δf_{MinInterval} are configured (hereinafter, referred to as “equal-interval Doppler shift amount configuration”), phase rotation amounts φ_{ndm} for applying DOP_{ndm} are assigned, for example, as in following Expression 4:

$$\begin{matrix}[ 4 ] & \\ {ϕ}_{ndm} = 2 π ( ndm - 1 ) Δ {f}_{MinInterval} / ( \frac{1}{{T}_{r} {L}_{oc}} ) . & ( Expression 4 )\end{matrix}$$

Note that, the narrower the minimum Doppler shift interval Δf_{MinInterval} is, the more likely interference between DDM signals is to occur, and the more likely the target detection accuracy is to be reduced (for example, deteriorated). Therefore, it is preferable to further widen the intervals between the Doppler shift amounts within the range that satisfies the constraint condition of Expression 2. For example, in a case where the equality in Expression 2 holds (for example, Δf_{MinInterval}=1/(TᵣN_{DM}L_{OC})), the interval in the Doppler domain between DDM signals can be maximized (hereinafter, referred to as “maximum equal-interval Doppler shift amount configuration”). In this case, phase rotation range greater than or equal to 0 and less than 2π is equally divided into N_{DM} different phase rotation amounts, and DOP₁, DOP₂, . . . , and DOP_{N_DM} are assigned respective different phase rotation amounts. For example, phase rotation amount φ_{ndm} for applying DOP_{ndm} is assigned as given in following Expression 5. Note that, in the following, the angle is expressed in radian.

$$\begin{matrix}[ 5 ] & \\ {ϕ}_{ndm} = \frac{2 π ( ndm - 1 )}{{N}_{DM}} & ( Expression 5 )\end{matrix}$$

Note that the assignment of the phase rotation amounts for applying DOP₁, DOP₂, . . . , and DOP_{N_DM} is not limited to this assignment method. For example, phase rotation amounts φ₁, φ₂, . . . , ON DM may be randomly assigned for DOP₁, DOP₂, . . . , DOP_{N_DM} (where “N_DM” corresponds to N_{DM}) using an assignment table of phase rotation amounts.

Further, in the equal-interval Doppler shift amount configuration, the phase rotation amount may be configured as given in following Expression 6 by setting Δf_{MinInterval}=1/(Tr (N_{DM}+Nᵢₙₜ)L_{OC}) in Expression 4. Here, Nᵢₙₜ takes an integer value.

$$\begin{matrix}[ 6 ] & \\ {ϕ}_{ndm} = \frac{2 π ( ndm - 1 )}{{N}_{DM} + {N}_{int}} & ( Expression 6 )\end{matrix}$$

Encoder 107 configures, for each of phase rotation amounts φ₁ to φ_{N_DM} for applying N_{DM} Doppler shift amounts input from Doppler shift setter 106, the phase rotation amounts based on one or a plurality (equal to or less than N_{CM}) of code sequences. Further, encoder 107 configures the phase rotation amounts, for example, “coded Doppler phase rotation amounts” (hereinafter abbreviated as CDP amounts) that generate coded Doppler multiplexed signals (CDDM signals), based on both the Doppler shift amounts and the code sequences, and outputs the CDP amounts to phase rotator 108.

An example of the operation of encoder 107 will be described below.

For example, it is preferable that encoder 107 use N_{CM} code sequences (for example, number of code multiplexing) each having a code length of Loc, which are less correlated or uncorrelated to one another. The encoder, for example, uses orthogonal code sequences. Note that, code elements constituting an orthogonal code sequence are not limited to real numbers and may include complex number values.

Hereinafter, N_{CM} orthogonal code sequences each having code length Loc will be represented as Code_{ncm}={OC_{ncm}(1), OC_{ncm}(2), . . . , OC_{ncm}(Loc)}. OC_{ncm}(noc) represents the nocth code element in ncmth orthogonal code sequence Code_{ncm}. Here, noc is an index of the code element, and noc=1 to Loc.

The orthogonal code sequence used in encoder 107 may be, for example, a Walsh-Hadamard code. Encoder 107 generates an orthogonal code sequence using a predetermined code length Loc capable of generating N_{CM} orthogonal code sequences.

In encoder 107, the number of code multiplexing (hereinafter referred to as the number of coded Doppler multiplexing) for encoding a DDM signal using ndmth Doppler shift amount DOP_{ndm} input from Doppler shift setter 106 is represented as “N_{CDDM}(ndm).” Here, ndm=1 to N_{DM}.

Encoder 107 configures number N_{CDDM}(ndm) of coded Doppler multiplexing such that the sum of numbers N_{CDDM}(1), N_{CDDM}(2), . . . , and N_{CDDM}(N_{DM}) of coded Doppler multiplexing for encoding the DDM signals is equal to number Nt of transmission antennas used for multiplexing transmission. Thus, radar apparatus 10 is capable of performing multiplexing transmission (hereinafter, referred to as coded Doppler multiplexing transmission (CDDM transmission)) in the Doppler domain and the code domain using Nt transmission antennas.

Further, by using, for example, an equal-interval Doppler shift amount configuration including a maximum equal-interval Doppler shift amount configuration, encoder 107 may configure the number of coded Doppler multiplexing such that it includes different numbers of coded Doppler multiplexing in a range of one or more to N_{CM} or less with respect to numbers N_{CDDM}(1), N_{CDDM}(2), . . . , N_{CDDM}(N_{DM}) of coded Doppler multiplexing. For example, encoder 107 does not configure the number of codes N_{CM} for all the numbers of coded Doppler multiplexing but configures the number of codes N_{CDDM}(ndm) corresponding to at least one DOP_{ndm} such that it is smaller than N_{CM}. Thus, among a plurality of combinations between DOP_{ndm} and orthogonal code sequences, number N_{CDDM}(ndm) of multiplexing (number of coded Doppler multiplexing) by the orthogonal code sequence associated with the at least one DOP_{ndm} may be different from the numbers of coded Doppler multiplexing associated with other Doppler shift amounts. For example, encoder 107 configures the numbers of coded Doppler multiplexing for the DDM signals non-uniformly. With this configuration, for example, the aliasing determination processing in the reception processing described in PTL 6 and PTL 7 allows radar apparatus 10 to individually demultiplex and receive signals transmitted by CDDM from a plurality of transmission antennas over a Doppler range of ±½Tr.

Encoder 107 configures CDP amount ψ_{ndc(ndm), ndm(m)} shown in following Expression 7 for phase rotation amount φ_{ndm} for applying ndmth Doppler shift amount DOP_{ndm} in mth transmission period Tr, and outputs CDP amount ψ_{ndc(ndm), ndm(m)} to phase rotator 108:

$$\begin{matrix}[ 7 ] & \\ {ψ}_{ndc ( ndm ) , ndm} ( m ) = floor [ \frac{( m - 1 )}{Loc} ] \times {φ}_{ndm} + angle [ {OC}_{ndc ( ndm )} ( OC\_INDEX ) ] & ( Expression 7 )\end{matrix}$$

Here, the subscript “ndc(ndm)” represents an index equal to or less than number N_{CDDM}(ndm) of coded Doppler multiplexing for phase rotation amount φ_{ndm} for applying Doppler shift amount DOP_{ndm}. For example, ndc(ndm)=1, . . . , N_{CDDM(ndm)}. Further, angle[x] is an operator that outputs the radian phase of real number x, and is, for example, angle[1]=0, angle[−1]=π, and angle[j]=π/2.

For example, as given by Expression 7, CDP amount ψ_{ndc(ndm),ndm(m)} provides a constant phase rotation amount for applying Doppler shift amount DOP_{ndm} in the duration of Loc transmission periods (“Loc” is the code length used for coding) (for example, the first term in Expression 7), and applies a phase rotation amount corresponding to each of Loc code elements OC_{ndc(ndm)}(1), . . . , OC_{ndc(ndm)}(Loc) of code Code_{ndc(ndm)} used for encoding (the second term in Expression 7).

Further, encoder 107 outputs, in each transmission period (Tr), orthogonal code element index OC_INDEX to radar receiver 200 (output switch 209 described below). OC_INDEX is an orthogonal code element index that indicates an element of orthogonal code sequence Code_{ndc(ndm)}, and is cyclically variable in a range of from 1 to Loc in each transmission period (Tr) as given by following Expression 8:

$$\begin{matrix}[ 8 ] & \\ OC\_INDEX = mod ( m - 1 , Loc ) + 1 & ( Expression 8 )\end{matrix}$$

Here, mod(x, y) denotes a modulo operator and is a function that outputs the remainder after x is divided by y. Further, m=1 to Nc. Nc denotes the number of transmission periods used for radar positioning (hereinafter referred to as “radar-transmission-signal transmission times”). In addition, radar-transmission-signal transmission times Nc is set to an integer multiple of Loc (by a factor of Ncode). For example, Nc=Loc×Ncode.

Next, an example of a method for configuring numbers N_{CDDM}(ndm) of coded Doppler multiplexing for the DDM signals non-uniformly in encoder 107 will be described.

For example, encoder 107 configures number N_{CM} of orthogonal code sequences (e.g., the number of code multiplexing or the number of codes) satisfying the condition below. For example, number N_{CM} of orthogonal code sequences and number N_{DM} of Doppler multiplexing satisfy the following relationship for number Nt of transmission antennas used for multiplexing transmission:

(Number N_{CM} of orthogonal code sequences)×(Number N_{DM} of Doppler multiplexing)>Number Nt of transmission antennas used for multiplexing transmission.

Next, a configuration example of CDP amount ψ_{ndc(ndm), ndm(m)} will be described.

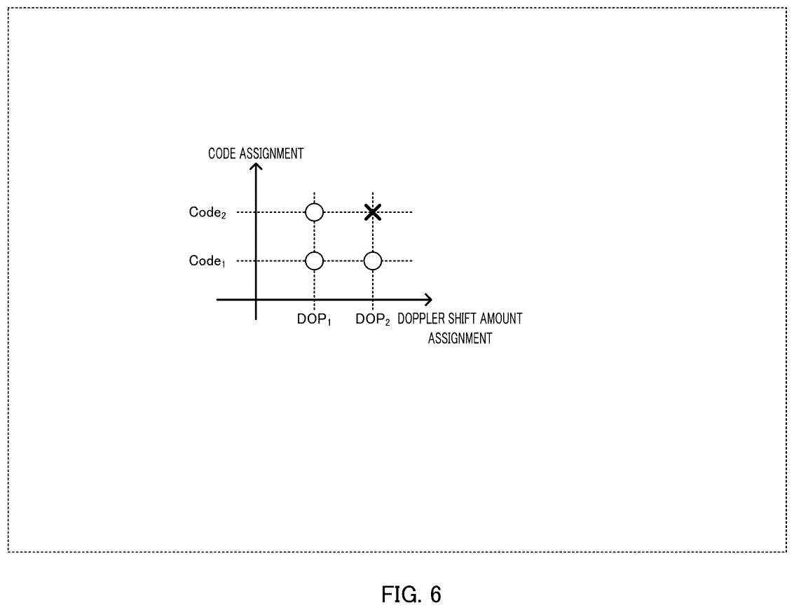

For example, a description will be given of a case where in encoder 107, number Nt of transmission antennas used for multiplexing transmission is 3, number N_{DM} of Doppler multiplexing is 2, and number N_{CM} of code multiplexing is 2, and orthogonal code sequences Code₁={1, 1} and Code₂={1, −1} with code length Loc=2 are used. In this case, for example, as shown in FIG. 6, when the numbers of coded Doppler multiplexing are N_{CDDM}(1)=1 and N_{CDDM}(2)=2, encoder 107 configures CDP amounts ψ_{1, 1}(m), ψ_{1, 2} (m), and ψ_{2, 2}(m) and outputs them to phase rotator 108. For example, when configuring CDP amount ψ_{1,1}(m), encoder 107 performs the configuration as in following Expression 9. Note that, in FIG. 6, “◯” represents the Doppler shift amount and the orthogonal code that are used, and “×” represents the assignment of the Doppler shift amount and the orthogonal code that are not used.

$$\begin{matrix}[ 9 ] & \\ \{ {ψ}_{1 , 1} ( 1 ) , {ψ}_{1 , 1} ( 2 ) , {ψ}_{1 , 1} ( 3 ) , {ψ}_{1 , 1} ( 4 ) , {ψ}_{1 , 1} ( 5 ) , {ψ}_{1 , 1} ( 6 ) , {ψ}_{1 , 1} ( 7 ) , {ψ}_{1 , 1} ( 8 ) , … \} = \{ 0 , 0 , {ϕ}_{1} , {ϕ}_{1} , 2 {ϕ}_{1} , 2 {ϕ}_{1} , 3 {ϕ}_{1} , 3 {ϕ}_{1} , … \} & ( Expression 9 )\end{matrix}$$

The foregoing description has been given of the configuration method for phase rotation amount setter 105 to configure the phase rotation amounts.

In FIG. 4, phase rotators 108 apply the phase rotation amounts in each transmission period Tr to the chirp signals inputted from radar transmission signal generator 101, based on CDP amounts ψ_{ndc(ndm), ndm(m)} configured by phase rotation amount setter 105. Here, ndm=1 to N_{DM}, and ndc(ndm)=1 to N_{CDDM}(ndm).

The outputs from Nt phase rotators 108 (referred to as, for example, CDDM signals) are amplified to a defined transmission power and then radiated into space respectively from the Nt transmission antennas of transmission antenna section 109.

Note that, in the following, phase rotator 108 that applies CDP amount ψ_{ndc(ndm), ndm}(m) is also referred to as “phase rotator PROT #[ndc(ndm), ndm].” Similarly, a transmission antenna for emitting the output of phase rotator PROT #[ndc(ndm), ndm] into space is also referred to as “transmission antenna Tx #[ndc(ndm), ndm].” Here, ndm=1 to N_{DM}, and ndc(ndm)=1 to N_{CDDM}(ndm). Alternatively, the Nt transmission antennas are also referred to as Tx #1, Tx #2, . . . , and Tx #Nt. The CDP amounts applied to the radar transmission signals transmitted from Tx #1, Tx #2, . . . , and Tx #Nt can be associated using a table or the like known in advance. For example, by determining (or detecting) CDP amount ψ_{ndc(ndm), ndm}(m), it is possible to determine (or detect) the transmission antenna.

For example, in the case of the example illustrated in FIG. 6, CDP amounts ψ_{1, 1}(m), ψ_{1, 2}(m), and ψ_{2, 2}(m) are input to phase rotator 108 from encoder 107 for each transmission period.

For example, phase rotator PROT #[1, 1] outputs a signal exp [jψ_{1, 1}(m)]cp(t) to which phase rotation amount ψ_{1, 1}(m) is applied at each mth transmission period to chirp signal cp(t) generated at each transmission period by radar transmission signal generator 101. The output of phase rotator PROT #[1, 1] is output from transmission antenna Tx #[1, 1]. Here, cp(t) denotes a chirp signal for each transmission period. Similarly, the output of phase rotator PROT #[1, 2] is output from Tx #[1, 2], and the output of phase rotator PROT #[2, 2] is output from Tx #[2, 2].

The configuration example of CDP amount ψ_{ndc(ndm), ndm(m)} has been described above.

Further, in the present embodiment, when numbers N_{CDDM}(ndm) of coded Doppler multiplexing for the DDM signals are configured non-uniformly, the numbers of multiplexing (for example, number N_{CDDM}(ndm) of coded Doppler multiplexing) by orthogonal code sequences Code_{ncm} corresponding respectively to Doppler shift amounts DOP_{ndm} may be different among the combinations of Doppler shift amounts DOP_{ndm} and orthogonal code sequences Code_{ncm}.

Further, in the present embodiment, when numbers N_{CDDM}(ndm) of coded Doppler multiplexing for the DDM signals are configured uniformly, the numbers of multiplexing by orthogonal code sequences Code_{ncm} (for example, numbers N_{CDDM}(ndm) of coded Doppler multiplexing) corresponding respectively to DOP_{ndm} may be the same among the combinations of DOP_{ndm} and orthogonal code sequences Code_{ncm}. In this case, the number of combinations of DOP_{ndm} and the orthogonal code sequences and number Nt of transmission antennas may be the same (for example, N_{DM}×N_{CM}=Nt).

Further, in the present embodiment, for example, Tx #1 to Tx #Nt of transmission antenna section 109 include transmission antennas of at least two different polarizations, and constitute a polarimetric radar. For example, Tx #1 to Tx #Nt may include transmission antennas that are orthogonal to each other as different polarizations. Also, there may be a plurality of transmission antennas of at least one of the polarizations, and at least one transmission antenna for the other polarizations.

Radar apparatus 10 (for example, phase rotation amount setter 105) configures different CDP amounts ψ_{ndc(ndm), ndm(m)} respectively for the transmission antennas, for example, considering transmission antennas of different polarizations. Radar apparatus 10 (for example, phase rotator 108) may apply CDP amounts ψ_{ndc(ndm), ndm(m)} configured in this manner to the chirp signals and output the chirp signals to transmission antenna section 109.

Thus, even in a case where the reception levels between reception signals corresponding to the transmission antennas of different polarizations are significantly different (for example, in a case where the reception level difference or the reception level ratio is equal to or larger than a threshold), radar apparatus 10 makes it possible to demultiplex CDDM signals and prevents the degradation of the positioning performance and the radar detection performance (an exemplary operation will be described later).

Hereinafter, an exemplary operation of phase rotation amount setter 105 in radar transmitter 100 in a case of configuring a polarimetric MIMO radar including at least two transmission antennas of different polarizations will be described.

Note that number Nt of transmission antennas≥3, number N_{DM} of Doppler multiplexing ≥2, number N_{CM} of code multiplexing ≥2 or more, and Nt<N_{DM}×N_{CM}. As described above, number Nt of the plurality of transmission antennas may be less than the total number of combinations of the Doppler shift amount and the code sequence (N_{DM}×N_{CM}). Note that, Nt may be the same as the total number of combinations of the Doppler shift amount and the code sequence (N_{DM}×N_{CM}).

Further, the number of different polarizations included in the transmission antennas (hereinafter, referred to as “number of transmission polarizations”) are represented as “NPL.” Further, the polarization of the qth is described as “PLq.” The character “q” is an integer value within numbers NPL of transmission polarizations (for example, any of q=1 to NPL).

Further, the number of transmission antennas of PLq polarization is denoted as “N_{PLq}.” N_{PLq}≥1, and the total number of transmission antennas of respective PLq polarizations is Nt. For example, in a case of NPL=2, number N_{PL1} of transmission antennas of PL1 polarization is N_{PL1}≥1, number N_{PL2} of transmission antennas of PL2 polarization is N_{PL2}≥1, and N_{PL1}+N_{PL2}=Nₜ.

Further, the number of Doppler multiplexing assigned for the transmission antenna of PLq polarization is denoted as “N_{DM_PLq}.” Here, N_{DM_PLq}≤N_{DM}. For example, in a case of NPL=2, N_{DM_PL1} and N_{DM_PL2}≤N_{DM}.

Radar apparatus 10 includes N_{PL1} and N_{PL2} transmission antennas of different PL1 polarization and PL2 polarization, respectively, and uses at least two polarizations. Phase rotation amount setter 105 in radar transmitter 100 of radar apparatus 10 (for example, a polarimetric MIMO radar) configures number N_{CDDM}(ndm) of coded Doppler multiplexing for the DDM signal non-uniformly, and configures CDP amount ψ_{ndc(ndm), ndm(m)} that satisfies following Condition 1. Here, ndm=1 to N_{DM}, and ndc(ndm)=1 to N_{CDDM}(ndm).

### <Condition 1>

For example, the patterns of the Doppler shift amount and the code sequence assigned for the transmission antenna of the PL1 polarization (for example, the pattern of the coded Doppler division multiplexing (CDDM) and the pattern of the CDDM assigned for the transmission antenna of the PL2 polarization are made different from each other. For example, phase rotation amount setter 105 configures CDP amount ψ_{ndc(ndm), ndm(m)} that satisfies a condition of a different Doppler multiplexing (DDM) pattern (for example, an assignment pattern of a Doppler shift amount), a condition of a different code multiplexing (CDM) pattern (for example, a different number of code multiplexing between DDM signals), or a condition of different patterns of DDM and CDM for each of the transmission antenna of PL1 polarization and the transmission antenna of PL2 polarization.

For example, the condition for different DDM patterns may be any one of the following conditions (for example, also referred to as “Condition 1A” or “1A of Condition 1”)
1A) Different DDM signal pattern conditions:
(A-1) The numbers of Doppler multiplexing corresponding to polarizations (for example, the numbers of Doppler multiplexing of transmission signals transmitted from transmission antennas of the polarizations) are the same (for example, N_{DM_PL1}=N_{DM_PL2}; however, N_{DM_PL1}=N_{DM_PL2≥}2), and include different Doppler shift intervals for the polarizations, respectively (for example, intervals of Doppler shift amounts associated with transmission antennas of each polarization).
(A-2) The number of Doppler multiplexing for each polarization (for example, the number of Doppler multiplexing for a transmission signal transmitted from a transmission antenna for each polarization) is different (N_{DM_PL1}≠N_{DM_PL2}).
(A-3) In a case where N_{DM_PL1}≥3 and N_{DM_PL2≥}3 and when the Doppler shift intervals for respective polarizations include the same Doppler shift interval, the orders of the Doppler shift intervals are different from each other (have a cyclic mismatch).

Further, for example, the condition of a different CDM pattern may be any one of the following conditions (for example, also referred to as “Condition 1B”).
(B-1) The code intervals (for example, code index intervals) assigned for respective DDM signals are different from each other (have a cyclic mismatch).
(B-2) The numbers of code multiplexing assigned for respective DDM signals are different from each other (have a cyclic mismatch).

Further, phase rotation amount setter 105 may configure CDP amount ψ_{ndc(ndm), ndm}(m) to satisfy, for example, following Condition 2.

### <Condition 2>

Signals transmitted from transmission antennas of the same polarization are multiplexed and transmitted with numbers of code multiplexing that are non-uniform between DDM signals, and the numbers of code multiplexing include any value in the range of from 1 to N_{CM}−1 or less (the number of code multiplexing of 1 is included in the case of N_{CM}=2). For example, in a plurality of combinations of a Doppler shift amount and a code sequence, the number of code multiplexing by a code sequence associated with at least one Doppler shift amount is different from the number of code multiplexing by a code sequence associated with another Doppler shift amount with respect to at least one transmission antenna of the PL1 polarization and the PL2 polarization.

For example, in A-3 of Condition 1, when each value of a plurality of intervals of the Doppler shift amount to be assigned (for example, a combination of Doppler shift intervals) is the same between the transmission antenna of the PL1 polarization and the transmission antenna of the PL2 polarization, the order of the plurality of Doppler shift intervals corresponding to the transmission antenna of the PL1 polarization on the Doppler frequency axis and the order of the plurality of Doppler shift intervals corresponding to the transmission antenna of the PL2 polarization on the Doppler frequency axis may be different from each other. For example, the combination of intervals included in an array in which the intervals of the Doppler shift amounts assigned for the transmission antenna of the PL1 polarization are arranged in the increasing order on the Doppler frequency axis and the combination of intervals included in an array in which the intervals of the Doppler shift amounts assigned for the transmission antenna of the PL2 polarization are arranged in the increasing order on the Doppler frequency axis match, and the first array and the second array are different arrays in a circular permutation. In a case where A-3 of Condition 1 is satisfied, the Doppler shift interval of the transmission antenna of PL1 polarization and the Doppler shift interval of the transmission antenna of PL2 polarization do not match (become cyclically mismatched) even if either one is cyclically shifted in the Doppler frequency domain.

Further, for example, in B-1 of Condition 1, the order of the code sequences associated with the transmission antenna of the PL1 polarization on the Doppler frequency axis and the order of the code sequences associated with the transmission antenna of the PL2 polarization on the Doppler frequency axis may be different from each other. For example, an array in which the indices of the code sequences corresponding to the Doppler shift amounts assigned for transmission antennas of the PL1 polarization are arranged in the increasing order on the Doppler frequency axis and an array in which the indices of the code sequences corresponding to the Doppler shift amounts assigned for transmission antennas of the PL2 polarization are arranged in the increasing order on the Doppler frequency axis are different arrays in a circular permutation. In a case where B-1 of Condition 1 is satisfied, the indices of the code sequences corresponding to Doppler shift amounts for the transmission antennas of the PL1 polarization and the indices of the code sequences corresponding to Doppler shift amounts for the transmission antennas of the PL2 polarization do not match (become cyclically mismatched) even if either one is cyclically shifted in the Doppler frequency domain.

Further, for example, in B-2 of Condition 1, the order of the numbers of code multiplexing by the code sequences associated with the transmission antennas of the PL1 polarization on the Doppler frequency axis and the order of the numbers of code multiplexing by the code sequences associated with the transmission antennas of the PL2 polarization on the Doppler frequency axis may be different from each other. For example, an array in which the numbers of code multiplexing corresponding to the Doppler shift amounts assigned for the transmission antennas of the PL1 polarization are arranged in the increasing order on the Doppler frequency axis and an array in which the numbers of code multiplexing corresponding to the Doppler shift amounts assigned for the transmission antennas of the PL2 polarization are arranged in the increasing order on the Doppler frequency axis are different arrays in a circular permutation. In a case where B-2 of Condition 1 is satisfied, the numbers of code multiplexing corresponding to Doppler shift amounts for the transmission antennas of the PL1 polarization and the numbers of code multiplexing corresponding to Doppler shift amounts for the transmission antennas of the PL2 polarization do not match (become cyclically mismatched) even if either one is cyclically shifted in the Doppler frequency domain.

Radar apparatus 10 achieves the following effects by applying CDP amounts that satisfy above Condition 1 to the transmission antennas.

For example, the Doppler frequency of the reception signal includes the coded Doppler phase rotation at the time of transmission as described above, and further includes the Doppler frequency of an unknown target object. For this reason, there is a possibility that the Doppler frequencies of the DDM signals may change in the positive direction or the negative direction while maintaining the intervals between the DDM signals. For example, by satisfying 1A of Condition 1, radar apparatus 10 can distinguish between a case where a CDDM signal assigned for a transmission antenna of PL1 polarization is received and a CDDM signal assigned for a transmission antenna of PL2 polarization is not received, and a case where a CDDM signal assigned for a transmission antenna of PL2 polarization is received and a CDDM signal assigned for a transmission antenna of PL1 polarization is not received, because the intervals or the numbers of Doppler multiplexing (for example, DDM pattern) of the DDM signals are different from one another in these cases.

Further, for example, by satisfying 1B of Condition 1, radar apparatus 10 can distinguish between a case where a CDDM signal assigned for a transmission antenna of PL1 polarization is received and a CDDM signal assigned for a transmission antenna of PL2 polarization is not received, and a case where a CDDM signal assigned for a transmission antenna of PL2 polarization is received and a CDDM signal assigned for a transmission antenna of PL1 polarization is not received, because the code intervals or the numbers of code multiplexing (for example, CDM pattern) at which the reception level becomes high after each DDM signal is code-demultiplexed are different from each other.

Thus, by configuring the CDP amounts by phase rotation amount setter 105 to satisfy Condition 1, radar apparatus 10 can demultiplex CDDM signals and prevent the degradation of positioning performance and radar detection performance even in cases where the reception levels between reception signals corresponding to transmission antennas of different polarizations vary significantly.

Further, by satisfying Condition 2 in addition to Condition 1, the configuration of the CDP amounts by phase rotation amount setter 105 allows the Doppler frequency range in which detection can be performed in radar apparatus 10 to be −1/(2Tr)≤f_{d}<1/(2Tr); it is thus possible to expand the range to a range equivalent to the Doppler detection range in the case of one transmission antenna (an example will be described later).

For example, in CDDM transmission by radar apparatus 10, both Condition 1 and Condition 2 may be satisfied, or Condition 1 may be satisfied and Condition 2 may not be satisfied. Examples of the case in which Condition 1 is satisfied but Condition 2 is not satisfied include the following three cases.

Case 1 is a case where neither PL1 polarization nor PL2 polarization satisfies Condition 2, and Doppler frequency range f_{d} in which detection can be successful is the range of −1/(2Tr)≤f_{d}<1/(2Tr), or the range of −1/(2Loc N_{DM_PL1}Tr)≤f_{d}<1/(2Loc N_{DM_PL1}Tr), or the range of −1/(2Loc N_{DM_PL2} Tr)≤f_{d}<1/(2Loc N_{DM_PL2}Tr). Case 2 is a case where PL2 polarization does not satisfy Condition 2, and Doppler frequency range f_{d} in which detection can be successful is the range of −1/(2Tr)≤f_{d}<1/(2Tr) or the range of −1/(2Loc N_{DM_PL2}Tr)≤f_{d}<1/(2Loc N_{DM_PL2}Tr). Case 3 is a case where PL1 polarization does not satisfy Condition 2, and Doppler frequency range f_{d} in which detection can be successful is the range of −1/(2Tr)≤f_{d}<1/(2Tr) or the range of −1/(2LocN_{DM_PL1}Tr)≤f_{d}<1/(2LocN_{DM_PL1}Tr).

In any of Cases 1 to 3, by satisfying Nt>Loc N_{DM_PL1} or Nₜ>Loc N_{DM_PL2}, the Doppler frequency range in which detection can be successful can be expanded beyond the Doppler detection range of −1/(2NtTr)≤f_{d}<1/(2NtTr) in the case of equal-interval Doppler multiplexing.

Hereinafter, an example of the CDP amount configuration in phase rotation amount setter 105 will be described.

Hereinafter, the interval of the Doppler shift amounts to be applied to Tx #n1 and Tx #n2 will be referred to as Doppler shift interval “Δfd_{(n1, n2)}.” Here, Δfd_{(n1, n2)} represents the interval (DOPₙ₂−DOPₙ₁) between Doppler shift amount DOPₙ₂ applied to Tx #n2 and Doppler shift amount DOPₙ₁ applied to Tx #n1 as a reference. Note that, in a case where Doppler shift interval Δfd_{(n1, n2)} is a negative value (for example, in a case where (DOPₙ₂−DOPₙ₁)<0), Doppler shift interval Δfd_{(n1, n2)} is calculated using Δfd_{(n1, n2)}=1/Loc Tr−Δfd_{(n1, n2)} in consideration of aliasing in a range from −1/(2 Loc Tr) through 1/(2 Loc Tr), which is an observation range in Doppler analyzers 210 described later, and is represented as a positive value. The description of Doppler shift interval Δfd_{(n1, n2)} in the following explanation will also use the same notation.

### Configuration Example 1

Configuration Example 1 is a configuration example of the CDP amount in a case where Condition 1 (different-CDM-pattern condition) is satisfied and Condition 2 is satisfied.

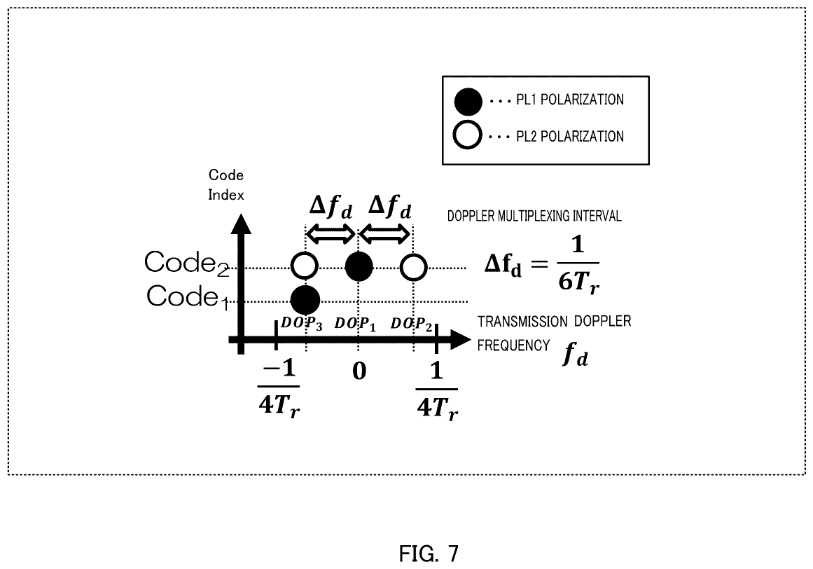

FIG. 7 illustrates an example of the CDP amount configuration in phase rotation amount setter 105 in a case where number Nt of transmission antennas is 4, N_{PL1} is 2, and N_{PL2} is 2. In FIG. 7, black circles (●) indicate the assignment of CDDM signals for transmission antennas (Tx #1 and Tx #2) of PL1 polarization, and white circles (◯) indicate the assignment of CDDM signals for transmission antennas (Tx #3 and Tx #4) of PL2 polarization.

Further, in FIG. 7, number N_{DM} of Doppler multiplexing=3, and Doppler shift setter 106 may configure three DOP₁ to DOP₃ using, for example, the maximum equal-interval Doppler shift amount configuration shown in Expression 5. In FIG. 7, phase rotation amount φ₁=0 for applying DOP₁=0, phase rotation amount φ₂=2π/3 for applying DOP₂=Δfd, and phase rotation amount φ₃=4π/3 (φ₃=−2π/3 may be used) for applying DOP₃=−Δfd. As illustrated in FIG. 7, the interval (also referred to as a Doppler multiplexing interval, a Doppler shift interval, or a Doppler interval) Δfd between DDM signals is an equal interval, and Δfd=1/(6Tr).

Further, in FIG. 7, number N_{CM} of code multiplexing=2, and encoder 107 uses Code₁={1, 1} and Code₂={1, −1}, which are orthogonal code sequences with code length Loc=2. Further, in Configuration Examples 2 to 3 described later, number N_{CM} of code multiplexing is 2, and the same codes may be used.

In FIG. 7, number Nt of transmission antennas is 4, number N_{DM} of Doppler multiplexing is 3, and number N_{CM} of code multiplexing is 2, and thus, since Nt<N_{DM}×N_{CM}, phase rotation amount setter 105 can configure numbers N_{CDDM}(ndm) of coded Doppler multiplexing for the DDM signals non-uniformly (here, ndm=1 to N_{DM}).

As illustrated in FIG. 7, the numbers of coded Doppler multiplexing for the DDM signals using three DOP₁ to DOP₃ input from Doppler shift setter 106 in encoder 107 are N_{CDDM}(1)=1, N_{CDDM}(2)=1, and N_{CDDM}(3)=2, respectively. As described above, phase rotation amount setter 105 configures the numbers of coded Doppler multiplexing for the DDM signals non-uniformly.

Further, in FIG. 7, Doppler shift setter 106 assigns, for transmission antennas Tx #1 and Tx #2 of PL1 polarization, DDM signals for which, for example, Doppler shift amounts DOP₁ and DOP₃ are used (N_{DM_PL1}=2), from among the DDM signals with number N_{DM} of Doppler multiplexing=3. Further, encoder 107 assigns Code₂ and Code₁ to DOP₁ and DOP₃ assigned for Tx #1 and Tx #2 of the PL1 polarization, respectively. Hereinafter, such an assignment will be described as configuring, by phase rotation amount setter 105, CDP amounts ψ_{2, 1}(m) and ψ_{1, 3}(m) for Tx #1 and Tx #2 of the PL1 polarization. Further, in FIG. 7, Doppler shift setter 106 assigns, for transmission antennas Tx #3 and Tx #4 of PL2 polarization, DDM signals for which, for example, Doppler shift amounts DOP₂ and DOP₃ are used (N_{DM_PL2}=2), from among the DDM signals with number N_{DM} of Doppler multiplexing=3.

For example, phase rotation amount setter 105 configures CDP amounts ψ_{2, 2}(m) and ψ_{2, 3}(m) respectively for Tx #3 and Tx #4 of the PL2 polarization.

In FIG. 7, the numbers of Doppler multiplexing that Doppler shift setter 106 assigns for the transmission antennas of PL1 polarization and the transmission antennas of PL2 polarization are N_{DM_PL1}=N_{DM_PL2}=2, and are the same. Further, the Doppler shift intervals of the DDM signals assigned for Tx #1 to #2 of PL1 polarization are Δfd (1,2)=Δ2fd and Δfd (2,1)=Δfd, and the Doppler shift intervals of the DDM signals assigned for Tx #3 to #4 of PL2 polarization are Δfd (3,4)=Δfd and Δfd (4,3)=2Δfd, and are the same (cyclically matched).

Accordingly, the CDP amount configuration illustrated in FIG. 7 does not match any of the DDM pattern conditions in Condition 1A.

Further, in FIG. 7, the codes assigned for the transmission antennas of the PL1 polarization for DDM signals using DOP₁ to DOP₃ are [Code₂, no assignment, Code₁], and the number of code multiplexing assigned for each DDM signal is 0 or 1.

Hereinafter, the code indices assigned for the transmission antennas of the PL1 polarization respectively for DDM signals using Doppler shift amounts DOP₁ to DOP₃ will be described as “CiPL1=(2, *, 1).” In CiPL1, “*” represents a case where no code is assigned. Further, in a case where a plurality of codes is assigned for one DDM signal, the codes are represented using “&.” For example, in a case where Code₁ and Code₂ are assigned for one DDM signal, the notation is represented as “1&2.” The code index is also referred to as “code interval.”

Further, hereinafter, the numbers of code multiplexing assigned for the transmission antennas of the PL1 polarization respectively for DDM signals using Doppler shift amounts DOP₁ to DOP₃ will be described as “NcPL1=(1, 0, 1)” (in the case of FIG. 7).

In FIG. 7, the codes assigned for the transmission antennas of the PL2 polarization respectively for DDM signals using DOP₁ to DOP₃ are [No assignment, Code₂, Code₂], and the number of code multiplexing assigned for each DDM signal is 0 or 1. Note that, similar to PL1 polarization, the code indices assigned for the transmission antennas of PL2 polarization respectively for DDM signals using DOP₁ to DOP₃ are represented as “CiPL2=(*, 2, 2).” Further, the numbers of code multiplexing assigned for the transmission antennas of the PL2 polarization respectively for DDM signals using DOP₁ to DOP₃ are described as “NcPL2=(0, 1, 1).”

As described above, the numbers of code multiplexing assigned for DDM signals for the transmission antennas of the PL1 polarization and the transmission antennas of the PL2 polarization are NcPL1=(1, 0, 1) and NcPL2=(0, 1, 1), respectively, and are cyclically matched, and thus, B-2 of Condition 1 is not satisfied.

On the other hand, the code indices assigned for DDM signals for the transmission antennas of the PL1 polarization and the transmission antennas of the PL2 polarization are CiPL1=(2, *, 1) and CiPL2=(*, 2, 2), respectively, and are different from each other (or, cyclically mismatched). Hereinafter, the difference in the INDEX interval will be referred to as a different INDEX interval.

Further, in a case where the Doppler frequency of the target object is −1/(2Tr)≤f_{dtg}<−1/(4Tr) or 1/(4Tr)≤f_{dtg}<1/(2Tr), an aliased Doppler frequency is observed in Doppler analyzers 210 described later. In this case, the code indices are CiPL1ₐₗᵢₐₛ=(1, *, 2) and CiPL2ₐₗᵢₐₛ=(*, 1, 1), which are different from each other (cyclically mismatched). Thus, in the example of FIG. 7, the code indices have a cyclic mismatch and the code intervals are different from each other in a range of −1/(2Tr)≤f_{dtg}<−1/(2Tr) of the Doppler frequency of the target object.

Accordingly, the code intervals assigned respectively for the DDM signals differ from each other between polarizations, satisfying B-1 of Condition 1 and matching a different-CDM-pattern condition.

Thus, the configuration of the CDP amounts illustrated in FIG. 7 is an example of a configuration that satisfies Condition 1.

Further, in FIG. 7, the number of code multiplexing assigned for each DDM signal in the transmission antenna of the PL1 polarization is NcPL1=(1, 0, 1), and the number of code multiplexing assigned for each DDM signal in the transmission antenna of the PL2 polarization is NcPL2=(0, 1, 1). Multiplexing transmission of both the signals is performed with the number of code multiplexing that is non-uniform between the DDM signals, and the number of code multiplexing is included in a range of from 1 to N_{CM}−1, inclusive.

Thus, in the example of FIG. 7, the signals transmitted from the transmission antennas of the same polarization (for example, each of PL1 polarization and PL2 polarization) are multiplexed and transmitted with the number of code multiplexing that is non-uniform between DDM signals, and the number of code multiplexing is included in a range of from 1 to N_{CM}−1, inclusive. Accordingly, the configuration of the CDP amounts illustrated in FIG. 7 is an example of a configuration that satisfies Condition 2 for both the PL1 polarization and the PL2 polarization.

Hereinafter, based on the configuration of the CDP amounts in phase rotation amount setter 105 as illustrated in FIG. 7, a description will be given of an example of a reception signal in the outputs of Doppler analyzers 210 in a case where, for example, transmission antenna section 109 in which PL1 polarization is left-handed circular polarization (LC) and PL2 polarization is right-handed circular polarization (RC) is used and reception antenna section 202 uses an LC polarization (PL1 polarization) antenna.

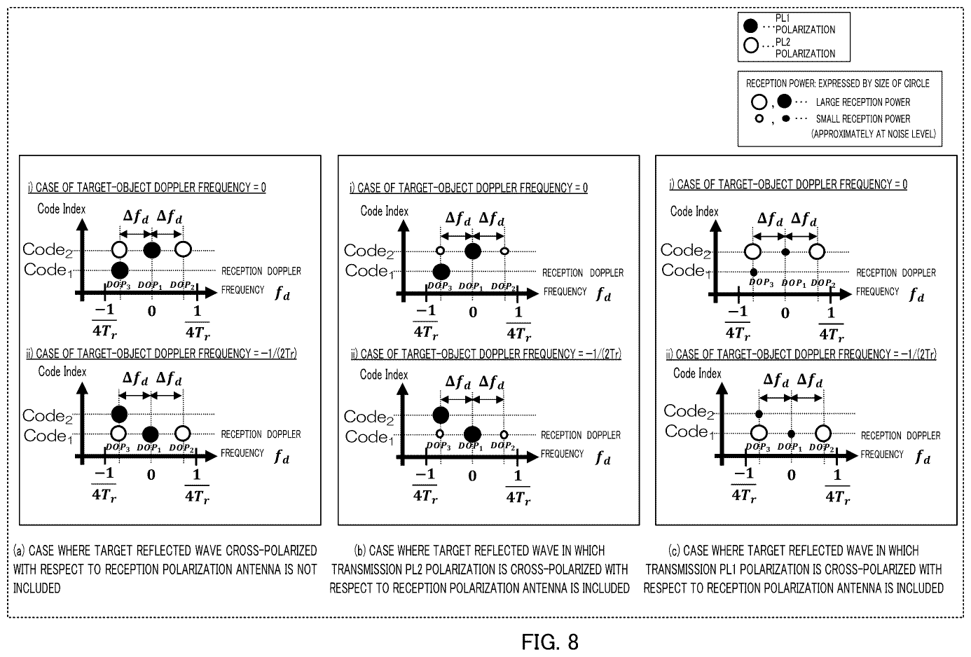

FIG. 8 illustrates an example of the outputs of Doppler analyzers 210 for a target-object reflected wave at a certain distance index. For example, the target-object reflected wave includes the Doppler frequency of f_{dtg} of the target object. Accordingly, radar apparatus 10 receives a signal that is Doppler-shifted by f_{dtg} from the Doppler shift amount configured in radar transmitter 100. FIG. 8 illustrates, as an example, a case where Doppler frequency f_{dtg} of the target-object reflected wave is 0, and a case where f_{dtg} is −1/(2Tr).

Note that, in FIG. 8, the reception power is represented by the size of the black circles (●) and white circles (◯). The smaller the size of black circles (●) and white circles (◯), the smaller the reception power (for example, the reception power is as small as the noise level) (the same notation is used in the following configuration examples).

In this case, when the reflected wave of the radar transmission wave reflected by the target object includes many scattered waves or is a reflected wave with many reflections, the reflected wave may contain various polarizations. Therefore, the reception level of the reception signal in radar apparatus 10 is less likely to vary significantly between reception signals corresponding to differently polarized transmission antennas (for example, PL1-polarized transmission antenna and PL2-polarized transmission antenna). Thus, radar apparatus 10 receives the reception signal corresponding to the RC polarization (PL2 polarization) transmission antenna and the reception signal corresponding to the LC polarization (PL1 polarization) transmission antenna at approximately the same reception level.

For example, in the configuration of the CDP amounts illustrated in FIG. 7, when the reception signal does not include a target-object reflected wave that is cross-polarized with respect to the polarization of the reception antenna (for example, LC polarization (PL1 polarization)), a reception signal as illustrated in (a) of FIG. 8 is obtained. As illustrated in (a) of FIG. 8, the reception levels of the reception signals corresponding respectively to Tx #1 and Tx #2 (PL1 polarization), and Tx #3 and Tx #4 (PL2 polarization) are substantially the same.

Further, for example, when radar apparatus 10 receives a reflected wave of a radar transmission wave specularly reflected (for example, from a surface with little unevenness) by the target object (for example, one specular reflection), the reception level may vary between polarized transmission antennas. For example, the reception signal corresponding to the LC polarization (PL1 polarization) transmission antenna becomes a signal of the same polarization as the reception antenna of LC polarization (PL1 polarization). On the other hand, for example, the reception signal corresponding to the RC polarization (PL2 polarization) transmission antenna becomes a signal cross polarized with respect to the reception antenna of LC polarization (PL1 polarization). Therefore, the reception signal corresponding to the RC polarization (PL2 polarization) transmission antenna may have a lower reception level (for example, lower by 10 dB or more depending on the cross-polarization discrimination degree of the antenna) compared to the reception signal corresponding to the LC polarization (PL1 polarization) transmission antenna. For example, depending on the received SNR, the reception signal corresponding to the RC polarization (PL2 polarization) transmission antenna may fall below the noise level, making it difficult for radar apparatus 10 to detect the peak of the Doppler frequency.

For example, in the case of the CDP amount configuration shown in FIG. 7, when target-object reflected waves in which RC polarization (PL2 polarization) is cross-polarized with respect to the polarization of the reception antenna (for example, LC polarization (PL1 polarization)) are included, a reception signal like that at part (b) in FIG. 8 is obtained. As shown at part (b) in FIG. 8, the reception levels of the reception signals corresponding to Tx #3 and Tx #4 (PL2 polarization) become smaller compared to the reception levels of the reception signals corresponding to Tx #1 and Tx #2 (PL1 polarization).

Further, for example, when radar apparatus 10 receives a reflected wave of a radar transmission wave specularly reflected by the target object and then further specularly reflected by a surface such as a road (for example, two specular reflections), the reception level may vary between polarized transmission antennas. For example, the reception signal corresponding to the RC polarization (PL2 polarization) transmission antenna becomes a signal of the same polarization as the reception antenna of LC polarization (PL1 polarization). On the other hand, for example, the reception signal corresponding to the LC polarization (PL1 polarization) transmission antenna becomes a signal cross polarized with respect to the reception antenna of LC polarization (PL1 polarization). Therefore, the reception signal corresponding to the LC polarization (PL1 polarization) transmission antenna may have a lower reception level compared to the reception signal corresponding to the RC polarization (PL2 polarization) transmission antenna (for example, lower by 10 dB or more depending on the cross-polarization discrimination degree of the antenna reception level). For example, depending on the received SNR, the reception signal from the LC polarization (PL1 polarization) transmission antenna may fall below the noise level, making it difficult for radar apparatus 10 to detect the peak of the Doppler frequency.

For example, in the case of the CDP amount configuration shown in FIG. 7, when target-object reflected waves in which LC polarization (PL1 polarization) is cross-polarized with respect to the polarization of the reception antenna (for example, LC polarization (PL1 polarization)) are included, a reception signal like that at part (c) in FIG. 8 is obtained. As shown at part (c) in FIG. 8, the reception levels of the reception signals corresponding to Tx #1 and Tx #2 (PL1 polarization) becomes smaller compared to the reception levels of the reception signals corresponding to Tx #3 and Tx #4 (PL2 polarization).

For example, as shown at part (a) in FIG. 8, when no target-object reflected wave which is cross-polarized with respect to the polarization of the reception antenna is included, radar apparatus 10 receives the reception signal corresponding to each of the RC polarization (PL2 polarization) transmission antennas (Tx #3 and Tx #4), and the LC polarization (PL1 polarization) transmission antennas (Tx #1 and Tx #2) at almost the same level or at a level within a range of approximately several dB to 6 dB. Here, in (a) of FIG. 8, the signals transmitted from number Nt of Tx #1 to Tx #4, which are composed of transmission antennas of RC polarization (PL2 polarization) and transmission antennas of LC polarization (PL1 polarization), are CDDM-transmitted using CDP amounts that make numbers N_{CDDM}(ndm) of coded Doppler multiplexing for respective DDM signals non-uniform. Thus, radar apparatus 10 can demultiplex CDDM signals based on the existing demultiplexing operation on CDDM signals (see, for example, PTL 7).

Further, as shown in parts (b) and (c) in FIG. 8, when a target-object reflected wave that is cross-polarized with respect to the polarization of the reception antenna, radar apparatus 10 receives different CDDM signals (for example, CDDM signals that meet B-1 of Condition 1) in the case where PL2 polarization includes target-object reflected waves that are cross-polarized (part (b) in FIG. 8) and in the case where PL1 polarization includes target-object reflected waves that are cross-polarized (part (c) in FIG. 8).

For example, i) of (b) of FIG. 8 illustrates a reception signal in which the Doppler frequency of the target-object reflected wave with PL2 polarization as a cross-polarization is f_{dtg}=0. In radar apparatus 10, each DDM signal is received with a cyclic shift on the Doppler frequency axis depending on the Doppler frequency of the target object. Regarding the code index assigned for each DDM signal, the Doppler frequency of the target object is −1/(4Tr)≤f_{dtg}<−1/(4Tr) and CiPL1=(2, *,1).

Further, ii) in (b) of FIG. 8 illustrates a reception signal in which the Doppler frequency of the target-object reflected wave in which the PL2 polarization is a cross-polarization is f_{dtg}=−1/(2Tr). In radar apparatus 10, each DDM signal is received with a cyclic shift on the Doppler frequency axis depending on the Doppler frequency of the target object. Regarding the code index assigned for each DDM signal, the Doppler frequency of the target object is −1/(2Tr)≤f_{dtg}<−1/(4Tr) or 1/(4Tr)≤f_{dtg}<1/(2Tr), and CiPL1ₐₗᵢₐₛ=(1,*,2).

Further, for example, i) of (c) of FIG. 8 illustrates a reception signal in which the Doppler frequency of the target-object reflected wave with PL1 polarization as a cross-polarization is f_{dtg}=0. In radar apparatus 10, each DDM signal is received with a cyclic shift on the Doppler frequency axis depending on the Doppler frequency of the target object. Regarding the code indices assigned respectively for the DDM signals, the Doppler frequency of the target object is −1/(4Tr)≤f_{dtg}<−1/(4Tr), and CiPL2=(*, 2, 2).

Further, ii) of (c) of FIG. 8 illustrates a reception signal in which the Doppler frequency of the target-object reflected wave in which the PL1 polarization is a cross-polarization is f_{dtg}=−1/(2Tr). In radar apparatus 10, each DDM signal is received with a cyclic shift on the Doppler frequency axis depending on the Doppler frequency of the target object. Regarding the code indices assigned respectively for the DDM signals, the Doppler frequency of the target object is −1/(2Tr)≤f_{dtg}<−1/(4Tr) or 1/(4Tr)≤f_{dtg}<1/(2Tr), and CiPL2ₐₗᵢₐₛ=(*, 1, 1).

As described above, in a case where the target-object reflected wave that is cross-polarized with respect to the polarization of the reception antenna is included, radar apparatus 10 receives a reflected wave signal being a CDDM signal different in pattern (for example, pattern of code indices or code intervals) between a case where the reception level of the reception signal corresponding to the transmission antenna of the PL1 polarization decreases and a case where the reception level of the reception signal corresponding to the transmission antenna of the PL2 polarization decreases, even when a DDM signal is received with a cyclic shift on the Doppler frequency axis by the Doppler frequency of the target object.

As a result, radar apparatus 10 becomes capable of determining, for example, based on the detected peaks of the Doppler frequency after code demultiplexing, whether a decrease in the reception level of the reception signal corresponding to the PL1-polarized (e.g., LC-polarized) transmission antenna has occurred, or whether a decrease in the reception level of the reception signal corresponding to the PL2-polarized (e.g., RC-polarized) transmission antenna has occurred, in coded Doppler demultiplexer 212 described later.

Further, for example, the DDM signals of the PL1 polarization are multiplexed and transmitted with number NcPL1 of code multiplexing=(1, 0, 1), which is non-uniform between the DDM signals (for example, the number of code multiplexing is 0 or 1 for three DDM signals, and thus, the transmission can be regarded as CDDM transmission that is non-uniform). Thus, for example, in a case where the reception signal is determined to be a reception signal corresponding to a transmission antenna of LC polarization (PL1 polarization) based on the determination result by coded Doppler demultiplexer 212, radar apparatus 10 can demultiplex the CDDM signal using the existing demultiplexing operation on the CDDM signal.

Similarly, for example, the DDM signals of PL2 polarization are multiplexed and transmitted with number NcPL2 of code multiplexing=(0, 1, 1), which is non-uniform between the DDM signals (for example, the number of code multiplexing is 0 or 1 for three DDM signals, and thus, the transmission can be regarded as CDDM transmission that is non-uniform). Thus, for example, in a case where the reception signal is determined to be a reception signal corresponding to a transmission antenna of PL2 polarization based on the determination result by coded Doppler demultiplexer 212, radar apparatus 10 can demultiplex the CDDM signal using the existing demultiplexing operation on the CDDM signal.

By the operation of coded Doppler demultiplexer 212 as described above, radar apparatus 10 can determine Doppler frequency f_{d} of the target object in a range of −1/(2Tr)≤fd<1/(2Tr), and can obtain an output in which a transmission antenna is associated with each CDDM signal.

### Configuration Example 2

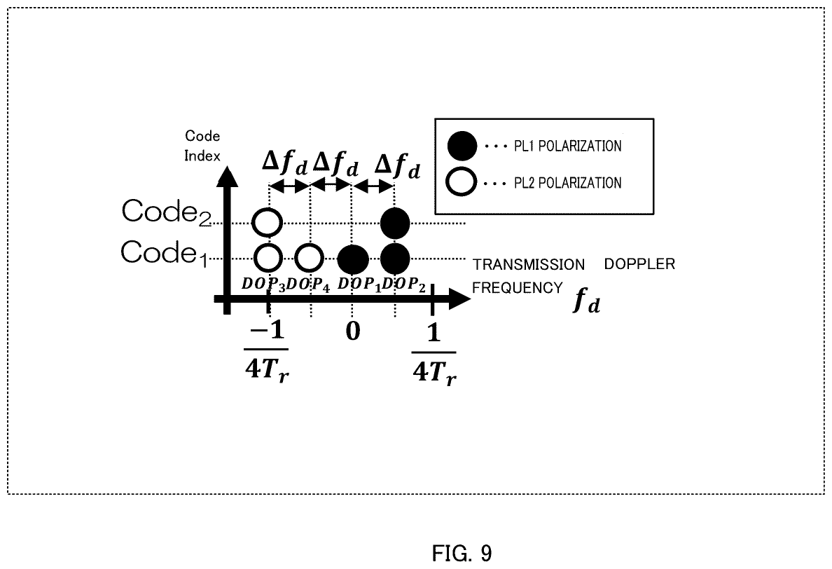

Configuration Example 2 is a configuration example of the CDP amount in a case where Condition 1 (satisfying the different-CDM-pattern condition (B-1 and B-2)) and Condition 2 are satisfied. FIG. 9 illustrates an example of the CDP amount configuration in phase rotation amount setter 105 in a case where number Nt of transmission antennas is 6, N_{PL1} is 3, and N_{PL2} is 3. In FIG. 9, black circles (●) indicate the assignment of CDDM signals to transmission antennas (Tx #1 to #3) of PL1 polarization, and white circles (◯) indicate the assignment of CDDM signals to transmission antennas (Tx #4 to #6) of PL2 polarization.

Further, in FIG. 9, number N_{DM} of Doppler multiplexing=4, and Doppler shift setter 106 may configure four DOP₁ to DOP₄ using, for example, the maximum equal-interval Doppler shift amount configuration shown in Expression 5. In FIG. 9, the phase rotation amounts for applying DOP₁=0, DOP₂=Δfd, DOP₃=−2Δfd, and DOP₄=−Δfd are φ₁=0, φ₂=π/2, φ₃=−π, and φ₄=3π/2 (φ₄=−π/2 may also be used), respectively. As illustrated in FIG. 9, Doppler multiplexing interval Δfd is an equal interval, and Δfd=1/(8Tr).

In FIG. 9, number Nt of transmission antennas is 6, number N_{DM} of Doppler multiplexing is 4, and number N_{CM} of code multiplexing is 2, and thus, since Nₜ<N_{DM}×N_{CM}, phase rotation amount setter 105 can configure numbers N_{CDDM}(ndm) of coded Doppler multiplexing for the DDM signals non-uniformly (where ndm=1 to N_{DM}).

As illustrated in FIG. 9, the numbers of coded Doppler multiplexing for the DDM signals using four DOP₁ to DOP₄ input from Doppler shift setter 106 in encoder 107 are set to N_{CDDM}(1)=1, N_{CDDM}(2)=2, N_{CDDM}(3)=2, and N_{CDDM}(4)=1, respectively. As described above, phase rotation amount setter 105 configures the numbers of coded Doppler multiplexing for the DDM signals non-uniformly.

Further, in FIG. 9, Doppler shift setter 106 assigns, for transmission antennas Tx #1 to #3 of PL1 polarization, DDM signals for which, for example, Doppler shift amounts DOP₁ and DOP₂ are used (N_{DM_PL1}=2), from among the DDM signals with number N_{DM} of Doppler multiplexing=4. For example, phase rotation amount setter 105 configures CDP amounts ψ_{1,1}(m), ψ_{1,2}(m), and ψ_{2,2}(m) respectively for Tx #1 to #3 of PL1 polarization.

Further, in FIG. 9, Doppler shift setter 106 assigns, for transmission antennas Tx #4 to #6 of PL2 polarization, DDM signals for which, for example, Doppler shift amounts DOP₃ and DOP₄ are used (N_{DM_PL2}=2), from among the DDM signals with number N_{DM} of Doppler multiplexing=4. For example, phase rotation amount setter 105 configures CDP amounts ψ_{1, 3}(m), ψ_{2, 3}(m), and ψ_{1, 4}(m) respectively for Tx #4 to #6 of the PL2 polarization.

In FIG. 9, the numbers of Doppler multiplexing that Doppler shift setter 106 assigns for the transmission antennas of the PL1 polarization and the transmission antennas of the PL2 polarization are N_{DM_PL1}=N_{DM_PL2}=2, and are the same. Further, the Doppler shift intervals of the DDM signals assigned for Tx #1 to #3 of the PL1 polarization are Δfd (1,2)=Δfd and Δfd(2,1)=3Δfd, and the Doppler shift intervals of the DDM signals assigned for Tx #4 to #6 of the PL2 polarization are Δfd (3,4)=Δfd and Δfd (4,3)=3 Δfd, and are the same (cyclically matched).

Accordingly, the CDP amount configuration illustrated in FIG. 9 does not match any of the DDM pattern conditions of Condition 1A.

Further, in FIG. 9, the code indices assigned for the transmission antennas of the PL1 polarization and the transmission antennas of the PL2 polarization for DDM signals using DOP₁ to DOP₄ are CiPL1=(1, 1&2, *, *) and CiPL2=(*, *, 1&2, 1), respectively, resulting in a cyclic mismatch and different code index intervals, thus satisfying B-1 of Condition 1.

Further, in FIG. 9, the numbers of code multiplexing assigned for the transmission antennas of the PL1 polarization and the transmission antennas of the PL2 polarization for DDM signals using DOP₁ to DOP₄ are NcPL1=(1, 2, 0, 0) and NcPL2=(0, 0, 2, 1), respectively, resulting in a cyclic mismatch and different numbers of code multiplexing. Accordingly, B-2 of Condition 1 is satisfied.

Note that, in a case where the Doppler frequency of the target object is −1/(2Tr)≤f_{dtg}<−1/(4Tr) or 1/(4Tr)≤f_{dtg}<1/(2Tr), Doppler analyzers 210 described later observe the aliased Doppler frequency. In this case, the code indices are CiPL1ₐₗᵢₐₛ=(2, 1&2, *, *) and CiPL2ₐₗᵢₐₛ=(*, *, 1&2, 2), which are different from each other (cyclically mismatched). Accordingly, in the example of FIG. 9, the code indices have a cyclic mismatch and the code intervals are different from each other in a range of the Doppler frequency of the target object being −1/(2Tr)≤f_{dtg}<−1/(2Tr). Accordingly, B-1 and B-2 of Condition 1 are satisfied, and the different-CDM-pattern condition is met.

Thus, the configuration of the CDP amounts illustrated in FIG. 9 is an example of a configuration that satisfies Condition 1.

Further, in FIG. 9, the number of code multiplexing assigned for DDM signals in the transmission antennas of the PL1 polarization is NcPL1=(1, 2, 0, 0), and the number of code multiplexing assigned for DDM signals in the transmission antennas of the PL2 polarization is NcPL2=(0, 0, 2, 1), and both the signals are multiplexed and transmitted with the number of code multiplexing that is non-uniform between the DDM signals, and the number of code multiplexing is included in a range of from 1 to N_{CM}−1, inclusive.

Thus, in the example of FIG. 9, the signals transmitted from the transmission antennas of the same polarization (for example, PL1 polarization and PL2 polarization) are multiplexed and transmitted with the number of code multiplexing that is non-uniform between DDM signals, and the number of code multiplexing is included in a range of from 1 to N_{CM}−1, inclusive. Accordingly, the configuration of the CDP amounts illustrated in FIG. 9 is an example of a configuration that satisfies Condition 2 for both the PL1 polarization and the PL2 polarization.

In a case where the target-object reflected wave that is cross-polarized with respect to the polarization of the reception antenna is not included according to the configuration of the CDP amounts illustrated in FIG. 9, radar apparatus 10 receives the reception signals corresponding respectively to the transmission antennas of the PL1 polarization and the transmission antennas of the PL2 polarization at substantially the same level or at a level within a range of approximately several dB to 6 dB. Here, in FIG. 9, the signal transmitted from Nt (=6) transmission antennas including transmission antennas of PL1 polarization and transmission antennas of PL2 polarization is CDDM-transmitted using CDP amounts that make the numbers of coded Doppler multiplexing for the DDM signals non-uniform.

Thus, radar apparatus 10 can demultiplex CDDM signals based on the existing demultiplexing operation on CDDM signals (see, for example, PTL 7).

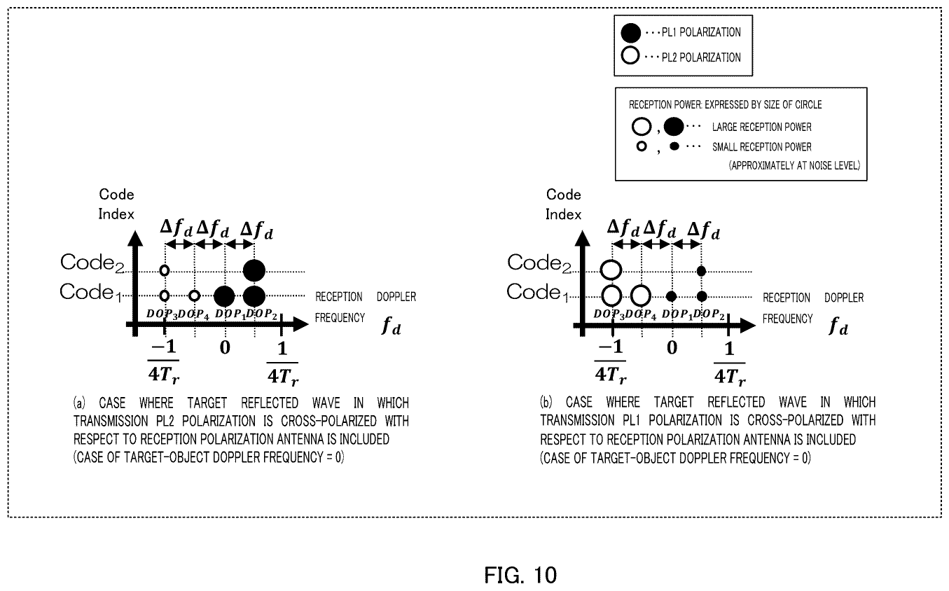

Further, for example, in the configuration of the CDP amounts illustrated in FIG. 9, in a case where the target-object reflected wave that is cross-polarized with respect to the polarization of the reception antenna is included, radar apparatus 10 receives different CDDM signals (for example, CDDM signals satisfying B-1 and B-2 of Condition 1) from each other between a case where the target-object reflected wave in which the PL2 polarization is a cross-polarization is included as illustrated in (a) of FIG. 10 and a case where the target-object reflected wave in which the PL1 polarization is a cross-polarization is included as illustrated in (b) of FIG. 10.

For example, (a) of FIG. 10 illustrates an example of a reception signal in which the Doppler frequency of the target-object reflected wave with PL2 polarization as the cross-polarization is f_{dtg}=0. In radar apparatus 10, each DDM signal is received with a cyclic shift on the Doppler frequency axis depending on the Doppler frequency of the target object. The code indices assigned respectively for the DDM signals are CiPL1=(1, 1&2, *, *) in a case where the Doppler frequency of the target object is −1/(4Tr)≤f_{dtg}<−1/(4Tr). Further, in a case where the Doppler frequency of the target object is −1/(2Tr)≤f_{dtg}<−1/(4Tr) or 1/(4Tr)≤f_{dtg}<1/(2Tr), the code indices assigned respectively for the DDM signals are CiPL1ₐₗᵢₐₛ=(2,1&2,*,*).

Further, for example, (b) of FIG. 10 illustrates an example of a reception signal in which the Doppler frequency of the target-object reflected wave with PL1 polarization as a cross-polarization is f_{dtg}=0. In radar apparatus 10, each DDM signal is received with a cyclic shift on the Doppler frequency axis depending on the Doppler frequency of the target object. The code indices assigned respectively for the DDM signals are CiPL2=(*, *, 1&2, 1) in a case where the Doppler frequency of the target object is −1/(4Tr)≤f_{dtg}<−1/(4Tr). Further, in a case where the Doppler frequency of the target object is −1/(2Tr)≤f_{dtg}<−1/(4Tr) or 1/(4Tr)≤f_{dtg}<1/(2Tr), the code indices assigned respectively for the DDM signals are CiPL2ₐₗᵢₐₛ=(*, *, 1&2, 2).

As described above, in a case where the reception antenna includes a target-object reflected wave that is cross-polarized with respect to the polarization (for example, LC polarization) of the reception antenna, radar apparatus 10 receives a reflected wave signal being a CDDM signal different in pattern (for example, pattern of code indices or code intervals) between a case where the reception level of the reception signal corresponding to the transmission antenna of PL1 polarization decreases and a case where the reception level of the reception signal corresponding to the transmission antenna of PL2 polarization decreases, even when the DDM signal is received with a cyclic shift on the Doppler frequency axis by the Doppler frequency of the target object.

As a result, radar apparatus 10 becomes capable of determining, for example, based on the detected peaks of the Doppler frequency after code demultiplexing, whether a decrease in the reception level of the reception signal corresponding to the PL1-polarized (e.g., LC-polarized) transmission antenna has occurred, or whether a decrease in the reception level of the reception signal corresponding to the PL2-polarized (e.g., RC-polarized) transmission antenna has occurred, in coded Doppler demultiplexer 212 described later.

Further, for example, the DDM signal of the PL1 polarization is multiplexed and transmitted with number NcPL1 of code multiplexing=(1, 2, 0, 0) that is non-uniform between the DDM signals (for example, the number of code multiplexing is 0, 1, or 2 for four DDM signals, and thus, the transmission can be regarded as CDDM transmission that is non-uniform).

Thus, for example, in a case where the reception signal is determined to be a reception signal corresponding to a transmission antenna of LC polarization (PL1 polarization) based on the determination result by coded Doppler demultiplexer 212, radar apparatus 10 can demultiplex the CDDM signal using the existing demultiplexing operation on the CDDM signal.

Similarly, for example, the DDM signal of PL2 polarization is multiplexed and transmitted with number NcPL2 of code multiplexing=(0, 0, 2, 1), which is non-uniform between the DDM signals (for example, the number of code multiplexing is 0, 1, or 2 for four DDM signals, and thus, the transmission can be regarded as CDDM transmission that is non-uniform).

Thus, for example, in a case where the reception signal is determined to be a reception signal corresponding to a transmission antenna of PL2 polarization based on the determination result by coded Doppler demultiplexer 212, radar apparatus 10 can demultiplex the CDDM signal using the existing demultiplexing operation on the CDDM signal.

By the operation of coded Doppler demultiplexer 212 as described above, radar apparatus 10 can determine Doppler frequency fd of the target object in a range of −1/(2Tr)≤fd<1/(2Tr), and can obtain an output in which a transmission antenna is associated with each CDDM signal.

### Configuration Example 3

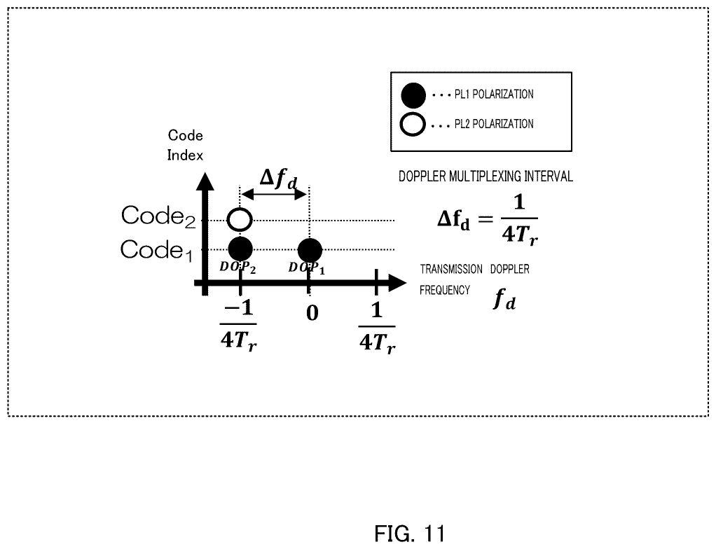

Configuration Example 3 is a configuration example of the CDP amount in a case where Condition 1 (different-CDM-pattern condition) is satisfied and Condition 2 is not satisfied. FIG. 11 illustrates an example of the CDP amount configuration in phase rotation amount setter 105 in a case where number Nt of transmission antennas is 3, N_{PL1} is 2, and N_{PL2} is 1. In FIG. 11, black circles (●) indicate the assignment of CDDM signals for transmission antennas (Tx #1 and Tx #2) of PL1 polarization, and the white circle (◯) indicates the assignment of a CDDM signal for transmission antenna (Tx #3) of PL2 polarization.

Further, in FIG. 11, number N_{DM} of Doppler multiplexing=2, and Doppler shift setter 106 may configure two DOP₁ and DOP₂ using, for example, the maximum equal-interval Doppler shift amount configuration shown in Expression 5. In FIG. 11, phase rotation amount φ₁ for applying DOP₁=0 is 0, and phase rotation amount φ₂ for applying DOP₂=−Δfd is −π. As illustrated in FIG. 11, Doppler multiplexing interval Δfd is an equal interval, and Δfd=1/(4Tr).

In FIG. 11, number Nt of transmission antennas is 3, number N_{DM} of Doppler multiplexing is 2, and number N_{CM} of code multiplexing is 2, and thus, since Nₜ<N_{DM}×N_{CM}, phase rotation amount setter 105 can configure numbers N_{CDDM}(ndm) of coded Doppler multiplexing for the DDM signals non-uniformly (where ndm=1 to N_{DM}).

As illustrated in FIG. 11, the numbers of coded Doppler multiplexing for the DDM signal using two DOP₁ and DOP₂ input from Doppler shift setter 106 in encoder 107 are N_{CDDM}(1)=1 and N_{CDDM}(2)=2. As described above, phase rotation amount setter 105 configures the numbers of coded Doppler multiplexing for the DDM signals non-uniformly.

Further, in FIG. 11, Doppler shift setter 106 assigns, for Tx #1 and Tx #2 of PL1 polarization, DDM signals for which, for example, Doppler shift amounts DOP₁ and DOP₂ (N_{DN_PL1}=2) are used, from among the DDM signals with number N_{DM} of Doppler multiplexing=2. For example, phase rotation amount setter 105 configures CDP amounts ψ_{1, 1}(m) and ψ_{1, 2}(m) for Tx #1 to #2 of PL1 polarization, respectively.

Further, in FIG. 11, Doppler shift setter 106 assigns, for Tx #3 of PL2 polarization, a DDM signal for which, for example, Doppler shift amount DOP₂ is used (N_{DM_PL2}=1), from among the DDM signals with number N_{DM} of Doppler multiplexing=2, and phase rotation amount setter 105 configures CDP amount ψ_{2, 2}(m) for Tx #3 of PL2 polarization.

In FIG. 11, the numbers of Doppler multiplexing that Doppler shift setter 106 assigns for the transmission antennas of PL1 polarization and the transmission antenna of PL2 polarization are N_{DM_PL1}=2 and N_{DM_PL2}=1, respectively, and are different numbers of Doppler multiplexing. Accordingly, the configuration of the CDP amounts illustrated in FIG. 11 matches the different-DDM-pattern condition of A-2 in Condition 1.

Further, in FIG. 11, the code indices assigned for the transmission antennas of PL1 polarization and the transmission antenna of PL2 polarization for DDM signals using DOP₁ and DOP₂ are CiPL1=(1, 1) and CiPL2=(*, 2), respectively, resulting in a cyclic mismatch and different code index intervals.

Further, in a case where the Doppler frequency of the target object is −1/(2Tr)≤f_{dtg}<−1/(4Tr) or 1/(4Tr)≤f_{dtg}<1/(2Tr), the Doppler frequency that has been aliased is observed in Doppler analyzers 210 described later. In this case, the code indices are CiPL1ₐₗᵢₐₛ=(2,2) and CiPL2ₐₗᵢₐₛ=(*,1), resulting in a cyclic mismatch. Thus, in the example of FIG. 11, the code indices have a cyclic mismatch and the code intervals are different from each other in a range of the Doppler frequency of the target object being −1/(2Tr)≤f_{dtg}<−1/(2Tr). Accordingly, B-1 of Condition 1 is satisfied.

Further, in FIG. 11, the numbers of code multiplexing assigned for the transmission antennas of PL1 polarization and the transmission antenna of PL2 polarization for DDM signals using DOP₁ and DOP₂ are NcPL1=(1, 1) and NcPL2=(0, 1), respectively, resulting in a cyclic mismatch and different numbers of code multiplexing. Accordingly, B-2 of Condition 1 is satisfied.

Accordingly, the CDP amount configuration illustrated in FIG. 11 satisfies B-1 and B-2 of Condition 1 and matches the different-CDM-pattern condition.

Thus, the configuration of the CDP amounts illustrated in FIG. 11 is an example of a configuration that satisfies Condition 1.

Further, in FIG. 11, the number of code multiplexing assigned for each DDM signal in the transmission antennas of the PL1 polarization is NcPL1=(1, 1), and the DDM signals are multiplexed and transmitted with a uniform number of code multiplexing.

On the other hand, in FIG. 11, the number of code multiplexing assigned for each DDM signal in the transmission antenna of the PL2 polarization is NcPL2=(0, 1), and the DDM signals are multiplexed and transmitted with the number of code multiplexing that is non-uniform between the DDM signals, and the number of code multiplexing is included in a range of from 1 to N_{CM}−1, inclusive.

Thus, in the example of FIG. 11, the signal transmitted from the transmission antenna of the PL2 polarization is multiplexed and transmitted with the number of code multiplexing that is non-uniform between DDM signals, and the number of code multiplexing is included in a range of from 1 to N_{CM}−1, inclusive, and the signal transmitted from the transmission antennas of the PL1 polarization is such that the number of code multiplexing assigned for each DDM signal is uniform. Accordingly, the configuration of the CDP amounts illustrated in FIG. 11 is an example of a configuration that satisfies Condition 2 for the PL2 polarization and does not satisfy Condition 2 for the PL1 polarization.

In a case where the target-object reflected wave that is cross-polarized with respect to the polarization of the reception antenna is not included according to the configuration of the CDP amounts illustrated in FIG. 11, radar apparatus 10 receives the reception signals corresponding to each of the transmission antenna of the PL1 polarization and the transmission antenna of the PL2 polarization at substantially the same level or at a level within a range of approximately several dB to 6 dB. Here, in FIG. 11, the signal transmitted from Nt (=3) transmission antennas, which are composed of the transmission antennas of PL1 polarization and the transmission antenna of PL2 polarization, is CDDM-transmitted using CDP amounts that make the numbers of coded Doppler multiplexing for DDM signals non-uniform.

Thus, radar apparatus 10 can demultiplex CDDM signals based on the existing demultiplexing operation on CDDM signals (see, for example, PTL 7).

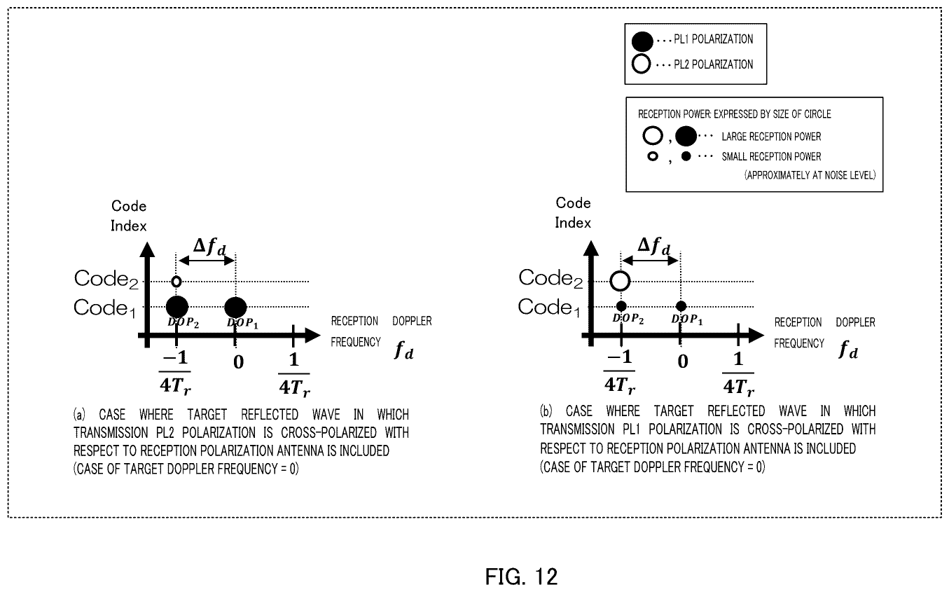

Further, for example, in the configuration of the CDP amounts illustrated in FIG. 11, in a case where the target-object reflected wave that is cross-polarized with respect to the polarization of the reception antenna is included, radar apparatus 10 receives CDDM signals (for example, CDDM signals satisfying 1A and 1B of Condition 1) that are different from each other between a case where the target-object reflected wave in which PL2 polarization is a cross-polarization is included as illustrated in (a) of FIG. 12 and a case where the target-object reflected wave in which PL1 polarization is a cross-polarization is included as illustrated in (b) of FIG. 12.

For example, (a) of FIG. 12 illustrates an example of a reception signal in which the Doppler frequency of the target-object reflected wave with PL2 polarization as the cross-polarization is f_{dtg}=0. In radar apparatus 10, each DDM signal is received with a cyclic shift on the Doppler frequency axis depending on the Doppler frequency of the target object. The code indices assigned respectively for the DDM signals are CiPL1=(1, 1) in a case where the Doppler frequency of the target object is −1/(4Tr)≤f_{dtg}<−1/(4Tr), and the code indices assigned respectively for the DDM signals are CiPL1ₐₗᵢₐₛ=(2, 2) in a case where the Doppler frequency of the target object is −1/(2Tr)≤f_{dtg}<−1/(4Tr) or 1/(4Tr)≤f_{dtg}<1/(2Tr).

Further, for example, (b) of FIG. 12 illustrates an example of a reception signal in which the Doppler frequency of the target-object reflected wave, where the PL1 polarization is a cross-polarization, is f_{dtg}=0. In radar apparatus 10, each DDM signal is received with a cyclic shift on the Doppler frequency axis depending on the Doppler frequency of the target object. The code indices assigned respectively for the DDM signals are CiPL2=(*, 2) in a case where the Doppler frequency of the target object is −1/(4Tr)≤f_{dtg}<−1/(4Tr). Further, in a case where the Doppler frequency of the target object is −1/(2Tr)≤f_{dtg}<−1/(4Tr) or 1/(4Tr)≤f_{dtg}<1/(2Tr), the code indices assigned respectively for the DDM signals are CiPL2ₐₗᵢₐₛ=(*, 1).

As described above, in a case where the reception antenna includes a target-object reflected wave that is cross-polarized with respect to the polarization (for example, LC polarization) of the reception antenna, radar apparatus 10 receives a reflected wave signal being a CDDM signal different in pattern (for example, pattern of numbers of Doppler multiplexing, code intervals, or numbers of code multiplexing) between a case where the reception level of the reception signal corresponding to the transmission antenna of PL1 polarization decreases and a case where the reception level of the reception signal corresponding to the transmission antenna of PL2 polarization decreases, even when the DDM signal is received with a cyclic shift on the Doppler frequency axis by the Doppler frequency of the target object.

As a result, radar apparatus 10 becomes capable of determining, for example, based on the detected peaks (e.g., number of peaks) of the Doppler frequency after code demultiplexing, whether a decrease in the reception level of the reception signal corresponding to the PL1-polarized (e.g., LC-polarized) transmission antenna has occurred, or whether a decrease in the reception level of the reception signal corresponding to the PL2-polarized (e.g., RC-polarized) transmission antenna has occurred, in coded Doppler demultiplexer 212 described later.

Further, for example, the DDM signal of the PL1 polarization is multiplexed and transmitted with number NcPL1 of code multiplexing=(1, 1) that is uniform between the DDM signals (for example, the number of code multiplexing is 1 for two DDM signals, and thus, the transmission can be regarded as CDDM transmission that is uniform). Thus, for example, in a case where the reception signal is determined to be a reception signal corresponding to a transmission antenna of LC polarization (PL1 polarization) based on the determination result by coded Doppler demultiplexer 212, radar apparatus 10 can demultiplex the DDM signal using the existing demultiplexing operation on the DDM signal (see, for example, PTL 5). In this case, radar apparatus 10 can determine Doppler frequency fd of the target object in a range of −1/(2LocN_{DM_PL1}Tr)≤fd<1/(2LocN_{DM_PL1}Tr), and can obtain an output in which a transmission antenna is associated with each CDDM signal.

Further, for example, the DDM signal of PL2 polarization is multiplexed and transmitted with number NcPL2 of code multiplexing=(0, 1) that is non-uniform between the DDM signals (for example, the number of code multiplexing is 0 or 1 for two DDM signals, and thus, the transmission can be regarded as CDDM transmission that is non-uniform). Thus, for example, in a case where the reception signal is determined to be a reception signal corresponding to a transmission antenna of PL2 polarization based on the determination result by coded Doppler demultiplexer 212, radar apparatus 10 can demultiplex the CDDM signal using the existing demultiplexing operation on the CDDM signal.

By the operation of coded Doppler demultiplexer 212 as described above, radar apparatus 10 can determine Doppler frequency fd of the target object in a range of −1/(2LocN_{DM_PL1}Tr)≤fd<1/(2LocN_{DM_PL1}Tr) in a case where the reception signal is determined to be a reception signal corresponding to the transmission antenna of PL1 polarization, and can obtain an output in which the transmission antenna is associated with each CDDM signal.

Further, in a determination other than the case where the reception signal is determined to be a reception signal corresponding to a transmission antenna of PL1 polarization, radar apparatus 10 can determine Doppler frequency fd of the target object in a range of −1/(2Tr)≤fd<1/(2Tr), and can obtain an output in which the transmission antenna is associated with each CDDM signal.

### Configuration Example 4

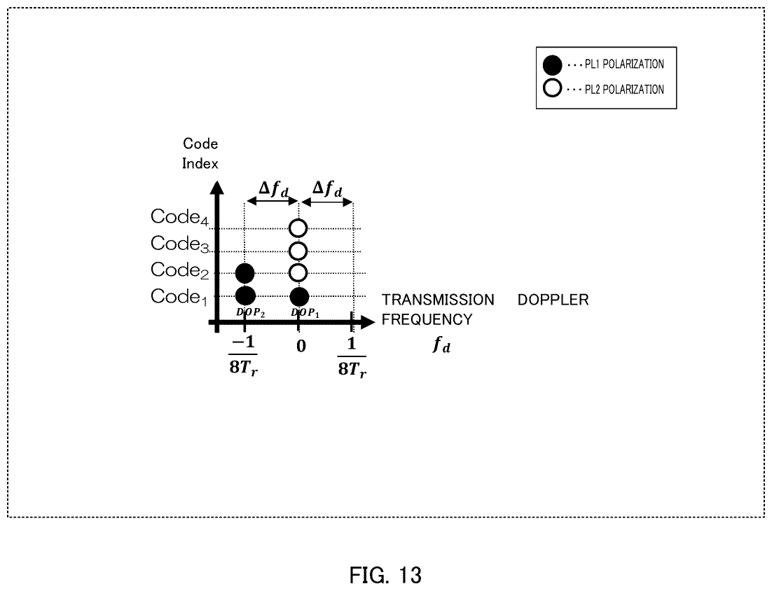

In the above-described Configuration Examples 1 to 3, a configuration example using codes with number N_{CM} of code multiplexing=2 has been described, but the number of code multiplexing is not limited to N_{CM}=2 and may be another value. For example, as illustrated in FIG. 13, number N_{CM} of code multiplexing=4 may be configured.

Configuration Example 4 is a configuration example that satisfies Condition 1 (different-DDM-pattern condition and CDM pattern condition) and Condition 2 with a code length of 4. Hereinafter, an example of the CDP amount configuration in phase rotation amount setter 105 in a case where number N_{CM} of code multiplexing=4 will be described.

FIG. 13 illustrates an example of the CDP amount configuration in phase rotation amount setter 105 in a case where number Nt of transmission antennas is 6, N_{PL1} is 3, and N_{PL2} is 3. In FIG. 13, black circles (●) indicate the assignment of CDDM signals for transmission antennas (Tx #1 to #3) of PL1 polarization, and white circles (◯) indicate the assignment of CDDM signals for transmission antennas (Tx #4 to #6) of PL2 polarization.

Further, in FIG. 13, number N_{DM} of Doppler multiplexing=2, and Doppler shift setter 106 may configure two DOP₁ and DOP₂ using, for example, the maximum equal-interval Doppler shift amount configuration shown in Expression 5. In FIG. 13, phase rotation amount φ₁=0 for applying DOP₁=0, and phase rotation amount φ₂=π for applying DOP₂=−Δfd. As illustrated in FIG. 13, interval Δfd between DDM signals is equal, and Δfd=1/(4Tr).

Further, in FIG. 13, number N_{CM} of code multiplexing is 4, and encoder 107 uses, for example, orthogonal code sequences of Walsh-Hadamard codes with a code length Loc=4, such as Code₁={1, 1, 1, 1}, Code₂={1, −1, 1, −1}, Code₃={1, 1, −1, −1}, and Code₄={1, −1, −1,1}.

In FIG. 13, phase rotation amount setter 105 configures CDP amounts ψ_{1, 1}(m), ψ_{1, 2} (m), and ψ_{2, 2}(m) respectively for Tx #1 to Tx #3 of the PL1 polarization, and configures CDP amounts ψ_{2, 1}(m), ψ_{3, 1}(m), and ψ_{4, 1}(m) respectively for Tx #4 to Tx #6 of the PL2 polarization. Accordingly, in FIG. 13, the numbers of Doppler multiplexing that Doppler shift setter 106 assigns for the transmission antennas of the PL1 polarization and the transmission antennas of the PL2 polarization are N_{DM_PL1}=2 and N_{DM_PL2}=1, respectively, and are different numbers of Doppler multiplexing. Accordingly, the configuration of the CDP amounts illustrated in FIG. 13 matches the different-DDM-pattern condition of A-2 in Condition 1.

Further, in FIG. 13, the code indices assigned for the transmission antennas of the PL1 polarization and the transmission antennas of the PL2 polarization for DDM signals using DOP₁ and DOP₂ are CiPL1=(1, 1&2) and CiPL2=(2&3&4, *), respectively, resulting in a cyclic mismatch and different code index intervals. Further, in FIG. 13, the numbers of code multiplexing assigned for the transmission antennas of the PL1 polarization and the PL2 polarization for DDM signals using DOP₁ and DOP₂ are NcPL1=(1, 2) and NcPL2=(3, 0), respectively, resulting in a cyclic mismatch and different numbers of code multiplexing. Accordingly, the CDP amount configuration illustrated in FIG. 13 satisfies B-1 and B-2 of Condition 1 and matches the different-CDM-pattern condition.

Thus, the configuration of the CDP amounts illustrated in FIG. 13 is an example of a configuration that satisfies Condition 1.

Further, in FIG. 13, the number of code multiplexing assigned for each DDM signal in the transmission antenna of the PL1 polarization is NcPL1=(1, 2), and the number of code multiplexing assigned for each DDM signal in the transmission antenna of the PL2 polarization is NcPL2=(3, 0), and both the signals are multiplexed and transmitted with the number of code multiplexing that is non-uniform between the DDM signals, and the number of code multiplexing is included in a range of 1 to N_{CM}−1 (=3), inclusive.

Thus, in FIG. 13, the signals transmitted from the transmission antennas of the PL1 polarization and the PL2 polarization are multiplexed and transmitted with the numbers of code multiplexing that are non-uniform between the DDM signals, and the numbers of code multiplexing are included in a range of from 1 to N_{CM}−1, inclusive. Accordingly, the configuration of the CDP amounts illustrated in FIG. 13 is an example of a configuration that satisfies Condition 2 for both the PL1 polarization and the PL2 polarization.

The above describes an example of the CDP amount configuration in phase rotation amount setter 105.

### [Configuration of Radar Receiver 200]

In FIG. 4, radar receiver 200 includes reception antenna section 202 including Na reception antennas Rx #1 to Rx #Na. Further, radar receiver 200 includes Na antenna system processors 201-1 to 201-Na, Constant False Alarm Rate (CFAR) section 211, coded Doppler demultiplexer 212, and direction estimator 213. Note that, Na antenna system processors 201-1 to 201-Na, CFAR section 211, coded Doppler demultiplexer 212, and direction estimator 213 may be collectively referred to as reception circuitry. Note that the reception circuitry performs target direction estimation using a reflected wave signal being a transmission signal reflected by a target object (target).

Reception antennas Rx #1 to Rx #Na of reception antenna section 202 each receive a reflected wave signal that is a radar transmission signal reflected from a target object (target), and output the received reflected wave signal to the corresponding one of antenna system processors 201 as a reception signal.

Each of antenna system processors 201 includes reception radio 203 and signal processor 206.

Signals received by Na reception antennas Rx #1 to Rx #Na are output respectively to Na reception radios 203. Further, the output signals from Na reception radios 203 are output respectively to Na signal processors 206.

Each of reception radios 203 includes mixer 204 and low pass filter (LPF) 205. Mixer 204 mixes the received reflected wave signal with a chirp signal inputted from radar transmission signal generator 101 which is a transmission signal. Reception radio 203, for example, passes the output of mixer 204 through LPF 205. As a result, a beat signal, which has a frequency depending on a delay time of the reflected wave signal, is output. For example, the difference in frequency between the transmitting chirp signal (transmitting frequency modulated wave), which is the transmission signal (radar transmission wave), and the reception chirp signal (received frequency modulated wave), which is the reception signal (radar reflected wave), is obtained as the beat frequency.

In each antenna system processor 201-z (where z is any of 1 to Na), signal processor 206 includes analog-to-digital (AD) converter 207, beat frequency analyzer 208, output switch 209, and Doppler analyzers 210.

The signal (for example, beat signal) outputted from LPF 205 is converted into discretely sampled data by AD converter 207 in signal processor 206.

Beat frequency analyzer 208 performs frequency analysis processing (for example, FFT processing) on the N_{data} pieces of discrete sample data obtained within a specified time range (range gate) for each transmission period Tr. Signal processor 206 thus outputs a frequency spectrum in which a peak appears at a beat frequency dependent on the delay time of the reflected wave signal (radar reflected wave).

Here, the beat frequency response output from beat frequency analyzer 208 in zth signal processor 206 obtained by the mth chirp pulse transmission is denoted as “RFT_{z}(f_{b}, m).” Here, f_{b} denotes the beat frequency index and corresponds to an FFT index (bin number). For example, f_{b}=0, . . . , (N_{data}/2)−1, z=1 to Na, and m=1 to N_{C}. A beat frequency having smaller beat frequency index f_{b} indicates a shorter delay time of the reflected wave signal (for example, a shorter distance to the target object).

Further, beat frequency index f_{b} can be converted into distance information R(f_{b}) using following Expression 10. Thus, in the following, beat frequency index f_{b} is also referred to as “distance index f_{b}.”

$$\begin{matrix}[ 10 ] & \\ R ( {f}_{b} ) = \frac{{c}_{0}}{2 {B}_{w}} {f}_{b} & ( Expression 10 )\end{matrix}$$

Here, B_{w} denotes a frequency-modulation bandwidth within the range gate for a chirp signal, and C₀ denotes the speed of light. Also, in Expression 10, C₀/(2B_{w}) represents the distance resolution.

Output switch 209 performs selective switching to output the output of beat frequency analyzer 208 for each transmission period to OC_INDEXth Doppler analyzer 210 among Loc Doppler analyzers 210 based on orthogonal code element index OC_INDEX inputted from encoder 107 of phase rotation amount setter 105.

Signal processor 206 includes Loc Doppler analyzers 210-1 to 210-Loc. For example, data is inputted by output switch 209 to nocth Doppler analyzer 210 in each of Loc transmission periods (Loc×Tr). Accordingly, nocth Doppler analyzer 210 performs Doppler analysis for each distance index f_{b} using data of Ncode transmission periods among Ne transmission periods (for example, using beat frequency response RFT_{z}(f_{b}, m) inputted from beat frequency analyzer 208). Here, noc is an index of the code element, and noc=1 to Loc.

For example, when Ncode is a power of 2, FFT processing is applicable in the Doppler analysis. In this case, the FFT size is Ncode, and a maximum Doppler frequency that is derived from the sampling theorem and in which no aliasing occurs is +1/(2Loc×Tr). Further, the Doppler frequency interval for Doppler frequency index fₛ is 1/(Ncode×Loc×Tr), and the range of Doppler frequency index fₛ is fₛ=−Ncode/2, . . . , 0, . . . , Ncode/2−1.

The following description will be given of a case where Ncode is a power of 2, as an example. Note that, when Ncode is not a power of 2, zero-padded data is included, for example, to allow FFT processing to be performed, with the data size (FFT size) being equal to a power of 2.

For example, output VFT_{z}^{noc}(f_{b}, fₛ) of Doppler analyzer 210 of zth signal processor 206 is given by following Expression 11. Note that j is the imaginary unit and z=1 to Na.

$$\begin{matrix}[ 11 ] & \\ {VFT}_{z}^{noc} ( {f}_{b} , {f}_{s} ) = {\sum }_{s = 0}^{{N}_{code} - 1} {RFT}_{z} ( {f}_{b} , {L}_{OC} \times s + noc ) exp [ - j \frac{2 π {sf}_{s}}{{N}_{code}} ] & ( Expression 11 )\end{matrix}$$

The processing in each component of signal processor 206 has been described above.

### [Exemplary Operation of CFAR Section 211]

In FIG. 4, CFAR section 211 performs CFAR processing (for example, adaptive threshold determination) using the outputs of Loc Doppler analyzers 210 of each of first to Nath signal processors 206, and extracts distance indices (hereinafter, referred to as f_{b_cf}) and Doppler frequency indices (hereinafter, referred to as f_{s_cf}) that provide peak signals. CFAR section 211 performs power addition of outputs VFT_{z}^{noc}(f_{b}, fₛ) of Doppler analyzers 210 in first to Nath signal processors 206, for example, and two-dimensional CFAR processing with the distance axis and the Doppler frequency axis (corresponding to the relative velocity) or CFAR processing that is a combination of one-dimensional CFAR processing (for example, the processing disclosed in NPL 2 may be applied).

For example, when phase rotation amount φ_{ndm} for applying Doppler shift amount DOP_{ndm} is determined using Expression 5, the intervals between the Doppler shift amounts in the Doppler frequency domain, which are outputted from Doppler analyzers 210, are equal intervals, and ΔFD=Ncode/N_{DM} when intervals ΔFD of the Doppler shift amounts are represented by the intervals of the Doppler frequency indices. Accordingly, in the outputs of Doppler analyzers 210, a peak is detected for each DDM signal at an interval of ΔFD in the Doppler frequency domain.

Accordingly, CFAR section 211 may perform, as given by following Expression 12, power addition (referred to as, for example, “Doppler domain compression”) with respect to the outputs of Doppler analyzers 210 while adjusting peak positions of Doppler multiplexed signals to respective ranges resulting from division by the range of interval ΔFD of the Doppler shift amounts. Subsequently, CFAR section 211 may perform CFAR processing (referred to as, for example, “Doppler domain compression CFAR processing”). In the reception processing, f_{sc}=−ΔFD/2, . . . , −ΔFD/2−1. For example, in the case of ΔFD=Ncode/N_{DM}, f_{sc}=Ncode/(2N_{DM}), . . . , Ncode/(2N_{DM})−1. Note that the Doppler domain compression CFAR processing is described in, for example, PTL 6 and PTL 7, and a detailed description thereof will be omitted.

$$\begin{matrix}[ 12 ] & \\ PowerFT ( {f}_{b} , {f}_{sc} ) = {\sum }_{nfd = 1}^{{N}_{DM}} {\sum }_{z = 1}^{{N}_{a}} {\sum }_{noc = 1}^{{L}_{oc}} {\vert {VFT}_{Z}^{noc} ( {f}_{b} , {f}_{sc} + ( nfd - ceil ( \frac{{N}_{DM}}{2} ) - 1 ) \times Δ FD ) \vert}^{2} & ( Expression 12 )\end{matrix}$$

For example, CFAR section 211, which uses the Doppler domain compression CFAR processing, adaptively configures a threshold and outputs, to coded Doppler demultiplexer 212, f_{b_cf}, f_{sc_cf}, and received-power information PowerFT(f_{b_cf}, f_{sc_cf}+(nfd−ceil(N_{DM}/2)−1)×ΔFD (where nfd=1, . . . , N_{DM})) for Doppler frequency indices (f_{sc_cf}+(nfd−ceil(N_{DM}/2)−1)×ΔFD) of N_{DM} DDM signals, which provide a reception power greater than the threshold.

### [Exemplary Operation of Coded Doppler Demultiplexer 212]

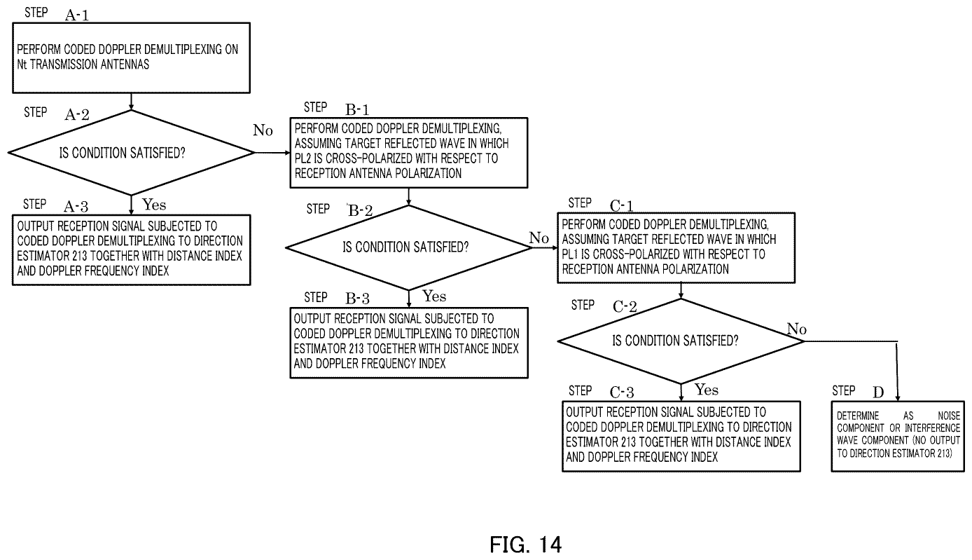

Next, an exemplary operation of coded Doppler demultiplexer 212 illustrated in FIG. 4 will be described. The following describes an example of processing performed by coded Doppler demultiplexer 212 when CFAR section 211 uses the Doppler domain compression CFAR processing. FIG. 14 is a flowchart illustrating an example of the demultiplexing operation in coded Doppler demultiplexer 212.

### <Step A-1>

Coded Doppler demultiplexer 212 performs coded Doppler demultiplexing processing for Nt CDDM signals, assuming a case where the target-object reflected wave that is cross-polarized with respect to the polarization of the reception antenna is not included.

For example, coded Doppler demultiplexer 212 demultiplexes Nt CDDM-transmitted signals and performs discrimination (for example, determination or identification) of the transmission antenna and discrimination of the Doppler frequency (for example, Doppler velocity or relative velocity) using the outputs of Doppler analyzers 210 based on f_{b_cf} and f_{sc_cf}, and the reception power information for the Doppler frequency indices of N_{DM} DDM signals input from CFAR section 211.

As described above, when encoder 107 of phase rotation amount setter 105 uses the configuration of the equal-interval Doppler shift amount including the maximum equal-interval Doppler shift amount configuration, for example, encoder 107 sets at least one of N_{DM} numbers N_{CDDM}(1), N_{CDDM}(2), . . . , N_{CDDM}(N_{DM}) of coded Doppler multiplexing to a value smaller than N_{CM} (configures the number of coded Doppler multiplexing to an uneven value) instead of setting all of the N_{DM} numbers of coded Doppler multiplexing to N_{CM}.

For example, coded Doppler demultiplexer 212 performs (1) code demultiplexing processing, detects a CDDM signal in which the number of coded Doppler multiplexing is set to be smaller than N_{CM} (for example, an unused CDDM signal that is not used for multiplexing transmission), and performs aliasing determination. Subsequently, coded Doppler demultiplexer 212 performs (2) Doppler code demultiplexing processing of CDDM signals used for multiplexing transmission based on the aliasing determination result.

The operation of coded Doppler demultiplexer 212 as described above is the same as the operation of the coded Doppler demultiplexer in a MIMO radar using existing coded Doppler multiplexing transmission, and is described in, for example, PTL 7, and thus, a detailed description of the operation will be omitted.

Note that, in a case where, as the equal-interval Doppler shift amount configuration including the maximum equal-interval Doppler shift amount configuration, for example, all of N_{DM} numbers N_{CDDM}(1), N_{CDDM}(2), . . . , and N_{CDDM}(N_{DM}) of coded Doppler multiplexing are not set to N_{CM}, and at least one number of coded Doppler multiplexing is set to a value smaller than N_{CM}, the Doppler frequency of the target object estimated in the range of −1/(2Tr)≤f_{d}<1/(2Tr) can be detected by the operation of coded Doppler demultiplexer 212 described above (see, for example, PTL 7).

### <Step A-2>

Coded Doppler demultiplexer 212 determines whether Nt CDDM signals have been normally detected. In a case where Nt CDDM signals are normally detected, coded Doppler demultiplexer 212 performs the processing in Step A-3, and in a case where the Nt CDDM signals are not normally detected, coded Doppler demultiplexer 212 performs the processing in Step B-1.

For example, in the processing of Step A-1, when the target-object reflected wave includes PL1 polarization or PL2 polarization that is a cross-polarization with respect to the polarization of the reception antenna, there is a possibility that the Nt CDDM signals are not detected normally.

For example, in a case where a polarimetric MIMO radar is configured using transmission antennas of two polarizations of PL1 polarization and PL2 polarization, the configuration of phase rotation amount setter 105 is N_{DM_PL1}<N_{DM} or N_{DM_PL2}<N_{DM}, and the target-object reflected wave in which the PL1 polarization or PL2 polarization is a cross-polarization with respect to the polarization of the reception antenna is included, a component at which the reception power is different by a value equal to or greater than a predetermined value or a component at which the reception power is as low as the noise level is included among the reception powers for the Doppler frequency indices of N_{DM} DDM signals. In such a case, coded Doppler demultiplexer 212 detects CDDM signals fewer than N_{DM}, and thus determines that the detection is not normal and performs the processing in Step B-1.

Further, for example, in a case where the configuration of phase rotation amount setter 105 is N_{DM_PL1}=N_{DM} for the transmission antennas of PL1 polarization and the target-object reflected wave in which the PL2 polarization is a cross-polarization with respect to the polarization of the reception antenna is included, or in a case where the configuration of phase rotation amount setter 105 is N_{DM_PL2}=N_{DM} for the transmission antennas of PL2 polarization and the target-object reflected wave in which the PL1 polarization is a cross-polarization with respect to the polarization of the reception antenna is included, the reception power within a predetermined range is received among the reception powers for the Doppler frequency indices of N_{DM} DDM signals.

In this case, the number of unused CDDM signals that are not used for multiplexing transmission becomes larger than the expected number (N_{CM}×N_{DM}−Nt) during the code demultiplexing processing, and thus, coded Doppler demultiplexer 212 fails in the aliasing determination, making it difficult to detect Nt CDDM signals normally.

Accordingly, coded Doppler demultiplexer 212 determines that the detection is not normal when the number of unused CDDM signals that are not used for multiplexing transmission is larger than the expected number (N_{CM}×N_{DM}−Nt) and performs the processing in Step B-1.

### <Step A-3>

Coded Doppler demultiplexer 212 outputs reception signal Y_{z}(f_{b_cf}, f_{sc_cf}, ncm, ndm) resulting from CDDM demultiplexing processing performed based on the aliasing determination result on the CDDM signal used for the multiplexing transmission, to direction estimator 213 together with f_{b_cf} and f_{sc_cf}.

Here, Y_{z}(f_{b_cf}, f_{sc_cf}, ndc(ndm), ndm) are outputs (for example, CDDM demultiplexing results) for f_{b_cf} and f_{sc_cf}, resulting from demultiplexing of Doppler analyzers 210 in zth antenna system processor 201 on the CDDM signals using DOP_{ndm} and orthogonal code Code_{ndc(ndm)}. For example, Y_{z}(f_{b_cf}, f_{sc_cf}, ndc(ndm), ndm) represents reception signals that are transmitted from transmission antenna Tx #[ndc(ndm), ndm], is reflected by the target object, and is received by zth antenna system processor 201.

Note that z=1 to Na, and ncm=1 to N_{CM}. Further, ndm=1 to N_{DM}, and ndc(ndm)=1 to N_{CDDM}(ndm).

Further, coded Doppler demultiplexer 212 may output information on the Doppler frequency of the detected target object to direction estimator 213.

Note that, in a case where Condition 2 is satisfied, coded Doppler demultiplexer 212 can detect the Doppler frequency of the target object estimated in the range of −1/(2Tr)≤f_{d}<1/(2Tr) by using the aliasing determination result.

### <Step B-1>

Coded Doppler demultiplexer 212 performs CDDM demultiplexing processing on N_{PL1} CDDM signals, assuming a case where the target-object reflected wave in which PL2 polarization is a cross-polarization with respect to the reception antenna polarization is included.

For example, coded Doppler demultiplexer 212 demultiplexes N_{PL1} CDDM-transmitted signals and performs discrimination (for example, determination or identification) of the transmission antenna and discrimination of the Doppler frequency (for example, Doppler velocity or relative velocity) using the outputs of Doppler analyzers 210 based on f_{b_cf} and f_{sc_cf}, and the reception power information for the Doppler frequency indices of N_{DM} DDM signals input from CFAR section 211.

Here, there is a case where the reception power is different by a value equal to or greater than a predetermined value among the reception powers for the Doppler frequency indices of N_{DM} DDM signals, or a case where (N_{DM}−N_{DM_PL1}) components having a reception power as low as the noise level are included. Note that, in a case where the configuration of phase rotation amount setter 105 is N_{DM}=N_{DM_PL1}, a component having a reception power as low as the noise level is not included.

Accordingly, coded Doppler demultiplexer 212 extracts, for example, top N_{DM_PL1} DDM signals in terms of power from among the reception powers for the Doppler frequency indices of the N_{DM} DDM signals.

For example, in a case where the Doppler multiplexing interval of the extracted top N_{DM_PL1} DDM signals in terms of power matches the Doppler multiplexing interval assigned for the transmission antennas of the PL1 polarization, coded Doppler demultiplexer 212 performs (1) code demultiplexing processing to detect a CDDM signal (for example, an unused CDDM signal not used for multiplexing transmission of the transmission antenna of the PL1 polarization) for which the number of coded Doppler multiplexing is set to be smaller than N_{CM} from among the CDDM signals assigned for the transmission antennas of the PL1 polarization, so as to perform aliasing determination. Subsequently, coded Doppler demultiplexer 212 performs (2) Doppler code demultiplexing processing on the CDDM signals used for multiplexing transmission based on the aliasing determination result.

The operation of coded Doppler demultiplexer 212 as described above is the same as the operation of the coded Doppler demultiplexer in a MIMO radar using existing coded Doppler multiplexing transmission, and is described in, for example, PTL 7, and thus, a detailed description of the operation will be omitted.

Note that, by configuring the CDP amounts such that it satisfies Condition 2, for example, the Doppler frequency of the target object estimated in the range of −1/(2Tr)≤fd<1/(2Tr) can be detected by the operation of the above-described coded Doppler demultiplexer 212 (see, for example, PTL 7).

### <Step B-2>

Coded Doppler demultiplexer 212 determines whether N_{PL1} CDDM signals assigned for N_{PL1} transmission antennas corresponding to the PL1 polarization are detected normally. In a case where N_{PL1} CDDM signals are normally detected, coded Doppler demultiplexer 212 performs the processing in Step B-3, and in a case where N_{PL1} CDDM signals are not normally detected, coded Doppler demultiplexer 212 performs the processing in Step C-1. By configuring the CDP amount by phase rotation amount setter 105 to satisfy Condition 1, the following determination processing can be performed.

For example, in the processing of Step B-1, when the target-object reflected wave in which PL2 polarization is a cross-polarization with respect to the polarization of the reception antenna is not included, there is a possibility that N_{PL1} CDDM signals are not detected normally.

Coded Doppler demultiplexer 212 determines, for example, that the target-object reflected wave in which the PL2 polarization is a cross-polarization with respect to the polarization of the reception antenna is not included, in a case where the power difference (or power ratio) between the extracted top N_{DM_PL1} DDM signals in terms of power and the other (N_{DM}−N_{DM_PL1}) lower-power DDM signals is not equal to or greater than a predetermined level, and performs the processing in Step C-1.

In a case where the configuration of the CDP amounts by phase rotation amount setter 105 satisfies (A-2) of Condition 1A, coded Doppler demultiplexer 212 can perform such determination processing.

Further, in a case where the Doppler multiplexing intervals of the extracted top N_{DM_PL1} DDM signals in terms of power do not match the Doppler multiplexing intervals assigned for the transmission antennas of the PL1 polarization, coded Doppler demultiplexer 212 determines that a target-object reflected wave in which the PL2 polarization is a cross-polarization with respect to the polarization of the reception antenna is not included, and performs the processing in Step C-1.

In a case where the configuration of the CDP amounts by phase rotation amount setter 105 satisfies (A-1) or (A-3) of Condition 1A, coded Doppler demultiplexer 212 can perform such determination processing.

Further, for example, the configuration of phase rotation amount setter 105 is N_{DM_PL1}=N_{DM_PL2} for the transmission antennas of the PL1 polarization. In this case, when the target-object reflected wave in which the PL1 polarization is a cross-polarization with respect to the polarization of the reception antenna is included, the reception power within a predetermined range is received among the reception powers for the Doppler frequency indices of the N_{DM} DDM signals. In such a case, during the code demultiplexing processing, a signal with a code interval or the number of code multiplexing different from the assumed N_{PL1} CDDM signals is obtained, and thus, coded Doppler demultiplexer 212 fails in the aliasing determination, making it difficult to detect the N_{PL1} CDDM signals normally. In such a case, coded Doppler demultiplexer 212 determines that the detection for the N_{PL1} CDDM signals is not normal, and performs the processing in Step C-1.

In a case where the configuration of the CDP amounts by phase rotation amount setter 105 satisfies (B-1) or (B-2) of Condition 1B, coded Doppler demultiplexer 212 can perform such determination processing.

### <Step B-3>

Coded Doppler demultiplexer 212 outputs reception signals YPL1_{z}(f_{b_cf}, f_{sc_cf}, ncm, ndm) resulting from CDDM demultiplexing processing performed, based on the processing result of Step B-2, on the CDDM signals used for multiplexing transmission of N_{PL1} transmission antennas corresponding to the PL1 polarization, to direction estimator 213 together with f_{b_cf} and f_{sc_cf}.

Here, YPL1_{z}(f_{b_cf}, f_{sc_cf}, ndc(ndm), ndm) are outputs (for example, CDDM demultiplexing results) for f_{b_cf} and f_{sc_cf}, resulting from demultiplexing of Doppler analyzers 210 in zth antenna system processor 201 on the CDDM signals using DOP_{ndm} and orthogonal code Code_{ndc(ndm)}. For example, YPL1_{z}(f_{b_cf}, f_{sc_cf}, ndc(ndm), ndm) represents reception signals that are transmitted from N_{PL1} transmission antennas Tx #[ndc(ndm), ndm] corresponding to the PL1 polarization, are reflected by the target object, and are received by zth antenna system processor 201. Note that, z=1 to Na, ndm=1 to N_{DM}, ndc(ndm)=1 to N_{CDDM}(ndm), and signals other than those assigned for N_{PL1} transmission antennas corresponding to the PL1 polarization are output as zero.

Further, coded Doppler demultiplexer 212 may output the Doppler frequency of the detected target object to direction estimator 213.

Note that, in a case where Condition 2 is satisfied, coded Doppler demultiplexer 212 can detect the Doppler frequency of the target object estimated in the range of −1/(2Tr)≤f_{d}<1/(2Tr) by using the aliasing determination result.

### <Step C-1>

Coded Doppler demultiplexer 212 performs CDDM demultiplexing processing on N_{PL2} CDDM signals, assuming a case where the target-object reflected wave in which the PL1 polarization is a cross-polarization with respect to the polarization of the reception antenna.

For example, coded Doppler demultiplexer 212 demultiplexes N_{PL2} CDDM-transmitted signals and performs discrimination (for example, determination or identification) of the transmission antenna and discrimination of the Doppler frequency (for example, Doppler velocity or relative velocity) using the outputs of Doppler analyzers 210 based on f_{b_cf} and f_{sc_cf}, and the reception power information for the Doppler frequency indices of N_{DM} DDM signals being the outputs from CFAR section 211.

Here, there is a case where the reception power is different by a value equal to or greater than a predetermined value among the reception powers for the Doppler frequency indices of N_{DM} DDM signals, or a case where (N_{DM}−N_{DM_PL2}) components having a reception power as low as the noise level are included. Note that, in a case where the configuration of phase rotation amount setter 105 is N_{DM}=N_{DM_PL2}, a component having a reception power as low as the noise level is not included.

Accordingly, coded Doppler demultiplexer 212 extracts, for example, top N_{DM_PL2} DDM signals in terms of power from among the reception powers for the Doppler frequency indices of the N_{DM} DDM signals.

For example, in a case where the Doppler multiplexing interval of the extracted top N_{DM_PL2} DDM signals in terms of power matches the Doppler multiplexing interval assigned for the transmission antennas of the PL2 polarization, coded Doppler demultiplexer 212 performs (1) code demultiplexing processing to detect a CDDM signal (for example, an unused CDDM signal not used for multiplexing transmission of the transmission antenna of the PL2 polarization) for which the number of coded Doppler multiplexing is set to be smaller than N_{CM} from among the CDDM signals assigned for the transmission antennas of the PL2 polarization, so as to perform aliasing determination. Subsequently, coded Doppler demultiplexer 212 performs (2) Doppler code demultiplexing processing on the CDDM signals used for multiplexing transmission based on the aliasing determination result.

The operation of coded Doppler demultiplexer 212 as described above is the same as the operation of the coded Doppler demultiplexer in a MIMO radar using existing coded Doppler multiplexing transmission, and is described in, for example, PTL 7, and thus, a detailed description of the operation will be omitted.

Note that, by configuring the CDP amounts such that it satisfies Condition 2, for example, the Doppler frequency of the target object estimated in the range of −1/(2Tr)≤fd<1/(2Tr) can be detected by the operation of the above-described coded Doppler demultiplexer 212 (see, for example, PTL 7).

### <Step C-2>

Coded Doppler demultiplexer 212 determines whether N_{PL2} CDDM signals assigned for N_{PL2} transmission antennas corresponding to the PL2 polarization are detected normally. In a case where N_{PL2} CDDM signals are normally detected, coded Doppler demultiplexer 212 performs the processing in Step C-3, and in a case where N_{PL1} CDDM signals are not normally detected, coded Doppler demultiplexer 212 performs the processing in Step D. This is because coded Doppler demultiplexer 212 regards the reception signal as having a high noise component (for example, low SNR) or as containing an interference component.

Coded Doppler demultiplexer 212, for example, determines that the target-object reflected wave in which the PL1 polarization is a cross-polarization with respect to the polarization of the reception antenna is not included, in a case where the power difference (or power ratio) between the extracted top N_{DM_PL2} DDM signals in terms of power and the other (N_{DM}−N_{DM_PL2}) lower-power DDM signals is not equal to or greater than a predetermined level, and performs the processing in Step D.

Further, in a case where the Doppler multiplexing intervals of the extracted top N_{DM_PL2} DDM signals in terms of power do not match the Doppler multiplexing intervals assigned for the transmission antennas of the PL2 polarization, coded Doppler demultiplexer 212 determines that a target-object reflected wave in which the PL1 polarization is a cross-polarization with respect to the polarization of the reception antenna is not included, and performs the processing in Step D.

Further, coded Doppler demultiplexer 212 determines, for example, whether the code intervals or the numbers of code multiplexing match the code intervals or the numbers of code multiplexing expected of the N_{PL2} CDDM signals, based on the reception powers of signals obtained by performing code demultiplexing processing on the extracted top N_{DM_PL2} DDM signals in terms of power. In a case where the code intervals or the numbers of code multiplexing do not match, it is determined that the target-object reflected wave in which PL1 polarization is a cross-polarization with respect to the polarization of the reception antenna is not included, and the processing in Step D is performed.

### <Step C-3>

Coded Doppler demultiplexer 212 outputs reception signals YPL2_{z}(f_{b_cf}, f_{sc_cf}, ncm, ndm) resulting from CDDM demultiplexing processing performed, based on the processing result of Step C-2, on the CDDM signals used for multiplexing transmission of N_{PL2} transmission antennas corresponding to the PL2 polarization, to direction estimator 213 together with f_{b_cf} and f_{sc_cf}.

Here, YPL2_{z}(f_{b_cf}, f_{sc_cf}, ndc(ndm), ndm) are outputs (for example, CDDM demultiplexing results) for f_{b_cf} and f_{sc_cf}, resulting from demultiplexing of Doppler analyzers 210 in zth antenna system processor 201 on the CDDM signals using DOP_{ndm} and orthogonal code Code_{ndc(ndm)}. For example, YPL2_{z}(f_{b_cf}, f_{sc_cf}, ndc(ndm), ndm) represents reception signals that are transmitted from N_{PL2} transmission antennas Tx #[ndc(ndm), ndm] corresponding to the PL2 polarization, are reflected by the target object, and are received by zth antenna system processor 201. Note that, z=1 to Na, ndm=1 to N_{DM}, ndc(ndm)=1 to N_{CDDM}(ndm), and signals other than those assigned for N_{PL2} transmission antennas corresponding to the PL2 polarization are output as zero.

Further, coded Doppler demultiplexer 212 may output the Doppler frequency of the detected target object to direction estimator 213.

Note that, in a case where Condition 2 is satisfied, coded Doppler demultiplexer 212 can detect the Doppler frequency of the target object estimated in the range of −1/(2Tr)≤fd<1/(2Tr) by using the aliasing determination result.

### <Step D>

In a case where the condition in Step C-2 is not satisfied, coded Doppler demultiplexer 212 may determine that the reception signal is a noise component or an interference component and may not output the reception signal to direction estimator 213.

The foregoing description has been given of an example of the operation of coded Doppler demultiplexer 212.

Note that, in a case where there are a plurality of f_{b_cf}, Doppler frequency index f_{sc_cf}, and reception power information input from CFAR section 211, coded Doppler demultiplexer 212 may perform the above-described CDDM demultiplexing operation a plurality of times for each of, for example, the distance index, the Doppler frequency index, and the reception power information.

### [Exemplary Operation of Direction Estimator 213]

Next, an exemplary operation of direction estimator 213 illustrated in FIG. 4 will be described.

Direction estimator 213 performs, for example, target-object direction estimation processing based on a signal input from coded Doppler demultiplexer 212 (for example, f_{b_cf}, reception signal Y_{z}(f_{b_cf}, f_{sc_cf}, ndc(ndm), ndm) or YPLq_{z}(f_{b_cf}, f_{sc_cf}, ndc(ndm), ndm) subjected to CDDM demultiplexing processing). Here, q=1 to NPL.

Note that, since reception signal Y_{z}(f_{b_cf}, f_{sc_cf}, ndc(ndm), ndm) on which the CDDM demultiplexing processing is to be performed is a reception signal from a transmission antenna for which CDP amount ψndc(ndm), ndm(m) is used, Y_{z}(f_{b_cf}, f_{sc_cf}, ndc(ndm), ndm) can be associated with Tx #1, Tx #2, . . . , and Tx #Nt. Accordingly, in the following, CDP amount ψ_{ndc(ndm), ndm(m)} in reception signal Y_{z}(f_{b_cf}, f_{sc_cf}, ndc(ndm), ndm) can also be referred to as “YT_{z}(f_{b_cf}, f_{sc_cf}, nt)” associated with any of Tx #1 to Tx #Nt. Here, nt=1 to Nt.

Similarly, CDP amount ψ_{ndc(ndm), ndm(m)} in reception signals YPLq_{z}(f_{b_cf}, f_{sc_cf}, ndc(ndm), ndm) can also be represented as “YPLT_{z}(f_{b_cf}, f_{sc_cf}, nt)” associated with any of Tx #1 to Tx #Nt.

Hereinafter, Exemplary Operation 1 and Exemplary Operation 2 of direction estimator 213 will be described.

### <Exemplary Operation 1 of Direction Estimator 213>

In Exemplary Operation 1, for example, direction estimator 213 generates virtual reception array correlation vector h(f_{b_cf}, f_{sc_cf}) of direction estimator 213 based on f_{b_cf} and reception signal Y_{z}(f_{b_cf}, f_{sc_cf}, ndc(ndm), ndm) on which CDDM demultiplexing processing have been performed, and performs direction estimation processing.

Here, the information input from coded Doppler demultiplexer 212 includes a CDDM demultiplexing reception signal for Nt transmission antennas in a case of including reception signal Y_{z}(f_{b_cf}, f_{sc_cf}, ndc(ndm), ndm) subjected to the CDDM demultiplexing processing. Thus, virtual reception array correlation vector h(f_{b_cf}, f_{sc_cf}) includes Nt×Na elements, which is the product of number Nt of transmission antennas and number Na of reception antennas. Based on the phase difference between the transmission/reception antennas, direction estimator 213 performs direction estimation on the reflected wave signal from the target object using virtual reception array correlation vector h(f_{b_cf}, f_{sc_cf}).

For example, to perform direction estimation processing for each polarization transmission antenna, direction estimator 213 extracts reception signals corresponding to transmission antennas of the same polarization from virtual reception array correlation vector h(f_{b_cf}, f_{sc_cf}), and generates virtual reception array correlation vector hPL_{q}(f_{b_cf}, f_{sc_cf}) by the transmission antennas of the PLq polarization. Here, hPL_{q}(f_{b_cf}, f_{sc_cf}) is a column vector including N_{PLq}×Na elements.

Direction estimator 213 calculates the spatial profile of the PLq polarization by varying azimuth direction θᵤ within a predetermined angle range in direction estimation evaluation function P_{H-PLq}(θᵤ, f_{b_cf}, f_{sc_cf}) using, for example, virtual reception array correlation vector h_{PLq}(f_{b_cf}, f_{sc_cf}) by the transmission antennas of the PLq polarization.

Direction estimator 213 may extract a predetermined number of maximum peaks of the spatial profiles for respective calculated PLq polarizations in descending order, and may output the azimuth directions of the maximum peaks as the direction-of-arrival estimation values (for example, positioning outputs) of the PLq polarizations. Here, q=1 to NPL.

Note that, there are various methods for direction estimation evaluation function value P_{H-PLq}(θᵤ, f_{b_cf}, f_{sc_cf}) depending on the direction-of-arrival estimation algorithm. For example, an estimation method using an array antenna disclosed in NPL 3 may be used.

Further, by using a MIMO virtual reception antenna arrangement in which the antennas are arranged in a rectangular grid shape, it is possible to estimate the arrival direction in the azimuth direction and the elevation angle direction. For example, direction estimator 213 may calculate the azimuth direction and the elevation angle direction as the direction-of-arrival estimation value for each transmission antenna of different polarizations, and may output the azimuth direction and the elevation angle direction as the positioning output. Note that, the same applies to Exemplary Operation 2 of direction estimator 213 described later.

By the above operation, direction estimator 213 of radar apparatus 10 may output, for example, the direction-of-arrival estimation value based on f_{b_cf} and reception signal Y_{z}(f_{b_cf}, f_{sc_cf}, ndc(ndm), ndm) subjected to CDDM demultiplexing processing as a positioning output. Further, direction estimator 213 may output, as the positioning output, f_{b_cf} and the Doppler frequency estimation value of the target object. Note that, the same applies to Exemplary Operation 2 of direction estimator 213 described later.

Further, f_{b_cf} may be output after converted into distance information using Expression 10. Note that, the same applies to Exemplary Operation 2 of direction estimator 213 described later.

Further, in a case where there are a plurality of pieces of information (for example, f_{b_cf} and reception signal Y_{z}(f_{b_cf}, f_{sc_cf}, ndc(ndm), ndm) on which the CDDM demultiplexing processing has been performed) input from coded Doppler demultiplexer 212, direction estimator 213 may calculate the direction-of-arrival estimation value for each of them in the same manner as the processing described above and may output the positioning results. Note that, the same applies to Exemplary Operation 2 of direction estimator 213 described later.

### <Exemplary Operation 2 of Direction Estimator 213>

In Exemplary Operation 2, for example, direction estimator 213 generates virtual reception array correlation vector hq(f_{b_cf}, f_{sc_cf}, ndc(ndm), ndm) of direction estimator 213 based on f_{b_cf} and reception signals YPLq_{z}(f_{b_cf}, f_{sc_cf}, ndc(ndm), ndm) on which CDDM demultiplexing processing has been performed, and performs direction estimation processing based on the reception signal from the transmission antenna of the PLq polarization.

Direction estimator 213 performs direction estimation processing for PLq polarization corresponding to q that matches the polarization of reception signal YPLq_{z}(f_{b_cf}, f_{sc_cf}, ndc(ndm), ndm) on which CDDM demultiplexing processing has been performed, which is different from the operation in Exemplary Operation 1. The operation in this case is the same as the processing in which Y_{z}(f_{b_cf}, f_{sc_cf}, ndc(ndm), ndm) in the operation in Exemplary Operation 1 is replaced with reception signal YPLq_{z}(f_{b_cf}, f_{sc_cf}, ndc(ndm), ndm), and thus, the detailed description of the operation will be omitted.

By the above operation, direction estimator 213 of radar apparatus 10 may output, for example, as the positioning output, the direction-of-arrival estimation value based on f_{b_cf} and YPLq_{z}(f_{b_cf}, f_{sc_cf}, ndc(ndm), ndm), which is a reception signal obtained by performing CDDM demultiplexing processing on a reception signal from a transmission antenna of PLq polarization.

The above describes Exemplary Operation 1 and Exemplary Operation 2 of direction estimator 213.

Direction estimator 213 can perform the direction estimation processing based on the output according to the demultiplexing operation of coded Doppler demultiplexer 212 by the operation described above.

For example, direction estimator 213 can perform the direction estimation processing based on the output of coded Doppler demultiplexer 212 in each of the cases where a target-object reflected wave cross-polarized with respect to the polarization of the reception antenna is not included, where a target-object reflected wave in which the PL2 polarization is a cross-polarization with respect to the polarization of the reception antenna is included, and where a target-object reflected wave in which the PL1 polarization is a cross-polarization with respect to the polarization of the reception antenna is included.

Further, for example, in a case where the target-object reflected wave cross-polarized with respect to the polarization of the reception antenna is not included, direction estimator 213 can perform the direction estimation processing for each of the polarizations included in the transmission antennas. Further, for example, in a case where the target-object reflected wave in which the PL2 polarization is a cross-polarization with respect to the polarization of the reception antenna is included, direction estimator 213 is capable of performing the direction estimation processing on PL1 polarization transmission. Further, for example, in a case where the target-object reflected wave in which the PL1 polarization is a cross-polarization with respect to the polarization of the reception antenna is included, direction estimator 213 is capable of performing the direction estimation processing on PL2 polarization transmission.

By the operation of direction estimator 213 as described above, a direction estimation processing result for each transmission polarization or a direction estimation result for a part of the transmission polarizations is obtained depending on the situation of the reflected wave, and a direction estimation result dependent on the transmission polarization is obtained. Since the response of the reflected waves from the target object may vary depending on the transmission polarization, radar apparatus 10 can improve the detection or identification performance of the target object based on such direction estimation results dependent on the transmission polarization.

The exemplary operation of direction estimator 213 has been described above.

As described above, in the present embodiment, radar apparatus 10 assigns CDDM signals that are different between polarizations satisfying at least Condition 1 in phase rotation amount setter 105 in a polarimetric transmission MIMO radar using CDDM (for example, signals in which at least one of the DDM pattern and the CDM pattern is different).

Thus, radar apparatus 10 can discriminate the transmission antenna in coded Doppler demultiplexer 212 and CDDM demultiplexing is possible even in a case where the reception levels between reflection waves corresponding to transmission antennas of different polarizations are significantly different. Thus, according to the present embodiment, it is possible to prevent the deterioration of the target object detection performance, the misestimation of the Doppler frequency, or the deterioration of the angle measurement performance.

Further, for example, in the assignment of the CDDM signal in phase rotation amount setter 105, by satisfying the above-described Condition 1 and Condition 2, radar apparatus 10 can expand Doppler frequency range f_{d} in which detection can be successful to a range of −1/(2Tr)≤f_{d}<1/(2Tr), which is similar to the range as in the case of using a single transmission antenna, even in a case where the reception levels between reflection waves corresponding to transmission antennas of different polarizations are significantly different.

Thus, according to the present embodiment, it is possible to improve the detection performance of a polarimetric MIMO radar using coded Doppler multiplexing transmission.

Further, in the present embodiment, radar apparatus 10 includes a reception antenna that receives a reflected wave signal of a radar transmission signal reflected by a target object using one of a plurality of polarizations (for example, PL1 polarization and PL2 polarization). Then, radar apparatus 10 performs direction estimation based on the reflected wave signal received by the reception antenna. Thus, radar apparatus 10 can discriminate the transmission antenna corresponding to the DDM signal and resolve the ambiguity of the Doppler frequency even in a case where a reflected wave having a cross-polarization relationship with the polarization of the reception antenna is included. Further, in the present embodiment, even when the reception antenna is a reception antenna with the same polarization, CDDM demultiplexing is possible, and it is not necessary to additionally use a reception antenna of a different type of polarization in radar receiver 200, and the number of reception antennas can be reduced.

### (Variation 1)

In the above-described embodiment, an exemplary operation of CFAR section 211, coded Doppler demultiplexer 212, and direction estimator 213 in a case where a plurality of reception antennas of reception antenna section 202 is reception antennas of the same polarization has been described as an example.

The plurality of reception antennas of reception antenna section 202 may include reception antennas of different polarizations. In Variation 1, an exemplary operation of the CFAR section, the coded Doppler demultiplexer, and the direction estimator in a case where the plurality of reception antennas of reception antenna section 202 includes reception antennas of different polarizations will be described.

For example, when the plurality of reception antennas includes reception antennas of different polarizations, the reception level of the target-object reflected waves may significantly differ for each polarization. Therefore, for example, radar apparatus 10 may perform CFAR processing, Doppler separation processing, and direction estimation processing individually for the outputs (e.g., reflected-wave signals received respectively by the reception antennas of the polarizations) of Doppler analyzers 210 corresponding to the reception antennas of different polarizations. Further, the direction estimation processing may be performed using the output of Doppler separation processing by reception antennas of a plurality of polarizations.

Hereinafter, as an example, the case where reception antenna section 202 includes reception antennas of at least two different polarizations, from Rx #1 to Rx #Na, will be described.

For example, two different polarizations are denoted as “RxPL1 polarization” and “RxPL2 polarization.” Also, out of Na reception antennas, the number of reception antennas of RxPL1 polarization is N_{RxPL1}, and the number for RxPL2 polarization is N_{RxPL2}. Here, N_{RxPL1}+N_{RxPL2}=Na.

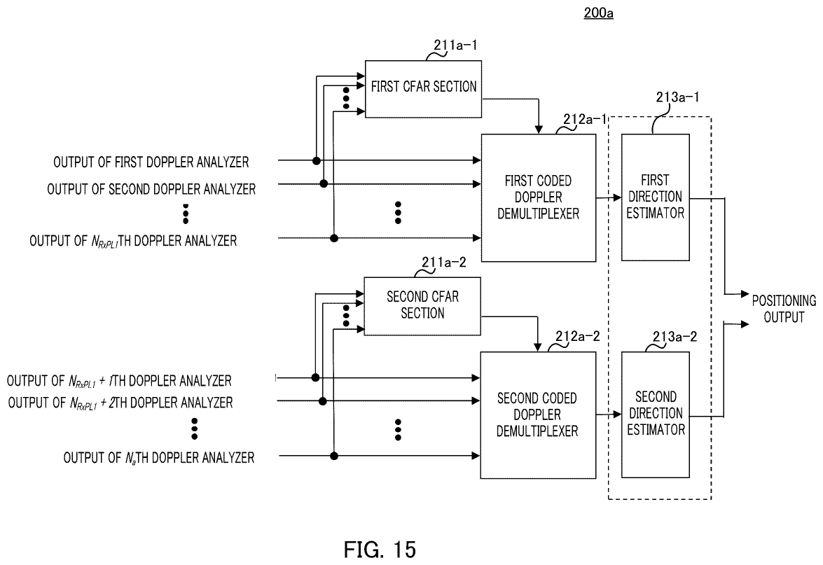

FIG. 15 is a block diagram illustrating an exemplary configuration of CFAR sections 211a, coded Doppler demultiplexers 212a, and direction estimators 213a of radar receiver 200a in radar apparatus 10 according to Variation 1. In FIG. 15, as an example, reception antennas Rx #1 to Rx #N_{RxPL1} are reception antennas of the RxPL1 polarization, and Rx #N_{RxPL1}+1 to Rx #Na are reception antennas of the RxPL2 polarization. Note that the relationship between the reception antenna numbers and the polarizations is not limited to the example illustrated in FIG. 15.

Further, as shown in FIG. 15, Doppler demultiplexing using peak detection results of the reception antennas of the same polarization is possible, and since power addition operations between reception antennas of two different polarizations may not be performed, a reduction in the amount of computation in radar receiver 200a can be achieved.

For example, among the outputs of Na Doppler analyzers 210, the outputs of first to N_{RxPL1}th Doppler analyzers 210 correspond to the reception signals of the reception antennas of RxPL1 polarization, and are input to first CFAR section 211a-1 that performs CFAR processing on the reception signals with RxPL1 polarization.

Further, for example, among the outputs of Na Doppler analyzers 210, the outputs of the Rx #N_{RxPL1}+1 to Nath Doppler analyzers 210 correspond to the reception signals of the reception antennas of RxPL2 polarization, and are input to second CFAR section 211a-2, which performs CFAR processing on the reception signals with RxPL2 polarization.

First coded Doppler demultiplexer 212a-1, for example, based on f_{b_cf}, f_{sc_cf}, and reception power information PowerFT_{RxPL1}(f_{b_cf}, f_{sc_cf}+(nfd−ceil(N_{DM}/2)−1)×ΔFD) (where nfd=1 to N_{DM}) for Doppler frequency index (f_{sc_cf}+(nfd−ceil(N_{DM}/2)−1)×ΔFD) of N_{DM} DDM signals input from, for example, first CFAR section 211a-1, demultiplexes Nₜ CDDM-transmitted signals using the outputs of first to N_{RxPL1}th Doppler analyzers 210 that are reception signals of the reception antennas of the RxPL1 polarization, and performs discrimination (for example, also referred to as determination or identification) of the transmission antenna and discrimination of the Doppler frequency (for example, also referred to as Doppler velocity or relative velocity). The operation of first coded Doppler demultiplexer 212a-1 is different from the operation of coded Doppler demultiplexer 212 in FIG. 4 in that the operation of first coded Doppler demultiplexer 212a-1 uses the reception power information based on the outputs of first to N_{RxPL1}th Doppler analyzers 210, and the other operations may be the same as the operation of coded Doppler demultiplexer 212.

Second coded Doppler demultiplexer 212a-2, for example, based on f_{b_cf}, f_{sc_cf}, and reception power information PowerFT_{RxPL2}(f_{b_cf}, f_{sc_cf}+(nfd−ceil(N_{DM}/2)−1)×ΔFD) (where nfd=1 to N_{DM}) for Doppler frequency indices (f_{sc_cf}+(nfd-ceil(N_{DM}/2)−1)×ΔFD) of N_{DM} DDM signals, which are the outputs of second CFAR section 211a-2, demultiplexes Nₜ CDDM-transmitted signals using the outputs of N_{RxPL1}+1th to Nₐth Doppler analyzers 210, which are reception signals of the reception antennas of the RxPL2 polarization, and performs discrimination (for example, also referred to as determination or identification) of the transmission antenna and discrimination of the Doppler frequency (for example, Doppler velocity or relative velocity). Second coded Doppler demultiplexer 212a-2 is different from coded Doppler demultiplexer 212 in FIG. 4 in that second coded Doppler demultiplexer 212a-2 uses reception power information based on the outputs of N_{RxPL1}+1th to Nₐth Doppler analyzers 210, and the other operations may be the same as those of coded Doppler demultiplexer 212.

Next, an exemplary operation of first direction estimator 213a-1 and second direction estimator 213a-2 will be described. Hereinafter, first direction estimator 213a-1 and second direction estimator 213a-2 will be collectively referred to as “yth direction estimator 213a” and will be described together. Here, y is 1 or 2. The yth direction estimator 213a performs, for example, the target-object direction estimation processing based on the signal input from yth coded Doppler demultiplexer 212a.

Hereinafter, Exemplary Operation 1 and Exemplary Operation 2 of yth direction estimator 213a will be described.

<Exemplary Operation 1 of yth Direction Estimator 213a>

For example, yth direction estimator 213a generates virtual reception array correlation vector h_{RxPLy}(f_{b_cf}, f_{b_comp_cf}) of yth direction estimator 213a based on f_{b_cf} and reception signal Y_{z}(f_{b_cf}, f_{sc_cf}, ndc(ndm), ndm) subjected to CDDM demultiplexing processing, which are signals input from yth coded Doppler demultiplexer 212a, and performs the direction estimation processing. Here, y is 1 or 2.

Virtual reception array correlation vector h_{RxPLy}(f_{b_cf}, f_{b_comp_cf}) includes Nt×N_{RxPLy} elements, which is a product of number Nt of transmission antennas and number N_{RxPLy} of reception antennas of the RxPLy polarization. The yth direction estimator 213a performs direction estimation based on the phase difference between the transmission/reception antennas for the reflected wave signals from the target object using virtual reception array correlation vector h_{RxPLy}(f_{b_cf}, f_{b_comp_cf}).

For example, to perform direction estimation processing for each polarization transmission antenna, yth direction estimator 213a extracts reception signals corresponding to transmission antennas of the same polarization from virtual reception array correlation vector h_{RxPLy}(f_{b_cf}, f_{sc_cf}), and generates virtual reception array correlation vector hPL_{q}, R_{xPLy}(f_{b_cf}, f_{sc_cf}) by the transmission antennas of the PLq polarization. Here, h_{pLq,RxPLy}(f_{b_cf},f_{sc_cf}) is a column vector having N_{PLq}×N_{RxPLy} elements.

The yth direction estimator 213a may, for example, perform direction estimation processing using virtual reception array correlation vector hPL_{q, RxPLy}(f_{b_cf}, f_{sc_cf}) by the transmission antennas of the PLq polarization, and may output the direction-of-arrival estimation value (for example, the positioning output) by the reception antennas of the RxPLy polarization for each PLq polarization.

Through the above operations, yth direction estimator 213a may, for example, output, as the positioning output, the direction-of-arrival estimation value by the reception antennas of the RxPLy polarization for each differently-polarized transmission antenna for f_{b_cf} and reception signal Y_{z}(f_{b_cf}, f_{sc_cf}, ndc(ndm), ndm) on which the CDDM demultiplexing processing has been performed, which are signals input from yth coded Doppler demultiplexer 212a. Further, yth direction estimator 213a may output f_{b_cf} as the positioning output.

<Exemplary Operation 2 of yth Direction Estimator 213a>

For example, yth direction estimator 213a generates virtual reception array correlation vector h_{PLq,RxPLy}(f_{b_cf}, f_{sc_cf}) by the transmission antennas of the PLq polarization based on f_{b_cf} and reception signals YPLq_{z}(f_{b_cf}, f_{sc_cf}, ndc(ndm), ndm) subjected to CDDM demultiplexing processing, which are input from yth coded Doppler demultiplexer 212a, and performs the direction estimation processing. The yth direction estimator 213a performs, for example, direction estimation processing of a polarization (PLq polarization) corresponding to q that matches the polarization of reception signals YPLq_{z}(f_{b_cf}, f_{sc_cf}, ndc(ndm), ndm) subjected to CDDM processing.

This operation is different from the operation in Exemplary Operation 1 in that yth direction estimator 213a performs direction estimation processing of a polarization (PLq polarization) corresponding to q that matches the polarization of reception signals YPLq_{z}(f_{b_cf}, f_{sc_cf}, ndc(ndm), ndm) subjected to CDDM processing. The operation in this case is the same as the operation in which the processing in which reception signal Y_{z}(f_{b_cf}, f_{sc_cf}, ndc(ndm), ndm) in the operation in Exemplary Operation 1 is replaced with reception signals YPLq_{z}(f_{b_cf}, f_{sc_cf}, ndc(ndm), ndm), and thus, the detailed description of the operation will be omitted.

Through the above operation, for example, based on reception signals from the transmission antenna of the PLq polarization for f_{b_cf} and the reception signals YPLq_{z}(f_{b_cf}, f_{sc_cf}, ndc(ndm), ndm) subjected to the CDDM demultiplexing processing, which are input from yth coded Doppler demultiplexer 212a, yth direction estimator 213a may output the direction-of-arrival estimation value by the reception antennas of the R_{xPLy} polarization for the PLq polarization transmission as the positioning output. Further, yth direction estimator 213a may output f_{b_cf} as the positioning output.

The above describes Exemplary Operation 1 and Exemplary Operation 2 of yth direction estimator 213a.

Through such operations, yth direction estimator 213a can obtain the results of direction estimation processing with the RxPLy-polarized reception antenna for each transmission polarization, or the direction estimation results with the RxPLy-polarized reception antenna for some transmission polarizations depending on the situation of the reflected waves, thus obtaining direction estimation results dependent on the transmission and reception polarization antennas. Since the response of the reflected waves from the target object can vary depending on the transmission and reception polarizations, radar apparatus 10 can improve the detection or identification performance of the target object based on such direction estimation results dependent on the transmission and reception polarizations.

Note that, here, a case where yth direction estimator 213a performs the target-object direction estimation processing based on the signal input from yth coded Doppler demultiplexer 212a (for example, f_{b_cf}, reception signal Y_{z}(f_{b_cf}, f_{sc_cf}, ndc(ndm), ndm) subjected to CDDM demultiplexing processing, or f_{sc_cf}) and the output of Doppler analyzer 210 corresponding to these distance and Doppler demultiplexing indices has been described, but the present disclosure is not limited thereto.

For example, yth direction estimator 213a may perform the target-object direction estimation processing based on the signal input from first coded Doppler demultiplexer 212a-1 and the signal input from second coded Doppler demultiplexer 212a-2.

For example, yth direction estimator 213a calculates virtual reception array correlation vector h_{PL1, RxPL1}(f_{b_cf}, f_{sc_cf}) based on the reception signal transmitted from a transmission antenna of PL1 polarization and received by a reception antenna of RxPL1 polarization, using the signal input from first coded Doppler demultiplexer 212a-1. Further, yth direction estimator 213a calculates virtual reception array correlation vector h_{PL2, RxPL2}(f_{b_cf}, f_{sc_cf}) based on the reception signal transmitted from a transmission antenna of PL2 polarization and received by a reception antenna of RxPL2 polarization, using the signal input from second coded Doppler demultiplexer 212a-2. Subsequently, yth direction estimator 213a may perform the target-object direction estimation processing based on virtual reception array correlation vector h_{PL1, RxPL1}(f_{b_cf}, f_{sc_cf}) and virtual reception array correlation vector h_{PL2, RxPL2}(f_{b_cf}, f_{sc_cf}).

Alternatively, for example, yth direction estimator 213a calculates virtual reception array correlation vector h_{PL2, RxPL1}(f_{b_cf}, f_{sc_cf}) based on the reception signal transmitted from a transmission antenna of PL2 polarization and received by a reception antenna of RxPL1 polarization, using a signal input from first coded Doppler demultiplexer 212a-1. Further, yth direction estimator 213a calculates virtual reception array correlation vector h_{PL1, RxPL2}(f_{b_cf}, f_{sc_cf}) based on the reception signal transmitted from a transmission antenna of PL1 polarization and received by a reception antenna of RxPL2 polarization, using the signal input from second coded Doppler demultiplexer 212a-2. Further, yth direction estimator 213a may perform the target-object direction estimation processing based on virtual reception array correlation vectors h_{PL2, RxPL1}(f_{b_cf}, f_{sc_cf}) and h_{PL1, RxPL2}(f_{b_cf}, f_{sc_cf}).

### (Variation 2)

Regarding the transmission polarizations of different polarizations, above-described Embodiment 1 is described in relation to the example of two polarizations, PL1 polarization and PL2 polarization, which are in orthogonal polarization relationship, but the present disclosure is not limited to this, and the number of polarizations may be three or more. For example, in addition to the two polarizations, PL1 polarization and PL2 polarization, which are in orthogonal polarization relationship, a transmission antenna of another polarization different from PL1 polarization and PL2 polarization may be used.

For example, radar apparatus 10 (e.g., polarimetric MIMO radar) may use Nt transmission antennas that include transmission antennas of three or more different polarizations, including two polarizations that are in orthogonal polarization relationship.

Hereinafter, the first polarization is described as PL1 polarization, and the second polarization is described as PL2 polarization. The qth polarization is described as PLq polarization. Also, combinations of different polarizations that are in orthogonal polarization relationship may include, for example, PL1 polarization and PL2 polarization, right-handed circular polarization and left-handed circular polarization, horizontal polarization and vertical polarization, and right diagonal 45° polarization and left diagonal 45° polarization.

Further, number Nt of transmission antennas is set to be equal to or greater than 3. For example, number N_{DM} of Doppler multiplexing ≥2 and number N_{CM} of code multiplexing ≥2. For example, Nₜ<N_{DM}×N_{CM}. Further, the number of transmission antennas of PLq polarization is denoted as “N_{PLq}.” Here, number N_{PLq} of PLq polarization antennas is N_{PLq}≥1, and N_{PL1}+N_{PL2}+ . . . +N_{PL_NPL}=Nₜ, where q=1 to NPL. For example, the transmission antennas include N_{PL1} PL1-polarized antennas and N_{PL2} PL2-polarized antennas, and N_{PL1}+N_{PL2}<Nt. Further, the number of Doppler multiplexing assigned for the transmission antennas of PLq polarization is denoted as “N_{DM_PLq}.” Here, N_{DM_PLq}≤N_{DM}.

Radar apparatus 10 performs CDDM transmission using, for example, Nt transmission antennas.

Further, radar apparatus 10 performs simultaneous multiplexing transmission from Nt transmission antennas using CDDM transmission that satisfies Condition 1a and Condition 2a described later for Nt transmission antennas including transmission antennas of PL1 polarization and PL2 polarization, which are cross-polarizations with respect to each other, and a transmission antenna for a polarization different from PL1 polarization and PL2 polarization.

Conditions 1a and 2a are, for example, conditions in the case of including a transmission antenna of another polarization different from PL1 polarization and PL2 polarization, in addition to the two polarizations, PL1 polarization and PL2 polarization, which are in orthogonal polarization relationship. For example, when there is no transmission antenna of another different polarization besides the transmission antennas of the two polarizations, PL1 polarization and PL2 polarization, which are in orthogonal polarization relationship, Conditions 1a and 2a become equivalent to Conditions 1 and 2.

For example, the reflected waves corresponding to the radar transmission signals from the transmission antennas of PL1 polarization and PL2 polarization, which are in orthogonal polarization relationship, become cross-polarized with respect to reception antenna section 202, which may result in cases where the reception levels of the reception signals significantly differ. On the other hand, among the Nt transmission antennas, the transmission antennas of a different polarization other than PL1-polarized and PL2-polarized antennas do not become orthogonal polarization relationship with PL1 polarization and PL2 polarization. Therefore, the reflected waves corresponding to the radar transmission signals from the transmission antennas of other polarizations are less likely to significantly differ in reception level of the reception signals from the reception level of the reception signals corresponding to the transmission antennas of PL1 polarization and PL2 polarization.

Thus, for example, in Condition 1a, a condition of “polarization transmission antenna excluding PL2 polarization (for example, (Nt−N_{PL2}) transmission antennas)” may be applied instead of “transmission antenna of PL1 polarization” in Condition 1. Similarly, in Condition 1a, a condition of “polarization transmission antenna excluding PL1 polarization (for example, (Nt−N_{PL1}) transmission antennas)” may be applied instead of the “transmission antenna of PL2 polarization” in Condition 1.

Further, for example, in Condition 2a, a condition of “each of a polarization transmission antenna excluding a PL2 polarization antenna and a polarization transmission antenna excluding a PL1 polarization antenna” may be applied instead of “a transmission antenna of the same polarization” in Condition 2.

For example, Condition 1a and Condition 2a may be defined as follows.

<Condition 1a>

For example, for each of a polarization transmission antenna excluding PL2 polarization and a polarization transmission antenna excluding PL1 polarization, phase rotation amount setter 105 configures CDP amount ψ_{ndc(ndm), ndm(m)} that satisfies a condition of a different DDM pattern (for example, an assignment pattern of a Doppler shift amount), a condition of a different CDM pattern (for example, the numbers of code multiplexing different between DDM signals), or a condition of a different pattern of Doppler multiplexing and code multiplexing.

<Condition 2a>

Multiplexing transmission of each of the signals transmitted from the polarization transmission antenna excluding the PL2 polarization antenna and the polarization transmission antenna excluding the PL1 polarization antenna is performed with the numbers of code multiplexing that are non-uniform between the DDM signals, and the numbers of code multiplexing include any of the ranges from 1 to N_{CM}−1, inclusive.

By applying a CDP amount that satisfies above Condition 1a to the transmission antenna, radar apparatus 10 achieves the following effects.

For example, the Doppler frequency of the reception signal includes the coded Doppler phase rotation at the time of transmission as described above, and further includes the Doppler frequency of an unknown target object. For this reason, the intervals between the DDM signals may be maintained, while their Doppler frequencies may change in the positive or negative direction. For example, by satisfying 1A of Condition 1a (for example, at least one of A-1, A-2, or A-3), radar apparatus 10 can discriminate between a case where a CDDM signal assigned for a transmission antenna of PL1 polarization is not received and a case where a CDDM signal assigned for a transmission antenna of PL2 polarization is not received, because the intervals or the numbers of Doppler multiplexing for the DDM signals are different from one another in these cases.

Further, for example, by satisfying 1B of Condition 1a (for example, at least one of B-1 or B-2), radar apparatus 10 can discriminate between a case where a CDDM signal assigned for a transmission antenna of PL1 polarization is not received and a case where a CDDM signal assigned for a transmission antenna of PL2 polarization is not received, because the code intervals or the numbers of code multiplexing at which the reception level becomes high are different after each DDM signal is code-demultiplexed.

Thus, by configuring the CDP amounts by phase rotation amount setter 105 to satisfy Condition 1a, radar apparatus 10 can demultiplex CDDM signals and prevent the degradation of positioning performance and radar detection performance even in cases where the reception levels between reception signals corresponding to transmission antennas of different polarizations vary significantly.

Further, by satisfying Condition 2a in addition to Condition 1a, the configuration of the CDP amounts by phase rotation amount setter 105 allows the Doppler frequency range in which detection can be performed in radar apparatus 10 to be −1/(2Tr)≤fd<1/(2Tr); it is thus possible to expand the range to a range equivalent to the Doppler detection range in the case of one transmission antenna.

Hereinafter, an example of the CDP amount configuration in phase rotation amount setter 105 will be described.

### Configuration Example 5

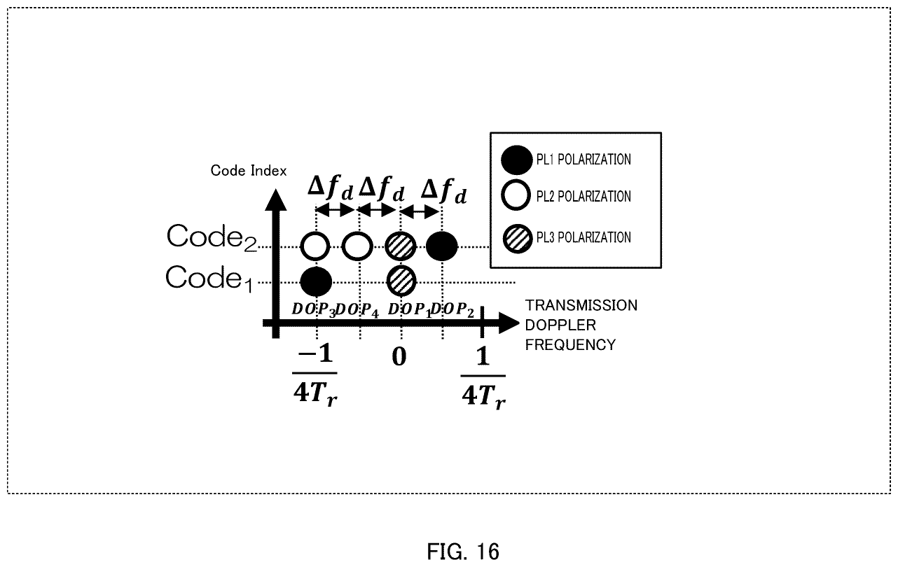

FIG. 16 illustrates an example of the CDP amount configuration in phase rotation amount setter 105 in a case where number Nt of transmission antennas is 6, N_{PL1}=2, N_{PL2}=2, and N_{PL3}=3.

In FIG. 16, the black circles indicate the assignment of CDDM signals for the transmission antennas (Tx #1 and Tx #2) of PL1 polarization, the white circles indicate the assignment of CDDM signals for the transmission antennas (Tx #3 and Tx #4) of PL2 polarization, and the shaded circles indicate the assignment of CDDM signals for the transmission antennas (Tx #5 and Tx #6) of PL3 polarization (for example, vertical (V) polarization). For example, the PL1 polarization and the PL2 polarization are polarizations that are in a relationship of orthogonal polarizations with each other. For example, PL1 polarization may be LC polarization, and PL2 polarization may be RC polarization. Further, the PL3 polarization may be a polarization (for example, vertical (V) polarization) that does not become an orthogonal polarization with respect to the PL1 polarization and the PL2 polarization.

Further, in FIG. 16, number N_{DM} of Doppler multiplexing=4, and Doppler shift setter 106 may configure four DOP₁ to DOP₄ using, for example, the maximum equal-interval Doppler shift amount configuration illustrated in Expression 5. In FIG. 16, phase rotation amount φ₁=0 for applying DOP₁=0, phase rotation amount φ₂=π/2 for applying DOP₂=Δfd, phase rotation amount φ₃=π for applying DOP₃=−2Δfd, and phase rotation amount φ₄=3π/2 (φ₄=−π/2 may be used) for applying DOP₄=−Δfd. As illustrated in FIG. 16, the interval (also referred to as a Doppler multiplexing interval, a Doppler shift interval, or a Doppler interval) Δfd between DDM signals is an equal interval, and Δfd=1/(8Tr).

Further, in FIG. 16, number N_{CM} of code multiplexing is 2, and encoder 107 uses, for example, Code₁={1, 1} and Code₂={1, −1}, which are orthogonal code sequences with a code length Loc=2.

In FIG. 16, number Nₜ of transmission antennas is 6, number N_{DM} of Doppler multiplexing is 4, and number N_{CM} of code multiplexing is 2, and thus, since Nₜ<N_{DM}×N_{CM}, phase rotation amount setter 105 can configure numbers N_{CDDM}(ndm) of coded Doppler multiplexing for the DDM signals non-uniformly (where ndm=1 to N_{DM}).

As illustrated in FIG. 16, the numbers of coded Doppler multiplexing for the DDM signals using four DOP₁ to DOP₄ input from Doppler shift setter 106 in encoder 107 are N_{CDDM}(1)=2, N_{CDDM}(2)=1, N_{CDDM}(3)=2, and N_{CDDM}(4)=1, respectively. As described above, phase rotation amount setter 105 configures the numbers of coded Doppler multiplexing for the DDM signals non-uniformly.

Further, in FIG. 16, Doppler shift setter 106 assigns, for transmission antennas Tx #1 and Tx #2 of PL1 polarization, DDM signals for which, for example, Doppler shift amounts DOP₂ and DOP₃ are used (N_{DM_PL1}=2), from among the DDM signals with number N_{DM} of Doppler multiplexing=4, assigns, for Tx #3 and Tx #4 of PL2 polarization, DDM signals for which, for example, Doppler shift amounts DOP₃ and DOP₄ are used (N_{DM_PL2}=2), from among the DDM signals with number N_{DM} of Doppler multiplexing=4, and assigns, for Tx #5 and Tx #6 of PL3 polarization, DDM signals for which, for example, Doppler shift amount DOP₁ is used (N_{DM_PL2}=1), from among the DDM signals with number N_{DM} of Doppler multiplexing=4.

For example, phase rotation amount setter 105 configures CDP amounts ψ_{2, 2}(m) and ψ_{1, 3}(m) respectively for Tx #1 and Tx #2 of PL1 polarization, CDP amounts ψ_{2, 3}(m) and ψ_{2, 4}(m) respectively for Tx #3 and Tx #4 of PL2 polarization, and CDP amounts ψ_{1, 1}(m) and ψ_{2, 1}(m) respectively for Tx #5 and Tx #6 of PL3 polarization.

For example, in FIG. 16, the number of Doppler multiplexing that Doppler shift setter 106 assigns for the transmission antennas (transmission antennas of PL1 polarization and PL3 polarization) excluding the transmission antenna of PL2 polarization is 3, and the number of Doppler multiplexing that Doppler shift setter 106 assigns for the transmission antennas (transmission antennas of PL2 polarization and PL3 polarization) excluding the transmission antenna of PL1 polarization is 3, and these numbers are the same.

Further, the Doppler shift intervals of the DDM signals assigned for the transmission antennas excluding the transmission antenna of the PL2 polarization are Δfd (1,2)=Δfd, Δfd (2,3)=Δfd, and Δfd (3,1)=2Δfd, and the Doppler shift intervals of the DDM signals assigned for the transmission antennas excluding the transmission antenna of the PL1 polarization are Δfd (1,3)=2Δfd, Δfd (3,4)=Δfd, and Δfd (4,1)=Δfd, and are cyclically matched and identical, and thus, do not match the different-DDM-pattern condition of 1A in Condition 1a.

Note that, the code indices assigned for the transmission antennas (transmission antennas of PL1 polarization and PL3 polarization) excluding the transmission antennas of PL2 polarization for DOP₁ to DOP₄ are represented as “CiNoPL2.” In the case of FIG. 16, CiNoPL2=(2, 1,1, *). Further, the code indices assigned for the transmission antennas (transmission antennas of PL2 polarization and PL3 polarization) excluding the transmission antennas of PL1 polarization for DOP₁ to DOP₄ are represented as “CiNoPL1.” In the case of FIG. 16, CiNoPL1=(2, *, 1, 1).

Further, the numbers of code multiplexing assigned for the transmission antennas (transmission antennas of PL1 polarization and PL3 polarization) excluding the transmission antennas of PL2 polarization for DOP₁ to DOP₄ are represented as “NcNoPL2.” In the case of FIG. 16, NcNoPL2=(2, 1, 1, 0). Further, the numbers of code multiplexing assigned for the transmission antennas (transmission antennas of PL2 polarization and PL3 polarization) excluding the transmission antennas of PL1 polarization for DOP₁ to DOP₄ are represented as “NcNoPL1.” In the case of FIG. 16, NcNoPL1=(2, 0, 1, 1).

As described above, the code indices assigned respectively for the DDM signals for the transmission antennas excluding the transmission antennas of the PL2 polarization and the transmission antennas excluding the transmission antennas of the PL1 polarization are CiNoPL2=(2, 1, 1, *) and CiNoPL1=(2, *, 1, 1), respectively, and the code indices are cyclically mismatched and the code index intervals are different, and thus, B-1 of Condition 1a is satisfied.

Further, the numbers of code multiplexing assigned respectively for DDM signals for the transmission antennas excluding the transmission antennas of the PL2 polarization and the transmission antennas excluding the transmission antennas of the PL1 polarization are NcNoPL2=(2, 1, 1, 0) and NcNoPL1=(2, 0, 1, 1), respectively, resulting in a cyclic mismatch and satisfying B-2 of Condition 1a.

Further, in a case where the Doppler frequency of the target object is −1/(2Tr)≤f_{dtg}<−1/(4Tr) or 1/(4Tr)≤f_{dtg}<1/(2Tr), Doppler analyzers 210 observe the aliased Doppler frequency. In this case, the code indices are CiNoPL2ₐₗᵢₐₛ=(1, 2, 2, *), CiNoPL1ₐₗᵢₐₛ=(1, *, 2, 2), and they are different from one another (cyclically mismatched). Thus, in the example of FIG. 16, the code indices have a cyclic mismatch and the code intervals are different from each other in a range of the Doppler frequency of the target object being −1/(2Tr)≤f_{dtg}<−1/(2Tr).

Accordingly, 1B of Condition 1a is satisfied, and the different-CDM-pattern condition is met.

Thus, the configuration of the CDP amounts illustrated in FIG. 16 is an example of a configuration that satisfies Condition 1a.

Further, in FIG. 16, the number of code multiplexing assigned for each DDM signal in the transmission antenna excluding the transmission antenna of the PL2 polarization is NcNoPL2=(2, 1, 1, 0), and the number of code multiplexing assigned for each DDM signal in the transmission antenna excluding the transmission antenna of the PL1 polarization is NcNoPL1=(2, 0, 1, 1), and multiplexing transmission is performed in both cases with numbers of code multiplexing that are non-uniform between the DDM signals, and the numbers of code multiplexing are included in a range of from 1 to N_{CM}−1, inclusive.

Thus, in the example of FIG. 16, the signals transmitted from the transmission antennas excluding the transmission antennas of PL2 polarization and the transmission antennas excluding the transmission antennas of PL1 polarization are multiplexed and transmitted with the numbers of code multiplexing that are non-uniform between the DDM signals, and the numbers of code multiplexing are included in a range of from 1 to N_{CM}−1, inclusive. Accordingly, the configuration of the CDP amounts illustrated in FIG. 16 is an example of a configuration that satisfies Condition 2a.

In a case where the target-object reflected wave that is cross-polarized with respect to the polarization of the reception antenna is not included according to the configuration of the CDP amounts illustrated in FIG. 16, radar apparatus 10 receives the reception signals corresponding respectively to the transmission antennas (Tx #1 and Tx #2) of the PL1 polarization, the transmission antennas (Tx #3 and Tx #4) of the PL2 polarization, and the transmission antennas (Tx #5 and Tx #6) of the PL3 polarization at substantially the same level or at a level within a range of approximately several dB to 6 dB. Here, in FIG. 16, the signals transmitted from Tx #1 to Tx #6, which are composed of Nt (=6) transmission antennas of PL1 polarization, PL2 polarization, and PL3 polarization, are CDDM-transmitted using CDP amounts that make the numbers of coded Doppler multiplexing for the DDM signals non-uniform.

Thus, radar apparatus 10 can demultiplex CDDM signals based on the existing demultiplexing operation on CDDM signals.

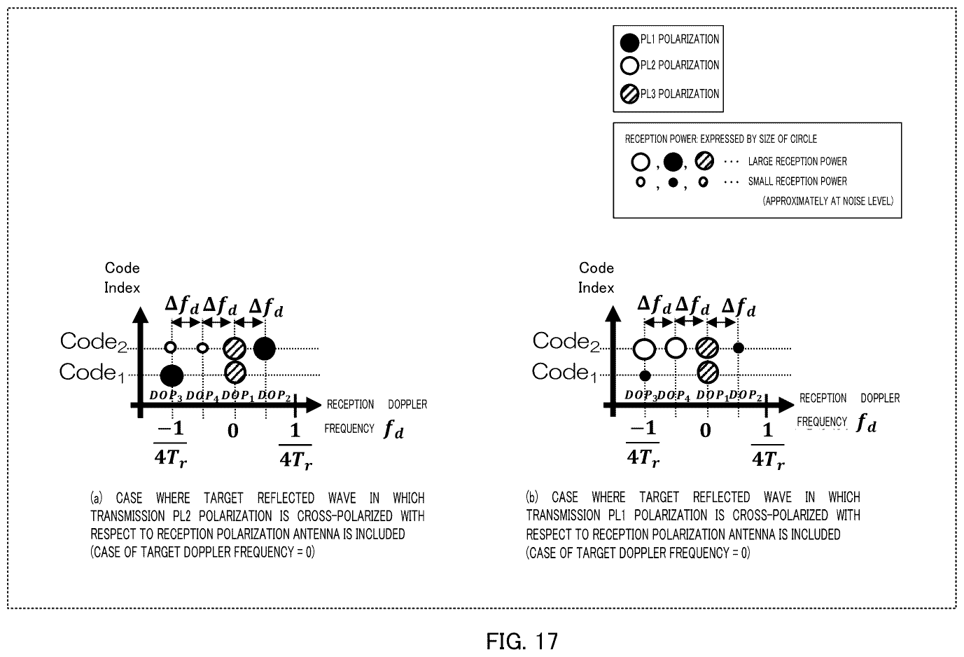

Further, for example, in the configuration of the CDP amounts illustrated in FIG. 16, in a case where the target-object reflected wave that is cross-polarized with respect to the polarization of the reception antenna is included, radar apparatus 10 receives different CDDM signals (for example, CDDM signals satisfying 1B of Condition 1a) from each other between a case where the target-object reflected wave in which PL2 polarization is a cross-polarization is included as illustrated in (a) of FIG. 17 and a case where the target-object reflected wave in which PL1 polarization is a cross-polarization is included as illustrated in (b) of FIG. 17.

As described above, in a case where the target-object reflected wave that is cross-polarized with respect to the polarization of the reception antenna is included, radar apparatus 10 receives reflected-wave signals including Doppler frequency components of different patterns from each other between a case as illustrated in (a) of FIG. 17 where the reception levels of the reception signals corresponding to the transmission antennas of PL2 polarization decrease (for example, corresponding to a case where reflection waves corresponding to transmission antennas other than the transmission antennas of PL2 polarization are received) and a case as illustrated in (b) of FIG. 17 where the reception levels of the reception signals corresponding to the transmission antennas of PL1 polarization decrease (for example, corresponding to a case where reflection waves corresponding to transmission antennas other than the transmission antennas of PL1 polarization are received).

Thus, radar apparatus 10 can determine, for example, in coded Doppler demultiplexer 212, whether a reception level decrease of a reception signal corresponding to a transmission antenna of PL1 polarization (for example, LC polarization) has occurred or a reception level decrease of a reception signal corresponding to a transmission antenna of PL2 polarization (for example, RC polarization) has occurred, based on the detected peak of the Doppler frequency after the code demultiplexing.

For example, the DDM signals of polarizations other than the PL2 polarization are transmitted by code multiplexing with non-uniform numbers of code multiplexing between N_{DM} DDM signals (the numbers of code multiplexing include a range from 1 to N_{CM}−1).

Thus, for example, in a case where the reception signals are determined based on the determination result by coded Doppler demultiplexer 212 as reception signals corresponding to transmission signals by the polarization transmission antennas excluding the transmission antennas of PL2 polarization, radar apparatus 10 can demultiplex the CDDM signals using the existing demultiplexing operation on the CDDM signal.

Similarly, for example, the DDM signals of polarizations other than the PL1 polarization are multiplexed and transmitted with the numbers of code multiplexing that are non-uniform among the N_{DM} DDM signals (the numbers of code multiplexing include a range from 1 to N_{CM}−1).

Thus, for example, in a case where the reception signals are determined based on the determination result by coded Doppler demultiplexer 212 as reception signals corresponding to transmission signals by the polarization transmission antennas excluding the transmission antennas of PL1 polarization, radar apparatus 10 can demultiplex the CDDM signals using the existing demultiplexing operation on the CDDM signals.

By the operation of coded Doppler demultiplexer 212 as described above, radar apparatus 10 can determine Doppler frequency f_{d} of the target object in a range of −1/(2Tr)≤f_{d}<1/(2Tr), and can obtain an output in which a transmission antenna is associated with each DDM signal.

The above describes an example of the CDP amount configuration in phase rotation amount setter 105.

### [Exemplary Operation of Coded Doppler Demultiplexer 212]

For example, in a case where in addition to the two polarizations, PL1 polarization and PL2 polarization, which are in orthogonal polarization relationship, a transmission antenna of another polarization different from PL1 polarization and PL2 polarization a transmission antenna of another polarization (for example, PL3 polarization) different from PL1 polarization and PL2 polarization is used, a DDM signal to which the CDP amount configured in phase rotation amount setter 105 described above is applied can be demultiplexed by the operation of coded Doppler demultiplexer 212 as follows. Hereinafter, an operation of coded Doppler demultiplexer 212 according to Variation 2, which is different from the operation in the embodiment described above, will be described.

In Variation 2, the operations in Step B and Step C of the demultiplexing operation on the CDDM signal in coded Doppler demultiplexer 212 illustrated in FIG. 14 are different from the operations in the embodiment described above as follows.

### <Step B-1>

In the demultiplexing operation on the CDDM signal in coded Doppler demultiplexer 212 illustrated in FIG. 14, the CDDM demultiplexing processing is performed for N_{PL1} PL1 polarizations, but in Variation 2, the CDDM demultiplexing processing is performed on DDM signals of polarization transmission antennas excluding (Nt−N_{PL2}) PL2 polarizations. The other operations are the same, and thus, the description thereof will be omitted.

### <Step B-2>

Coded Doppler demultiplexer 212 determines whether the (Nt−N_{PL2}) CDDM signals assigned for (Nt−N_{PL2}) transmission antennas excluding the transmission antenna of the PL2 polarization are normally detected. In a case where the (Nt−N_{PL2}) CDDM signals are normally detected, coded Doppler demultiplexer 212 performs the processing in Step B-3, and in a case where the (Nt−N_{PL2}) CDDM signals are not normally detected, coded Doppler demultiplexer 212 performs the processing in Step C-1.

For example, in the processing of Step B-1, in a case where a target-object reflected wave in which PL2 polarization is a cross polarization with respect to the polarization of the reception antenna is not included, there is a possibility that the (Nt−N_{PL2}) CDDM signals are not detected normally.

Coded Doppler demultiplexer 212, for example, determines that the target-object reflected wave in which PL2 polarization is a cross polarization with respect to the polarization of the reception antenna not included, in a case where the power difference (or power ratio) between the extracted top N_{DM_NotPL2} DDM signals in terms of power and the other (N_{DM}−N_{DM_NotPL2}) lower-power DDM signals is not equal to or greater than a predetermined level, and performs the processing in Step C-1.

In a case where the configuration of the CDP amounts by phase rotation amount setter 105 satisfies (A-2) of Condition 1a, coded Doppler demultiplexer 212 can perform such determination processing.

Here, N_{DM_NotPL2} is the number of DDM signals at which CDDM signals are assigned for the transmission antennas excluding the transmission antennas of the PL2 polarization. For example, N_{DM_NotPL2} is the number of DDM signals for which the number of code multiplexing assigned for N_{DM} DDM signals for the transmission antennas excluding the transmission antennas of the PL2 polarization is equal to or greater than 1. For example, in the configuration example in FIG. 16, NcNoPL2=(2, 1, 1, 0), and N_{DM_NotPL2}=3.

Further, in a case where the Doppler multiplexing interval of the extracted top N_{DM_NotPL2} DDM signals in terms of power match the Doppler multiplexing interval assigned for the polarization transmission antennas excluding the PL2 polarization, coded Doppler demultiplexer 212 determines that the target-object reflected wave in which the PL2 polarization is a cross-polarization with respect to the polarization of the reception antenna is not included, and performs the processing in Step C-1.

In a case where the CDP amount configuration by phase rotation amount setter 105 satisfies (A-1) or (A-3) of Condition 1a, coded Doppler demultiplexer 212 is capable of performing such determination processing.

Further, for example, the configuration of phase rotation amount setter 105 is N_{DM_NotPL1}=N_{DM_NotPL2} for (Nt−N_{PL2}) transmission antennas excluding the transmission antennas of PL2 polarization. In this case, when the target-object reflected wave in which the PL1 polarization is a cross-polarization with respect to the polarization of the reception antenna is included, a reception power within a predetermined range is received among reception powers PowerFT(f_{b_cf}, f_{sc_cf}+(nfd−ceil(N_{DM}/2)−1)×ΔFD) for the Doppler frequency indices (f_{sc_cf}+(nfd-ceil(N_{DM}/2)−1)×ΔFD) of the N_{DM} DDM signals. In such a case, during the code demultiplexing processing, a signal with a code interval or number of code multiplexing different from that of the expected N_{DM_NotPL2} CDDM signals is obtained, causing coded Doppler demultiplexer 212 to fail in the aliasing determination and making it difficult to detect the N_{DM_NotPL2} CDDM signals normally. In this case, coded Doppler demultiplexer 212 determines that the detection for the N_{DM_NotPL2} CDDM signals is not normal, and performs the processing in Step C-1.

In a case where the CDP amount configuration by phase rotation amount setter 105 satisfies (B-1) or (B-2) of Condition 1a, coded Doppler demultiplexer 212 can perform such determination processing.

### <Step B-3>

Based on the processing result in Step B-2, coded Doppler demultiplexer 212 outputs reception signals YPL1_{z}(f_{b_cf}, f_{sc_cf}, ncm, ndm) resulting from CDDM demultiplexing processing on the CDDM signals used for the multiplexing transmission of (Nt−N_{PL2}) transmission antennas excluding the transmission antennas of the PL2 polarization, to direction estimator 213 together with f_{b_cf} and f_{sc_cf}.

Here, YPL1_{z}(f_{b_cf}, f_{sc_cf}, ndc(ndm), ndm) are outputs (for example, CDDM demultiplexing results) for f_{b_cf} and f_{sc_cf}, resulting from demultiplexing of Doppler analyzers 210 in zth antenna system processor 201 on the CDDM signals using DOP ndm and orthogonal code Code_{ndc(ndm)}. For example, YPL1_{z}(f_{b_cf}, f_{sc_cf}, ndc(ndm), ndm) represents reception signals that are transmitted from (Nt−N_{PL2}) transmission antennas Tx #[ndc(ndm), ndm] excluding the transmission antennas of the PL2 polarization, are reflected by the target object, and are received by zth antenna system processor 201.

Note that z=1 to Na, ndm=1 to N_{DM}, ndc(ndm)=1 to N_{CDDM}(ndm), and the signals assigned for N_{PL2} transmission antennas corresponding to the PL2 polarization are output as zero.

### <Step C-1>

Coded Doppler demultiplexer 212 performs CDDM demultiplexing processing on the CDDM signals of the polarization transmission antennas excluding (Nt−N_{PL1}) PL1 polarizations, assuming a case where the target-object reflected wave in which the PL1 polarization is a cross-polarization with respect to the polarization of the reception antenna is included.

In the demultiplexing operation on the CDDM signal in coded Doppler demultiplexer 212 illustrated in FIG. 14, the CDDM demultiplexing processing is performed for N_{PL2} PL2 polarizations, but in Variation 2, the CDDM demultiplexing processing is performed on DDM signals of polarization transmission antennas excluding (Nt−N_{PL1}) PL2 polarizations. The other operations are the same, and thus, the description thereof will be omitted.

### <Step C-2>

Coded Doppler demultiplexer 212 determines whether (Nt−N_{PL1}) CDDM signals assigned for (Nt−N_{PL1}) transmission antennas excluding the transmission antennas of the PL1 polarization are normally detected. In a case where the (Nt−N_{PL1}) CDDM signals are normally detected, coded Doppler demultiplexer 212 performs the processing in Step C-3, and in a case where the (Nt−N_{PL1}) CDDM signals are not normally detected, coded Doppler demultiplexer 212 considers the reception signals as including a large amount of noise components (for example, the SNR is low) or as a signal including interference components, and performs the processing in Step D.

Coded Doppler demultiplexer 212, for example, determines that the target-object reflected wave in which PL1 polarization is a cross polarization with respect to the polarization of the reception antenna not included, in a case where the power difference (or power ratio) between the extracted top N_{DM_NotPL1} DDM signals in terms of power and the other (N_{DM}−N_{DM_NotPL1}) lower-power DDM signals is not equal to or greater than a predetermined level, and performs the processing in Step D.

Here, N_{DM_NotPL1} is the number of DDM signals at which CDDM signals are assigned for the transmission antennas excluding the transmission antennas of the PL1 polarization. For example, N_{DM_NotPL1} is the number of DDM signals for which the number of code multiplexing assigned for N_{DM} DDM signals for the transmission antennas excluding the transmission antennas of the PL1 polarization is equal to or greater than 1. For example, in the configuration example in FIG. 16, NcNoPL1=(2, 0, 1, 1), and N_{DM_NotPL1}=3.

Further, in a case where the Doppler multiplexing intervals of the extracted top N_{DM_NotPL1} DDM signals in terms of power do not match the Doppler multiplexing intervals assigned for the polarization transmission antennas excluding the PL1 polarization, coded Doppler demultiplexer 212 determines that the target-object reflected wave in which the PL1 polarization is a cross-polarization with respect to the polarization of the reception antenna is not included, and performs the processing in Step D.

Further, coded Doppler demultiplexer 212 determines, for example, whether the code intervals or the numbers of code multiplexing match the code intervals or numbers of code multiplexing expected of the (Nₜ−N_{PL1}) CDDM signals, based on the reception powers of signals obtained by performing code demultiplexing processing on the extracted top N_{DM_NotPL1} DDM signals in terms of power. In a case where the code intervals or the numbers of code multiplexing do not match, coded Doppler demultiplexer 212 determines that the target-object reflected wave in which the PL1 polarization is a cross-polarization with respect to the polarization of the reception antenna is not included, and performs the processing in Step D.

### <Step C-3>

Coded Doppler demultiplexer 212 outputs reception signals YPL2_{z}(f_{b_cf}, f_{sc_cf}, ncm, ndm) resulting from CDDM demultiplexing processing performed, based on the processing result of Step C-2, on the CDDM signals used for the multiplexing transmission of (Nt−N_{PL1}) transmission antennas excluding the transmission antennas of the PL1 polarization, to direction estimator 213 together with f_{b_cf} and f_{sc_cf}.

Here, YPL2_{z}(f_{b_cf}, f_{sc_cf}, ndc(ndm), ndm) are outputs (for example, CDDM demultiplexing results) for f_{b_cf} and f_{sc_cf}, resulting from demultiplexing of Doppler analyzers 210 in zth antenna system processor 201 on the CDDM signals using DOP_{ndm} and orthogonal code Code_{ndc(ndm)}. For example, YPL2_{z}(f_{b_cf}, f_{sc_cf}, ndc(ndm), ndm) represents reception signals that are transmitted from (Nt−N_{PL1}) Tx #[ndc(ndm), ndm] excluding the transmission antennas of the PL1 polarization, are reflected by the target object, and are received by zth antenna system processor 201.

Note that z=1 to Na, ndm=1 to N_{DM}, ndc(ndm)=1 to N_{CDDM}(ndm), and the signals assigned for N_{PL1} transmission antennas corresponding to polarization PL1 are output as zero.

Further, coded Doppler demultiplexer 212 may output the Doppler frequency of the detected target object to direction estimator 213.

Note that, in a case where Condition 2a is satisfied, coded Doppler demultiplexer 212 can detect the Doppler frequency of the target object estimated in the range of −1/(2Tr)≤fd<1/(2Tr) by using the aliasing determination result.

The foregoing description has been given of an example of the operation of coded Doppler demultiplexer 212.

### [Exemplary Operation of Direction Estimator 213]

Direction estimator 213 may perform direction estimation processing based on the outputs according to the demultiplexing operation of coded Doppler demultiplexer 212, as in the embodiment described above.

For example, direction estimator 213 can perform the direction estimation processing based on the output of coded Doppler demultiplexer 212 in each of the cases where a target-object reflected wave cross-polarized with respect to the polarization of the reception antenna is not included, where a target-object reflected wave in which the PL2 polarization is a cross-polarization with respect to the polarization of the reception antenna is included, and where a target-object reflected wave in which the PL1 polarization is a cross-polarization with respect to the polarization of the reception antenna is included.

By the operation of direction estimator 213 as described above, a direction estimation processing result for each transmission polarization or a direction estimation result for a part of the transmission polarizations is obtained depending on the situation of the reflected wave, and a direction estimation result dependent on the transmission polarization is obtained. Since the response of the reflected waves from the target object may vary depending on the transmission polarization, radar apparatus 10 can improve the detection or identification performance of the target object based on such direction estimation results dependent on the transmission polarization.

Variation 2 has been described, thus far.

The embodiments of the present disclosure have been described above.

### OTHER EMBODIMENTS

(1) Preconditions for the above-described embodiment are that in a polarimetric MIMO radar using CDDM transmission, the numbers of code multiplexing between DDM signals are configured non-uniformly for Nₜ transmission antennas including differently-polarized transmission antennas, and CDDM transmission is performed from a plurality of transmission antennas in order to expand the Doppler frequency range in which detection can be successful to the +1/(2Tr) range. In the above embodiment, a method for further improving the detection performance of the polarimetric MIMO radar by applying CDDM transmission that satisfies Condition 1 and Condition 2 has been described. For example, in a case where the assumed movement velocity of the target object is relatively low, or in a case where the relative velocity between the radar apparatus and the target object is limited to a narrow range, the above-described preconditions need not be applied.

For example, encoder 107 may configure numbers N_{CDDM}(1), N_{CDDM}(2), . . . , N_{CDDM}(N_{DM}) of coded Doppler multiplexing to include the same numbers of coded Doppler multiplexing in a range of form 1 to N_{CM}, inclusive, by using an equal-interval Doppler shift amount configuration (for example, Expression 6) with an interval narrower than the maximum equal-interval Doppler shift amount configuration. For example, encoder 107 may configure N_{CM} codes for all the numbers of coded Doppler multiplexing. Thus, in a plurality of combinations of DOP_{ndm} and orthogonal code sequences, numbers N_{CDDM}(ndm) of multiplexing (numbers of coded Doppler multiplexing) by the orthogonal code sequences associated with each DOP_{ndm} may be the same. For example, encoder 107 may configure the numbers of coded Doppler multiplexing for the DDM signals uniformly. With such a configuration, in a case where the DDM signal is an unequal interval Doppler multiplexing, for example, the aliasing determination in PTL 8 can be applied, and radar apparatus 10 can individually demultiplex and receive signals CDDM-transmitted from a plurality of transmission antennas over a Doppler range of ±1/(2×Loc×Tr). By applying such a CDDM transmission configuration and further applying CDDM transmission that satisfies Condition 1, the effect of Condition 1 described in Embodiment 1 can be obtained, and it is possible to improve the detection performance of a polarimetric MIMO radar.

Alternatively, encoder 107 may configure all of numbers N_{CDDM}(1), N_{CDDM}(2), . . . , N_{CDDM}(N_{DM}) of coded Doppler multiplexing to include the same numbers of coded Doppler multiplexing in a range of from 1 to N_{CM}, inclusive, for example, by using the maximum equal-interval Doppler shift amount configuration. For example, encoder 107 may configure N_{CM} codes for all the numbers of coded Doppler multiplexing. In this case, the number of combinations of DOP_{ndm} and the orthogonal code sequences and number Nt of transmission antennas may be the same (for example, N_{DM}×N_{CM}=Nt). For example, encoder 107 may configure the numbers of coded Doppler multiplexing for the DDM signal uniformly. In this configuration, the aliasing determination processing in the reception processing of radar apparatus 10 is not applied. Further, radar apparatus 10 can individually demultiplex and receive signals CDDM-transmitted from a plurality of transmission antennas over a Doppler range of, for example, ±1/(2Loc×N_{DM}×Tr). By applying such a CDDM transmission configuration and further applying CDDM transmission that satisfies Condition 1, the effect of Condition 1 described in Embodiment 1 can be obtained, and it is possible to improve the detection performance of a polarimetric MIMO radar.
(2) In one exemplary embodiment of the present disclosure, radar apparatus 10 may perform code multiplexing transmission using a part of the Nt transmission antennas instead of using all of the Nt transmission antennas.

Further, in a case where the code multiplexing transmission in the embodiment described above is applied using a part of Nt transmission antennas provided in radar apparatus 10, radar apparatus 10 may configure (or change), in a time-division manner, at least one of the combination of transmission antennas used for the code Doppler multiplexing transmission or the number of multiplexing transmissions and perform transmission. In this case, for example, radar apparatus 10 may time-divisionally switch the combination of transmission antennas for each transmission period or for each code transmission period (for example, each period corresponding to the code length of a code sequence). Alternatively, for example, radar apparatus 10 may switch the combinations of transmission antennas or the numbers of transmission antennas to be multiplexed for each measurement period (for each time of the Nc radar transmission signal transmissions). Even when such an operation is applied, the effects of the embodiment described above can also be obtained.

Further, in a case where a part of the Nt transmission antennas provided in radar apparatus 10 is used instead of using all of the Nt transmission antennas, and the code multiplexing transmission in the embodiment described above is applied, radar apparatus 10 may configure (for example, change) the combinations of transmission antennas used for the coded Doppler multiplexing transmission in a time division manner and may transmit different chirp signals. For example, radar apparatus 10 may change at least one of the transmission band, the frequency sweep time, or the center frequency of the chirp signal, or may transmit using different chirp signals by combining these parameters in various ways.
(3) In the radar apparatuses according to one exemplary embodiment of the present disclosure, the radar transmitter and the radar receiver may be individually arranged in physically demultiplex locations from each other. Also, In the radar receiver according to the exemplary embodiments of the present disclosure, the direction estimator and any other component may be individually arranged in physically demultiplex locations from one another.
(4) The numerical values of parameters such as number Nt of transmission antennas, number Na of reception antennas, number N_{DM} of Doppler multiplexing, number N_{PLq} of transmission antennas of PLq polarization, the number of polarizations, the Doppler shift amount, the Doppler shift interval, number N_{CM} of code multiplexing, and the code interval (code index) used in one exemplary embodiment of the present disclosure are examples and are not limited to those values. Further, for example, the number of some of the transmission antennas included in the radar apparatus may be used as number Nt of transmission antennas, and the number of some of the reception antennas included in the radar apparatus may be used as number Na of reception antennas.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

When future integrated circuit technology replaces LSIs as a result of the advancement of semiconductor technology or other derivative technology, the functional blocks could be integrated using the future integrated circuit technology. Biotechnology can also be applied.

### SUMMARY OF PRESENT DISCLOSURE

A radar apparatus according to one exemplary embodiment of the present disclosure includes: a plurality of transmission antennas including a first transmission antenna for emitting a first polarized wave and a second transmission antenna for emitting a second polarized wave different from the first polarized wave; and transmission circuitry, which, in operation, performs a multiplexing transmission on a transmission signal to which a phase rotation amount corresponding to a combination of a Doppler shift amount and a code sequence is applied, from the plurality of transmission antennas, in which the combination in which at least one of the Doppler shift amount or the code sequence is different is associated with each of the plurality of transmission antennas, and a first pattern of the Doppler shift amount and the code sequence assigned for the first transmission antenna and a second pattern of the Doppler shift amount and the code sequence assigned for the second transmission antenna are different from each other.

In one exemplary embodiment of the present disclosure, a number of the plurality of transmission antennas is less than a total number of the combinations.

In one exemplary embodiment of the present disclosure, the first pattern and the second pattern relate to an interval of the Doppler shift amount, a number of Doppler multiplexing for the transmission signal transmitted by the first transmission antenna and a number of Doppler multiplexing for the transmission signal transmitted by the second transmission antenna are the same, and at least one of a plurality of the intervals of the Doppler shift amount associated with the first transmission antenna is different from the interval of the Doppler shift amount associated with the second transmission antenna.

In one exemplary embodiment of the present disclosure, the first pattern and the second pattern relate to a number of Doppler multiplexing, and the number of Doppler multiplexing for the transmission signal transmitted by the first transmission antenna and the number of Doppler multiplexing for the transmission signal transmitted by the second transmission antenna are different from each other.

In one exemplary embodiment of the present disclosure, the first pattern and the second pattern relate to an order of an interval of the Doppler shift amount, a plurality of first Doppler shift intervals between a plurality of the Doppler shift amounts associated with the first transmission antenna and a plurality of second Doppler shift intervals between a plurality of the Doppler shift amounts associated with the second transmission antenna are the same, and the order of the plurality of first Doppler shift intervals on a Doppler frequency axis is different from the order of the plurality of second Doppler shift intervals on the Doppler frequency axis.

In one exemplary embodiment of the present disclosure, the first pattern and the second pattern relate to the code sequence, and an order of the code sequence associated with the first transmission antenna on a Doppler frequency axis and an order of the code sequence associated with the second transmission antenna on the Doppler frequency axis are different from each other in a plurality of the combinations.

In one exemplary embodiment of the present disclosure, the first pattern and the second pattern relate to a number of code multiplexing by the code sequence, and an order on a Doppler frequency axis of the number of code multiplexing by the code sequence associated with the first transmission antenna and an order on the Doppler frequency axis of the number of code multiplexing by the code sequence associated with the second transmission antenna are different from each other in a plurality of the combinations.

In one exemplary embodiment of the present disclosure, a number of code multiplexing by the code sequence associated with at least one of a plurality of the Doppler shift amounts or a number of code multiplexing by the code sequence associated with another of the plurality of Doppler shift amounts are different from each other in a plurality of the combinations with respect to at least one of the first transmission antenna or the second transmission antenna.

In one exemplary embodiment of the present disclosure, a reception antenna that receives a reflected wave signal being the transmission signal reflected by a target object using any one of the first polarized wave and the second polarized wave; and direction estimation circuitry, which, in operation, performs direction estimation for the target object based on the reflected wave signal are further included.

In one exemplary embodiment of the present disclosure, a plurality of reception antennas that includes a first reception antenna and a second reception antenna, and that receive a reflected wave signal being the transmission signal reflected by a target object, the first reception antenna being configured to receive the first polarized wave, the second reception antenna being configured to receive the second polarized wave; and direction estimation circuitry, which, in operation, performs direction estimation for the target object individually on the reflected wave signal received by each of the first reception antenna and the second reception antenna are further included.

In one exemplary embodiment of the present disclosure, a combination of transmission antennas from among the plurality of transmission antennas for use in the multiplexing transmission of the transmission signal is switched for each transmission period of the transmission signal, for each period corresponding to a code length of the code sequence, or for each measurement period in the radar apparatus.

In one exemplary embodiment of the present disclosure, a plurality of transmission antennas including a first transmission antenna for emitting a first polarized wave, a second transmission antenna for emitting a second polarized wave different from the first polarized wave, and a third transmission antenna for emitting a third polarized wave different from the first polarized wave and the second polarized wave; and transmission circuitry, which, in operation, performs multiplexing transmission from the plurality of transmission antennas on a transmission signal to which a phase rotation amount corresponding to a combination of a Doppler shift amount and a code sequence are included, in which the combination in which at least one of the Doppler shift amount or the code sequence is different is associated with each of the plurality of transmission antennas, and a third pattern of the Doppler shift amount and the code sequence assigned for the first transmission antenna and the third transmission antenna differs from a fourth pattern of the Doppler shift amount and the code sequence assigned for the second transmission antenna and the third transmission antenna.

The disclosure of Japanese Patent Application No. 2022-202052, filed on Dec. 19, 2022, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

10 Radar apparatus
100 Radar transmitter
101 Radar transmission signal generator
102 Transmission signal generation controller
103 Modulation signal generator
104 VCO
105 Phase rotation amount setter
106 Doppler shift setter
107 Encoder
108 Phase rotator
109 Transmission antenna section
200, 200a Radar receiver
201 Antenna system processor
202 Reception antenna section
203 Reception radio
204 Mixer
205 LPF
206 Signal processor
207 AD converter
208 Beat frequency analyzer
209 Output switch
210 Doppler analyzer
211, 211a CFAR section
212, 212a Coded Doppler demultiplexer
213, 213a Direction estimator

1. A radar apparatus, comprising:
a plurality of transmission antennas including a first transmission antenna for emitting a first polarized wave and a second transmission antenna for emitting a second polarized wave different from the first polarized wave; and
transmission circuitry, which, in operation, performs a multiplexing transmission on a transmission signal to which a phase rotation amount corresponding to a combination of a Doppler shift amount and a code sequence is applied, from the plurality of transmission antennas, wherein
the combination in which at least one of the Doppler shift amount or the code sequence is different is associated with each of the plurality of transmission antennas, and
a first pattern of the Doppler shift amount and the code sequence assigned for the first transmission antenna and a second pattern of the Doppler shift amount and the code sequence assigned for the second transmission antenna are different from each other.

2. The radar apparatus according to claim 1, wherein
a number of the plurality of transmission antennas is less than a total number of the combinations.

3. The radar apparatus according to claim 1, wherein:
the first pattern and the second pattern relate to an interval of the Doppler shift amount,
a number of Doppler multiplexing for the transmission signal transmitted by the first transmission antenna and a number of Doppler multiplexing for the transmission signal transmitted by the second transmission antenna are the same, and
at least one of a plurality of the intervals of the Doppler shift amount associated with the first transmission antenna is different from the interval of the Doppler shift amount associated with the second transmission antenna.

4. The radar apparatus according to claim 1, wherein:
the first pattern and the second pattern relate to a number of Doppler multiplexing, and
the number of Doppler multiplexing for the transmission signal transmitted by the first transmission antenna and the number of Doppler multiplexing for the transmission signal transmitted by the second transmission antenna are different from each other.

5. The radar apparatus according to claim 1, wherein:
the first pattern and the second pattern relate to an order of an interval of the Doppler shift amount,
a plurality of first Doppler shift intervals between a plurality of the Doppler shift amounts associated with the first transmission antenna and a plurality of second Doppler shift intervals between a plurality of the Doppler shift amounts associated with the second transmission antenna are the same, and
the order of the plurality of first Doppler shift intervals on a Doppler frequency axis is different from the order of the plurality of second Doppler shift intervals on the Doppler frequency axis.

6. The radar apparatus according to claim 1, wherein:
the first pattern and the second pattern relate to the code sequence, and
an order of the code sequence associated with the first transmission antenna on a Doppler frequency axis and an order of the code sequence associated with the second transmission antenna on the Doppler frequency axis are different from each other in a plurality of the combinations.

7. The radar apparatus according to claim 1, wherein:
the first pattern and the second pattern relate to a number of code multiplexing by the code sequence, and
an order on a Doppler frequency axis of the number of code multiplexing by the code sequence associated with the first transmission antenna and an order on the Doppler frequency axis of the number of code multiplexing by the code sequence associated with the second transmission antenna are different from each other in a plurality of the combinations.

8. The radar apparatus according to claim 1, wherein
a number of code multiplexing by the code sequence associated with at least one of a plurality of the Doppler shift amounts or a number of code multiplexing by the code sequence associated with another of the plurality of Doppler shift amounts are different from each other in a plurality of the combinations with respect to at least one of the first transmission antenna or the second transmission antenna.

9. The radar apparatus according to claim 1, further comprising:
a reception antenna that receives a reflected wave signal being the transmission signal reflected by a target object using any one of the first polarized wave and the second polarized wave; and
direction estimation circuitry, which, in operation, performs direction estimation for the target object based on the reflected wave signal.

10. The radar apparatus according to claim 1, further comprising:
a plurality of reception antennas that includes a first reception antenna and a second reception antenna, and that receive a reflected wave signal being the transmission signal reflected by a target object, the first reception antenna being configured to receive the first polarized wave, the second reception antenna being configured to receive the second polarized wave; and
direction estimation circuitry, which, in operation, performs direction estimation for the target object individually on the reflected wave signal received by each of the first reception antenna and the second reception antenna.

11. The radar apparatus according to claim 1, wherein
a combination of transmission antennas from among the plurality of transmission antennas for use in the multiplexing transmission of the transmission signal is switched for each transmission period of the transmission signal, for each period corresponding to a code length of the code sequence, or for each measurement period in the radar apparatus.

12. The radar apparatus according to claim 1, wherein:
the plurality of transmission antennas further includes a third transmission antenna for emitting a third polarized wave different from the first polarized wave and the second polarized wave, and
a third pattern of the Doppler shift amount and the code sequence assigned for the third transmission antenna is different from the first pattern and the second pattern.

13. A method for transmitting a radar signal, the method comprising:
applying a phase rotation amount corresponding to a combination of a Doppler shift amount and a code sequence to a radar signal; and
performing a multiplexing transmission on the radar signal to which the phase rotation amount is applied, from a plurality of transmission antennas, wherein
the plurality of transmission antennas includes a first transmission antenna for emitting a first polarized wave and a second transmission antenna for emitting a second polarized wave different from the first polarized wave,
the combination in which at least one of the Doppler shift amount or the code sequence is different is associated with each of the plurality of transmission antennas, and
a first pattern of the Doppler shift amount and the code sequence assigned for the first transmission antenna and a second pattern of the Doppler shift amount and the code sequence assigned for the second transmission antenna are different from each other.

14. The method for transmitting a radar signal according to claim 13, wherein
a number of the plurality of transmission antennas is less than a total number of the combinations.

15. The method for transmitting a radar signal according to claim 13, wherein:
the first pattern and the second pattern relate to an interval of the Doppler shift amount,
a number of Doppler multiplexing for the radar signal transmitted by the first transmission antenna and a number of Doppler multiplexing for the radar signal transmitted by the second transmission antenna are the same, and
at least one of a plurality of the intervals of the Doppler shift amount associated with the first transmission antenna is different from the interval of the Doppler shift amount associated with the second transmission antenna.

16. The method for transmitting a radar signal according to claim 13, wherein:
the first pattern and the second pattern relate to a number of Doppler multiplexing, and
the number of Doppler multiplexing for the radar signal transmitted by the first transmission antenna and the number of Doppler multiplexing for the radar signal transmitted by the second transmission antenna are different from each other.

17. The method for transmitting a radar signal according to claim 13, wherein:
the first pattern and the second pattern relate to an order of an interval of the Doppler shift amount,
a plurality of first Doppler shift intervals between a plurality of the Doppler shift amounts associated with the first transmission antenna and a plurality of second Doppler shift intervals between a plurality of the Doppler shift amounts associated with the second transmission antenna are the same, and
the order of the plurality of first Doppler shift intervals on a Doppler frequency axis is different from the order of the plurality of second Doppler shift intervals on the Doppler frequency axis.

18. The method for transmitting a radar signal according to claim 13, wherein:
the plurality of transmission antennas further includes a third transmission antenna for emitting a third polarized wave different from the first polarized wave and the second polarized wave, and
a third pattern of the Doppler shift amount and the code sequence assigned for the third transmission antenna is different from the first pattern and the second pattern.

19. A method for receiving a radar signal, the method comprising:
receiving, by a reception antenna, a reflected wave signal being a radar signal transmitted by the method for transmitting a radar signal according to claim 13 and reflected by a target object; and
performing direction estimation for the target object based on the reflected wave signal, wherein
the reception antenna receives the reflected wave signal using either one of the first polarized wave and the second polarized wave.

20. A radar signal generation apparatus, comprising:
phase rotation circuitry, which, in operation, applies a phase rotation amount corresponding to a combination of a Doppler shift amount and a code sequence to a radar signal; and
transmission circuitry, which, in operation, performs a multiplexing transmission on the radar signal to which the phase rotation amount is applied, from a plurality of transmission antennas, wherein
the plurality of transmission antennas includes a first transmission antenna for emitting a first polarized wave and a second transmission antenna for emitting a second polarized wave different from the first polarized wave,
the combination in which at least one of the Doppler shift amount or the code sequence is different is associated with each of the plurality of transmission antennas, and
a first pattern of the Doppler shift amount and the code sequence assigned for the first transmission antenna and a second pattern of the Doppler shift amount and the code sequence assigned for the second transmission antenna are different from each other.
